(19) United States
(12) Patent Application Publication
(10) Pub. No.: US 2013/0042116 A1
(43) Pub. Date: Feb. 14, 2013

(54) INFORMATION PROCESSING APPARATUS AND INFORMATION PROCESSING METHOD

(71) Applicant: Koichi SAKUMOTO, Tokyo (JP)

(72) Inventor: Koichi SAKUMOTO, Tokyo (JP)

(21) Appl. No.: 13/566,231

(22) Filed: Aug. 3, 2012

(30) Foreign Application Priority Data
Aug. 12, 2011 (JP) 2011-177333

(51) Int. Cl. H04L 9/30

(52) U.S. Cl. 713/176

(57) ABSTRACT

An information processing apparatus including a message generator generating a message based on a set F=(f₁, . . . , fₘ) of multi-order multivariable polynomials defined on a ring K and a vector sεKⁿ, a message provision unit providing the message to a verifier holding the set F and a vector y=(y₁, . . . , yₘ)=(f₁(s), . . . , fₘ(s)), and a response provision unit providing response information corresponding to a verification pattern selected by the verifier to the verifier. The vector s is a secret key. The set F and the vector y are a public key. The message is obtained by performing an operation prepared for the verification pattern corresponding to the response information by using the public key and the response information. The set F is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

### BACKGROUND

The present technology relates to an information processing apparatus and an information processing method.

With rapid development of information processing technology and communication technology, digitization of documents are in progress at a rapid pace regardless of whether documents are public documents or private documents. Accordingly, many individuals and enterprises show a keen interest in safety management of electronic documents. With such a mounting interest, countermeasures against tampering acts such as eavesdropping and forgery of electronic documents are increasingly studied in many quarters. Safety of an electronic document from eavesdropping can be secured by, for example, encrypting the electronic document. Also, safety of an electronic document from forgery can be secured by, for example, using a digital signature. However, it is difficult to guarantee sufficient safety if encryption or digital signatures to be used do not have a high level of resistance to tampering.

A digital signature is used to identify the creator of an electronic document. Thus, the digital signature should be made creatable only by the creator of an electronic document. If a malicious third party should be able to create the same digital signature, the third party can disguise as the creator of the electronic document. That is, an electronic document is forged by a malicious third party. To prevent such a forgery, various discussions about safety of an electronic document have been conducted. Among digital signature schemes currently in widespread use, for example, the RSA signature scheme and the DSA signature scheme are known.

For example, safety of the RSA signature scheme is grounded on “difficulty of factorization of a large composite number into prime numbers (hereinafter, called a factorization problem)”. Also, safety of the DSA signature scheme is grounded on “difficulty of deriving a solution to a discrete logarithmic problem”. These grounds are ascribable to non-existence of an algorithm that efficiently solves the factorization problem or the discrete logarithmic problem by using a classical computer. That is, the above difficulty means computational difficulty for a classical computer. However, using a quantum computer, a solution to the factorization problem or the discrete logarithmic problem is said to be efficiently calculated.

Like the RSA signature scheme and the DSA signature scheme, safety of many digital signature schemes and public key authentication schemes currently in use is grounded on difficulty of the factorization problem or the discrete logarithmic problem. Thus, when a quantum computer becomes commercially available, safety of such digital signature schemes and public key authentication schemes is no longer secured. Thus, realization of new digital signature schemes and public key authentication schemes whose safety is ground on different problems from the factorization problem or the discrete logarithmic problem that may easily be solved by a quantum computer is demanded. Problems that are difficult to solve by a quantum computer include, for example, a multivariable polynomial problem.

Digital signature schemes whose safety is grounded on the multivariable polynomial problem include, for example, schemes based on MI (Matsumoto-Imai cryptography), HFE (Hidden Field Equation cryptography), OV (Oil-Vinegar signature scheme), and TTM (Tamed Transformation Method cryptography). For example, Jacques Patarin Asymmetric Cryptography with a Hidden Monomial, CRYPTO 1996, pp. 45-60 and Patarin, J., Courtois, N., and Goubin, L. QUARTZ, 128-Bit Long Digital Signatures, In Naccache, D., Ed. Topics in Cryptology—CT-RSA 2001 (San Francisco, Calif., USA, April 2001), vol. 2020 of Lecture Notes in Computer Science, Springer-Verlag., pp. 282-297 disclose digital signature schemes based on HFE.

### SUMMARY

The multivariable polynomial problem is, as described above, an example of the problem called the NP difficulty problem that is difficult to solve even if a quantum computer is used. Public key authentication schemes using a multivariable polynomial problem including FIFE normally use a multi-order multivariable simultaneous equation into which special trapdoors are incorporated. For example, a multi-order multivariable simultaneous equation F(x₁, . . . , xₘ)=y of x₁, . . . , xₙ and linear transformations A, B are provided and the linear transformations A, B are managed in secret. In this case, the multi-order multivariable simultaneous equation F and the linear transformations A, B become trapdoors.

An entity knowing the trapdoors F, A, B can solve an equation B(F(A(x₁, . . . , xₙ)))=y′ of x₁, . . . , xₙ. On the other hand, it is difficult for an entity not knowing the trapdoors F, A, B to solve the equation B(F(A(x₁, . . . , xₙ)))=y′ of x₁, . . . , xₙ. By using the above mechanism, a public key authentication scheme or digital signature scheme whose safety is grounded on difficulty of solving a multi-order multivariable simultaneous equation is realized.

To realize such a public key authentication scheme or digital signature scheme, as described above, it is necessary to provide a special multi-order multivariable simultaneous equation satisfying B(F(A(x₁, . . . , xₙ)))=y. Moreover, it is necessary to solve a multi-order multivariable simultaneous equation F when a signature is generated. Thus, multi-order multivariable simultaneous equations F that can be used are limited to those that can relatively easily be solved. That is, only a multi-order multivariable simultaneous equation B(F(A(x₁, . . . , xₙ)))=_{y} combining three functions (trapdoors) B, F, A that can relatively easily be solved can be used by the past schemes, which makes it difficult to secure sufficient safety.

In view of the above circumstances, it is desirable to provide a novel and improved information processing apparatus capable of realizing a public key authentication scheme or digital signature scheme with a high level of safety by using a multi-order multivariable simultaneous equation for which a method (trapdoor) of efficiently finding a solution is not known and an information processing method.

According to an embodiment of the present technology, there is provided an information processing apparatus including a message generator that generates a message based on a set F=(f₁, . . . , fₘ) of multi-order multivariable polynomials defined on a ring K and a vector sεKⁿ, a message provision unit that provides the message to a verifier holding the set F of the multi-order multivariable polynomials and a vector y=(y₁, . . . , yₘ)=(f₁(s), . . . , fₘ(s)), and a response provision unit that provides response information corresponding to a verification pattern selected by the verifier from k (k≧3) verification patterns to the verifier, wherein the vector s is a secret key, the set F of the multi-order multivariable polynomials and the vector y are a public key, the message is information obtained by performing an operation prepared in advance for the verification pattern corresponding to the response information by using the public key and the response information, and the set F of multi-order multivariable polynomials is obtained by adding a set F^{A}=(f₁^{A}, . . . fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

According to another embodiment of the present technology, there is provided an information processing apparatus including an information holding unit that holds a set F=(f₁, . . . , fₘ) of multi-order multivariable polynomials defined on a ring K and a vector y=(y₁, . . . , yₘ)=(f₁(s), . . . , fₘ(s)), a message acquisition unit that acquires a message generated based on the set F of multi-order multivariable polynomials and a vector sεKⁿ, a pattern information provision unit that provides information about a verification pattern selected randomly from k (k≧3) verification patterns to a prover who provides the message, a response acquisition unit that acquires response information corresponding to the selected verification pattern from the prover, and a verification unit that verifies whether the prover holds the vector s based on the message, the set F of multi-order multivariable polynomials, the vector y, and the response information, wherein the vector s is a secret key, the set F of multi-order multivariable polynomials and the vector y are a public key, the message is information obtained by performing an operation prepared in advance for the verification pattern corresponding to the response information by using the public key and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

According to still another embodiment of the present technology, there is provided an information processing apparatus including a message generator that generates a message based on a set F=(f₁, . . . , fₘ) of multi-order multivariable polynomials defined on a ring K and a vector sεKⁿ, a message provision unit that provides the message to a verifier holding the set F of multi-order multivariable polynomials and a vector y=(y₁, . . . , yₘ)=(f₁(s), . . . , fₘ(s)), an intermediate information generator that generates third information by using first information randomly selected by the verifier and second information obtained when the message is generated, an intermediate information provision unit that provides the third information to the verifier, and a response provision unit that provides response information corresponding to a verification pattern selected by the verifier from k (k≧2) verification patterns to the verifier, wherein the vector s is a secret key, the set F of multi-order multivariable polynomials and the vector y are a public key, the message is information obtained by performing an operation prepared in advance for the verification pattern corresponding to the response information by using the public key, the first information, the third information, and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . gₘ^{A}) of terms of third order or higher.

According to still another embodiment of the present technology, there is provided an information processing apparatus including an information holding unit that holds a set F=(f₁, . . . , fₘ) of multi-order multivariable polynomials defined on a ring K and a vector y=(y₁, . . . , yₘ)=(f₁(s), . . . , fₘ(s)), a message acquisition unit that acquires a message generated based on the set F of multi-order multivariable polynomials and a vector sεKⁿ, an information provision unit that provides first information selected randomly to a prover who provides the message, an intermediate information acquisition unit that acquires third information generated by the prover by using the first information and second information obtained when the message is generated, a pattern information provision unit that provides information about a verification pattern selected randomly from k (k≧3) verification patterns to the prover, a response acquisition unit that acquires response information corresponding to the selected verification pattern from the prover, and a verification unit that verifies whether the prover holds the vector s based on the message, the first information, the third information, the set F of multi-order multivariable polynomials, and the response information, wherein the vector s is a secret key, the set F of multi-order multivariable polynomials and the vector y are a public key, the message is information obtained by performing an operation prepared in advance for the verification pattern corresponding to the response information by using the public key, the first information, the third information, and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . gₘ^{A}) of terms of third order or higher.

According to still another embodiment of the present technology, there is provided an information processing method including generating a message based on a set F=(f₁, . . . , fₘ) of multi-order multivariable polynomials defined on a ring K and a vector sεKⁿ, providing the message to a verifier holding the set F of multi-order multivariable polynomials and a vector y=(y₁, . . . , yₘ)=(f₁(s), . . . , fₘ(s)), and providing response information corresponding to a verification pattern selected by the verifier from k (k≧3) verification patterns to the verifier, wherein the vector s is a secret key, the set F of multi-order multivariable polynomials and the vector y are a public key, the message is information obtained by performing an operation prepared in advance for the verification pattern corresponding to the response information by using the public key and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

According to still another embodiment of the present technology, there is provided an information processing method to be performed by an information processing apparatus that holds a set F=(f₁, . . . , fₘ) of multi-order multivariable polynomials defined on a ring K and a vector y=(y₁, . . . , yₘ)=(f₁(s), . . . , fₘ(s)), the method including acquiring a message generated based on the set F of multi-order multivariable polynomials and a vector sεKⁿ, providing information about a verification pattern selected randomly from k (k≧3) verification patterns to a prover who provides the message, acquiring response information corresponding to the selected verification pattern from the prover, and verifying whether the prover holds the vector s based on the message, the set F of multi-order multivariable polynomials, the vector y, and the response information, wherein the vector s is a secret key, the set F of multi-order multivariable polynomials and the vector y are a public key, the message is information obtained by performing an operation prepared in advance for the verification pattern corresponding to the response information by using the public key and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

According to still another embodiment of the present technology, there is provided an information processing method including generating a message based on a set F=(f₁, . . . , fₘ) of multi-order multivariable polynomials defined on a ring K and a vector sεKⁿ, providing the message to a verifier holding the set F of multi-order multivariable polynomials and a vector y=(y₁, . . . , yₘ)=(f₁(s), . . . , fₘ(s)), generating third information by using first information randomly selected by the verifier and second information obtained when the message is generated, providing the third information to the verifier, and providing response information corresponding to a verification pattern selected by the verifier from k (k≧2) verification patterns to the verifier, wherein the vector s is a secret key, the set F of multi-order multivariable polynomials and the vector y are a public key, the message is information obtained by performing an operation prepared in advance for the verification pattern corresponding to the response information by using the public key, the first information, the third information, and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

According to still another embodiment of the present technology, there is provided an information processing method to be performed by an information processing apparatus that holds a set F=(f₁, . . . , fₘ) of multi-order multivariable polynomials defined on a ring K and a vector y=(y₁, . . . , yₘ)=(f₁(s), . . . , fₘ(s)), the method including acquiring a message generated based on the set F=(f₁, . . . , fₘ) of multi-order multivariable polynomials and a vector sεKⁿ, providing first information selected randomly to a prover who provides the message, acquiring third information generated by the prover by using the first information and second information obtained when the message is generated, providing information about a verification pattern selected randomly from k (k≧3) verification patterns to the prover, acquiring response information corresponding to the selected verification pattern from the prover, and verifying whether the prover holds the vector s based on the message, the first information, the third information, the set F of multi-order multivariable polynomials, and the response information, wherein the vector s is a secret key, the set F of multi-order multivariable polynomials and the vector y are a public key, the message is information obtained by performing an operation prepared in advance for the verification pattern corresponding to the response information by using the public key, the first information, the third information, and the response information, and the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

According to another embodiment of the present technology, there is provided a program causing a computer to realize the function of each unit of the above information processing apparatus. Further, according to another embodiment of the present technology, there is provided a computer-readable recording medium in which the program is recorded.

According to the present technology, as described above, a public key authentication scheme or digital signature scheme with a high level of safety can be realized by using a multi-order multivariable simultaneous equation for which a method (trapdoor) of efficiently a solution is not known.

### BRIEF DESCRIPTION OF THE DRAWINGS

FIG. 1 is an explanatory view illustrating an algorithm configuration of a public key authentication scheme;

FIG. 2 is an explanatory view illustrating the algorithm configuration of a digital signature scheme;

FIG. 3 is an explanatory view illustrating an n-pass public key authentication scheme;

FIG. 4 is an explanatory view illustrating an algorithm of the public key authentication scheme according to a first embodiment (3-pass) of the present technology;

FIG. 5 is an explanatory view illustrating an extended algorithm of the public key authentication scheme according to the embodiment;

FIG. 6 is an explanatory view illustrating a parallel algorithm of the public key authentication scheme according to the embodiment;

FIG. 7 is an explanatory view illustrating a concrete algorithm of the public key authentication scheme according to the embodiment;

FIG. 8 is an explanatory view illustrating an efficient algorithm of the public key authentication scheme according to the embodiment;

FIG. 9 is an explanatory view illustrating the efficient algorithm of the public key authentication scheme according to the embodiment;

FIG. 10 is an explanatory view illustrating the efficient algorithm of the public key authentication scheme according to the embodiment;

FIG. 11 is an explanatory view illustrating parallelization of the efficient algorithm of the public key authentication scheme according to the embodiment;

FIG. 12 is an explanatory view illustrating a method of modifying the efficient algorithm of the public key authentication scheme according to the embodiment into the algorithm of a digital signature scheme;

FIG. 13 is an explanatory view illustrating the method of modifying the efficient algorithm of the public key authentication scheme according to the embodiment into the efficient algorithm of the digital signature scheme;

FIG. 14 is an explanatory view illustrating a parallel-serial configuration of the efficient algorithm of the public key authentication scheme according to the embodiment;

FIG. 15 is an explanatory view illustrating a serial-parallel configuration of the efficient algorithm of the public key authentication scheme according to the embodiment;

FIG. 16 is an explanatory view illustrating the algorithm of the public key authentication scheme according to a second embodiment (5-pass) of the present technology;

FIG. 17 is an explanatory view illustrating the extended algorithm of the public key authentication scheme according to the embodiment;

FIG. 18 is an explanatory view illustrating the parallel algorithm of the public key authentication scheme according to the embodiment;

FIG. 19 is an explanatory view illustrating parallelization of the extended algorithm of the public key authentication scheme according to the embodiment;

FIG. 20 is an explanatory view illustrating the concrete algorithm of the public key authentication scheme according to the embodiment;

FIG. 21 is an explanatory view illustrating the efficient algorithm of the public key authentication scheme according to the embodiment;

FIG. 22 is an explanatory view illustrating the efficient algorithm of the public key authentication scheme according to the embodiment;

FIG. 23 is an explanatory view illustrating the efficient algorithm of the public key authentication scheme according to the embodiment;

FIG. 24 is an explanatory view illustrating the efficient algorithm of the public key authentication scheme according to the embodiment;

FIG. 25 is an explanatory view illustrating the efficient algorithm of the public key authentication scheme according to the embodiment;

FIG. 26 is an explanatory view illustrating the efficient algorithm of the public key authentication scheme according to the embodiment;

FIG. 27 is an explanatory view illustrating the efficient algorithm of the public key authentication scheme according to the embodiment;

FIG. 28 is an explanatory view illustrating parallelization of the efficient algorithm of the public key authentication scheme according to the embodiment;

FIG. 29 is an explanatory view illustrating parallelization of the efficient algorithm of the public key authentication scheme according to the embodiment;

FIG. 30 is an explanatory view illustrating how to make the efficient algorithm of the public key authentication scheme according to the embodiment more efficient;

FIG. 31 is an explanatory view illustrating how to make the efficient algorithm of the public key authentication scheme according to the embodiment more efficient;

FIG. 32 is an explanatory view illustrating the parallel-serial configuration of the efficient algorithm of the public key authentication scheme according to the embodiment;

FIG. 33 is an explanatory view illustrating the parallel-serial configuration of the efficient algorithm of the public key authentication scheme according to the embodiment;

FIG. 34 is an explanatory view illustrating the serial-parallel configuration of the efficient algorithm of the public key authentication scheme according to the embodiment;

FIG. 35 is an explanatory view illustrating the serial-parallel configuration of the efficient algorithm of the public key authentication scheme according to the embodiment;

FIG. 36 is an explanatory view illustrating a contrivance to improve robustness of an interactive protocol according to the first and second embodiments;

FIG. 37 is an explanatory view illustrating the contrivance to improve robustness of the interactive protocol according to the first and second embodiments;

FIG. 38 is an explanatory view illustrating a hardware configuration example of an information processing apparatus capable of executing the algorithm according to each embodiment of the present technology;

FIG. 39 is a chart comparing efficiency of the public key authentication schemes according to the first and second embodiments of the present technology; and

FIG. 40 is an explanatory view illustrating a preferred setting method of parameters used by the public key authentication schemes according to the first and second embodiments of the present technology and effects thereof.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

[Flow of the Description]

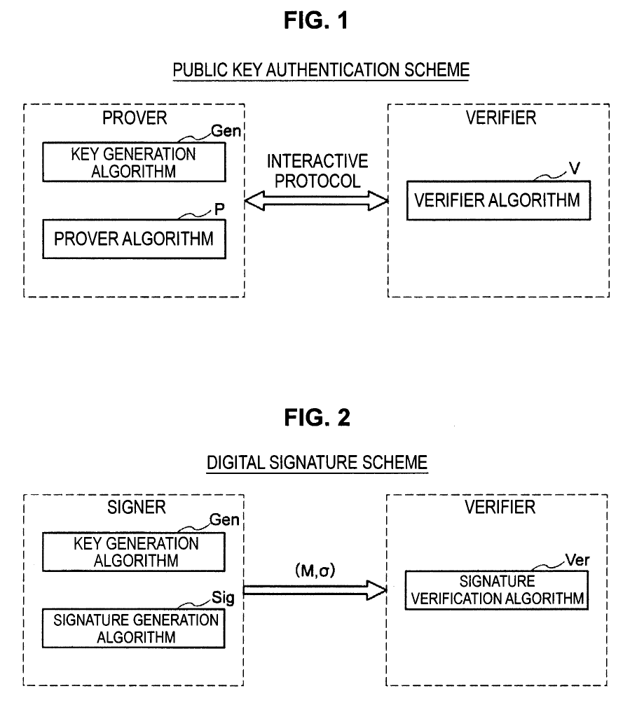

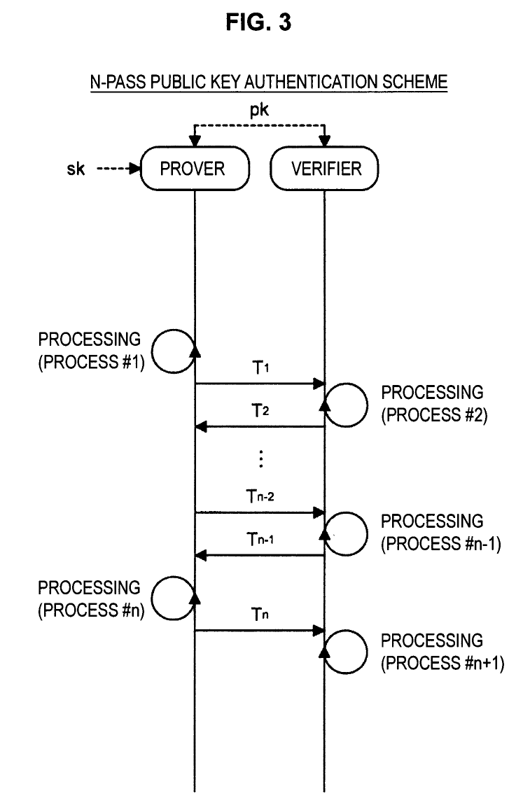

The flow of the description about the embodiments of the present technology described below will briefly be described. First, an algorithm configuration of a public key authentication scheme will be described with reference to FIG. 1. Next, the algorithm configuration of a digital signature scheme will be described with reference to FIG. 2. Next, an n-pass public key authentication scheme will be described with reference to FIG. 3.

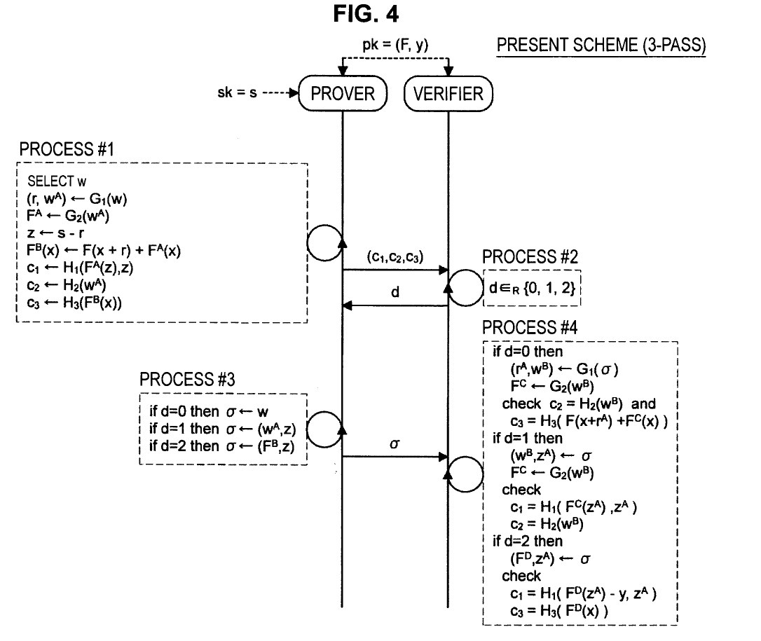

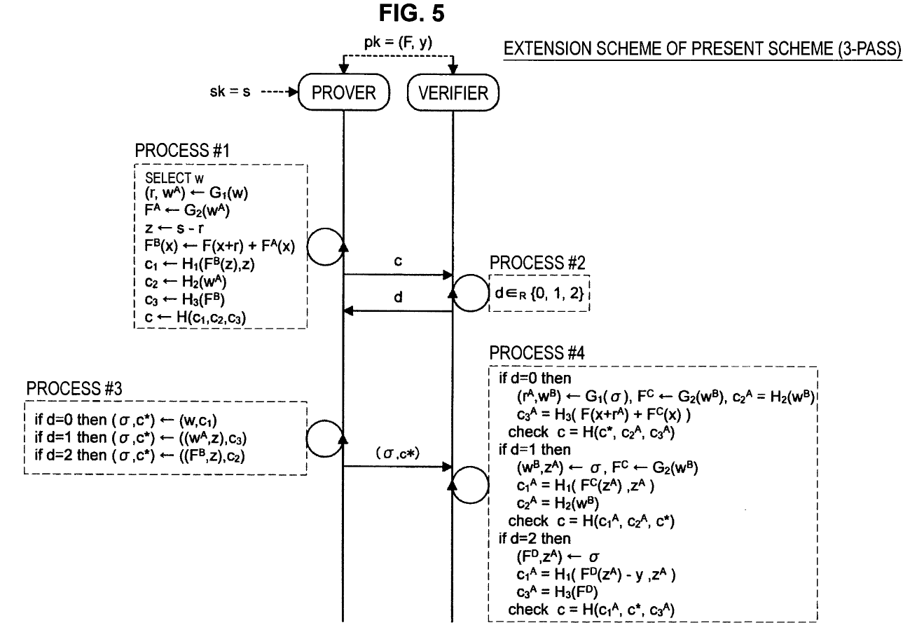

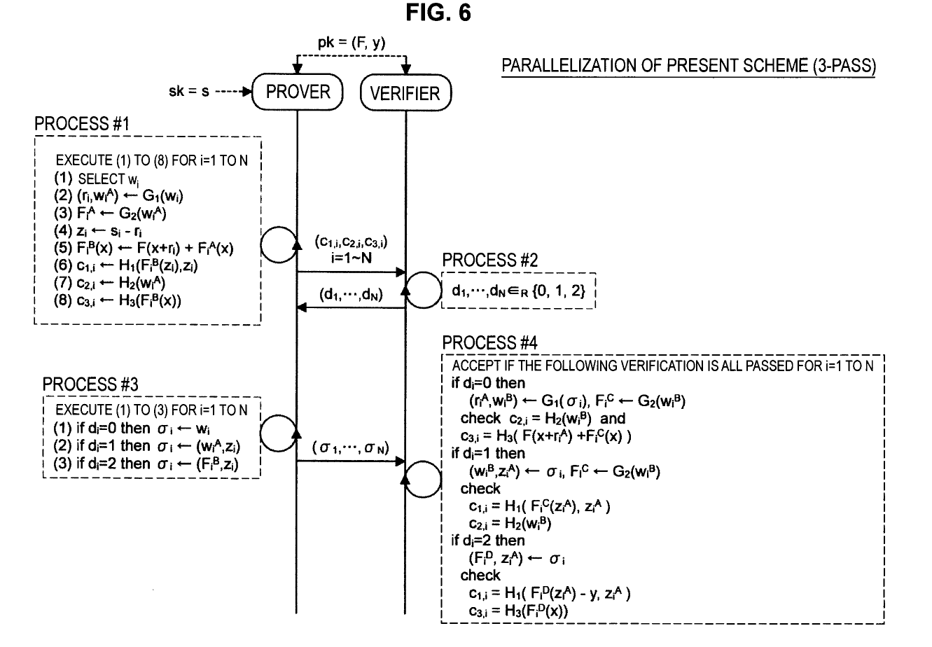

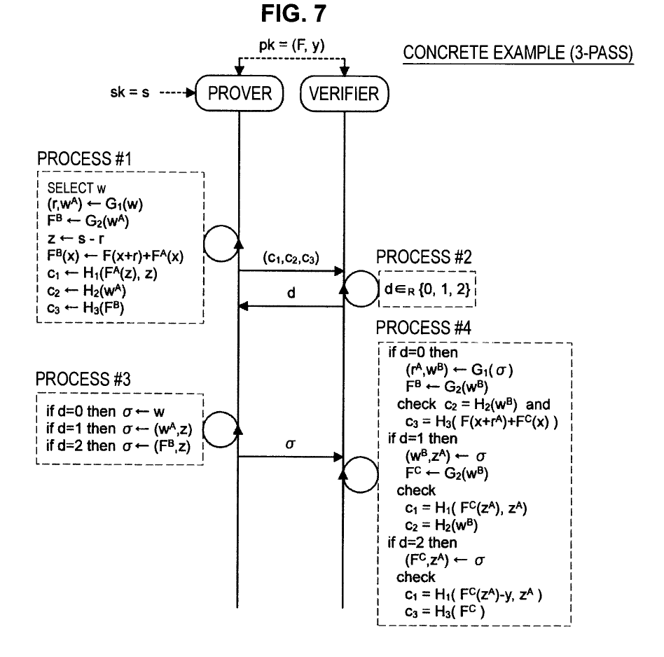

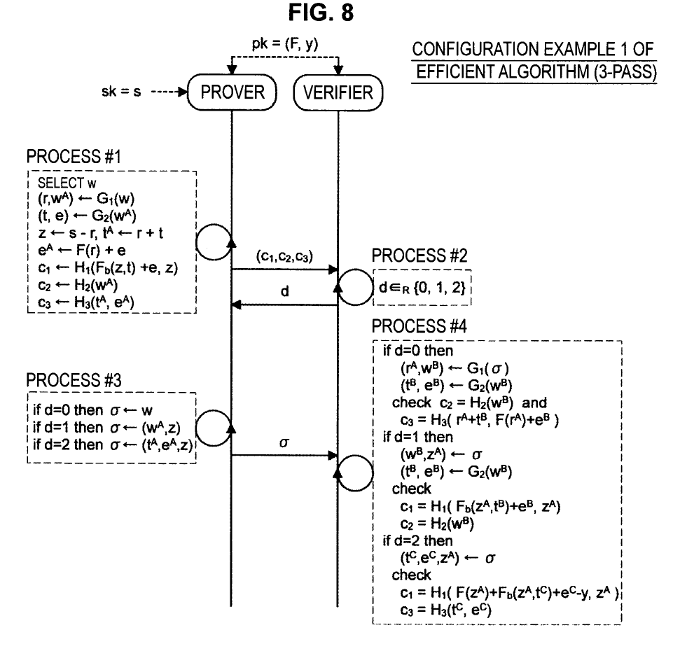

Next, an algorithm of the public key authentication scheme according to the first embodiment (3-pass) of the present technology will be described with reference to FIG. 4. Next, an extended algorithm of the public key authentication scheme according to the embodiment will be described with reference to FIG. 5. Next, a parallel algorithm of the public key authentication scheme according to the embodiment will be described with reference to FIG. 6. Next, a concrete algorithm of the public key authentication scheme according to the embodiment will be described with reference to FIG. 7. Next, an efficient algorithm of the public key authentication scheme according to the embodiment and modifications thereof will be described with reference to FIGS. 8 to 15.

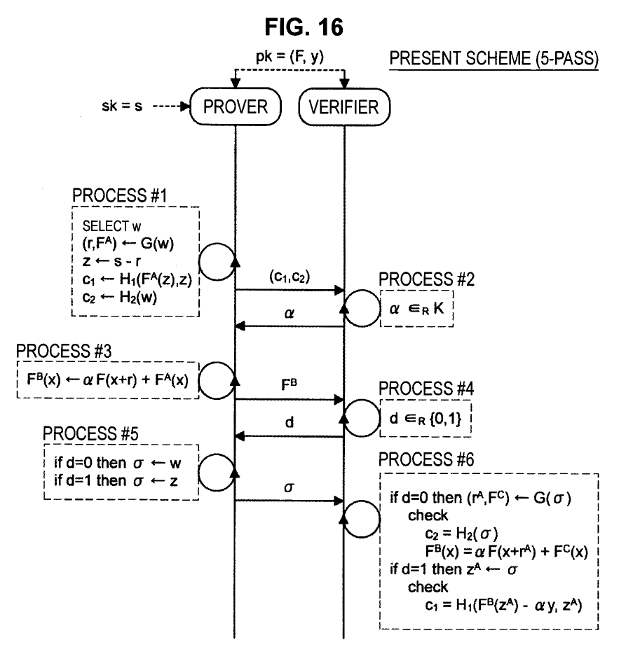

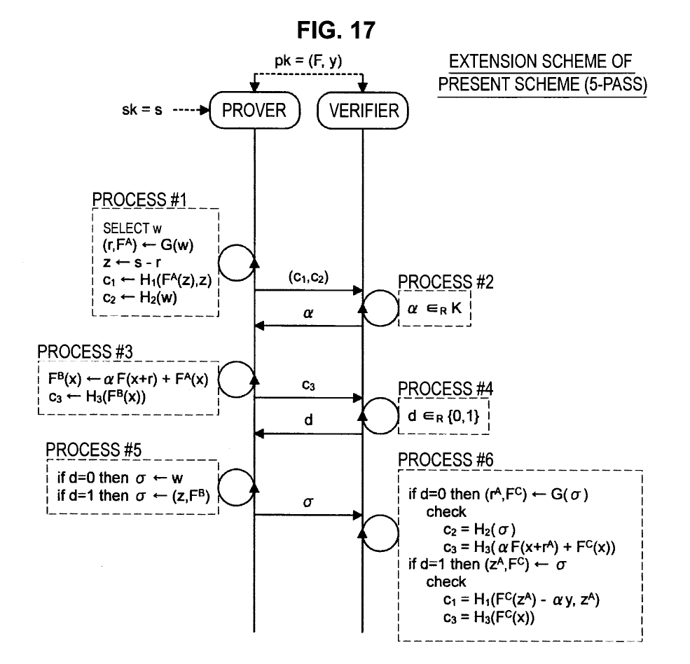

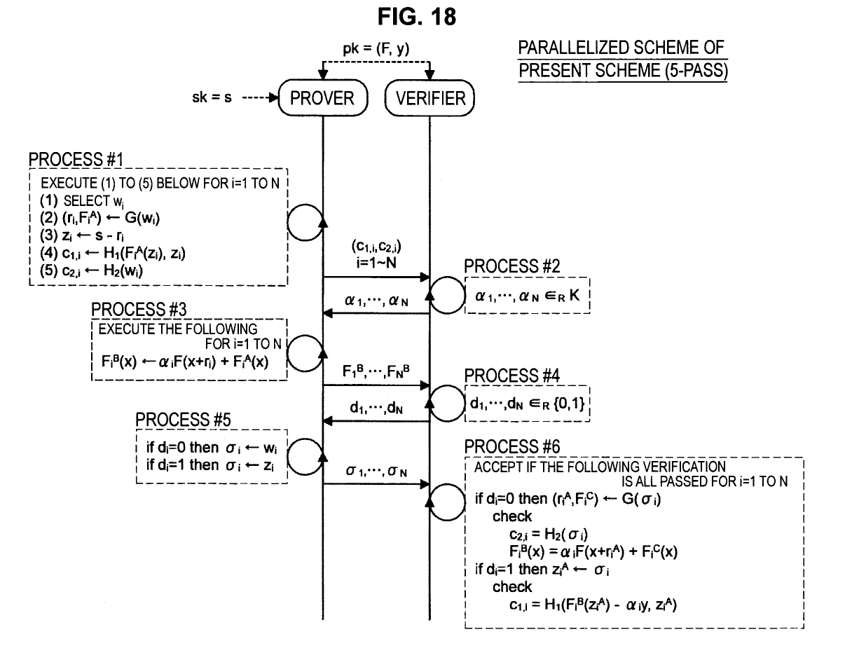

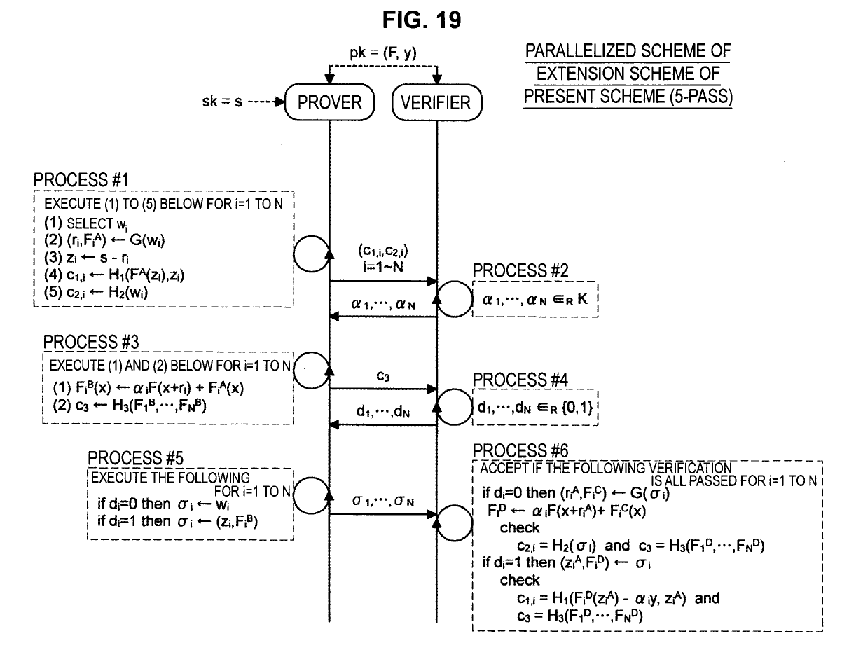

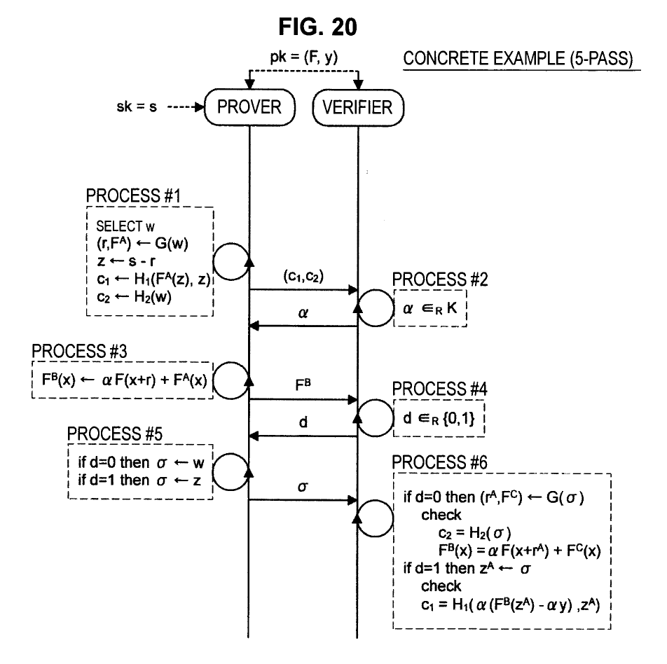

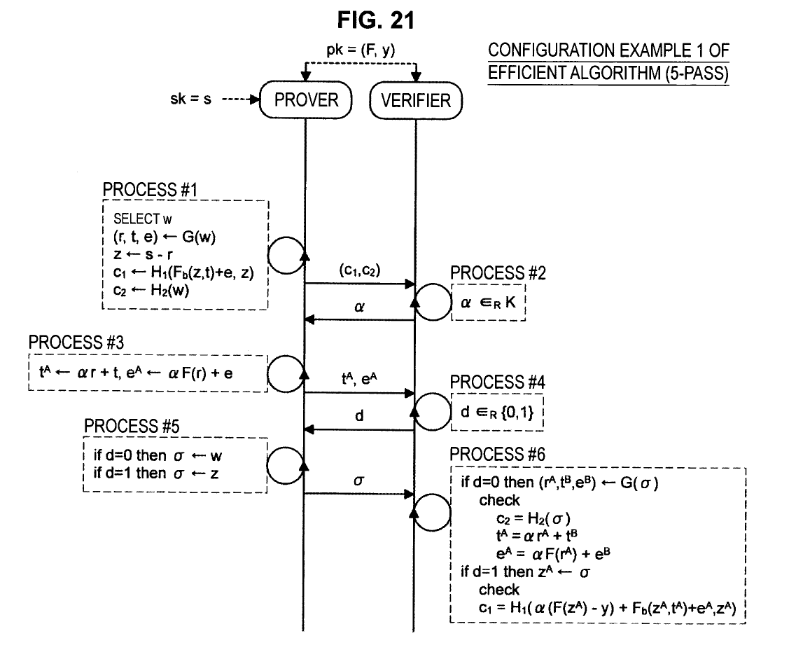

Next, the algorithm of the public key authentication scheme according to the second embodiment (5-pass) of the present technology will be described with reference to FIG. 16. Next, the extended algorithm of the public key authentication scheme according to the embodiment will be described with reference to FIG. 17. Next, the parallel algorithm of the public key authentication scheme according to the embodiment will be described with reference to FIGS. 18 and 19. Next, the concrete algorithm of the public key authentication scheme according to the embodiment will be described with reference to FIG. 20. Next, the efficient algorithm of the public key authentication scheme according to the embodiment and modifications thereof will be described with reference to FIGS. 21 to 35.

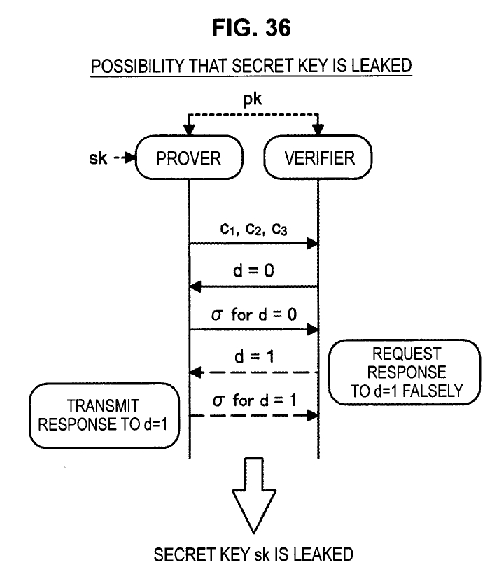

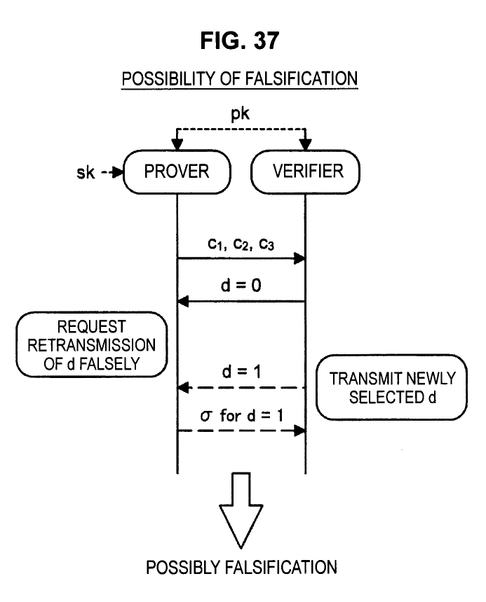

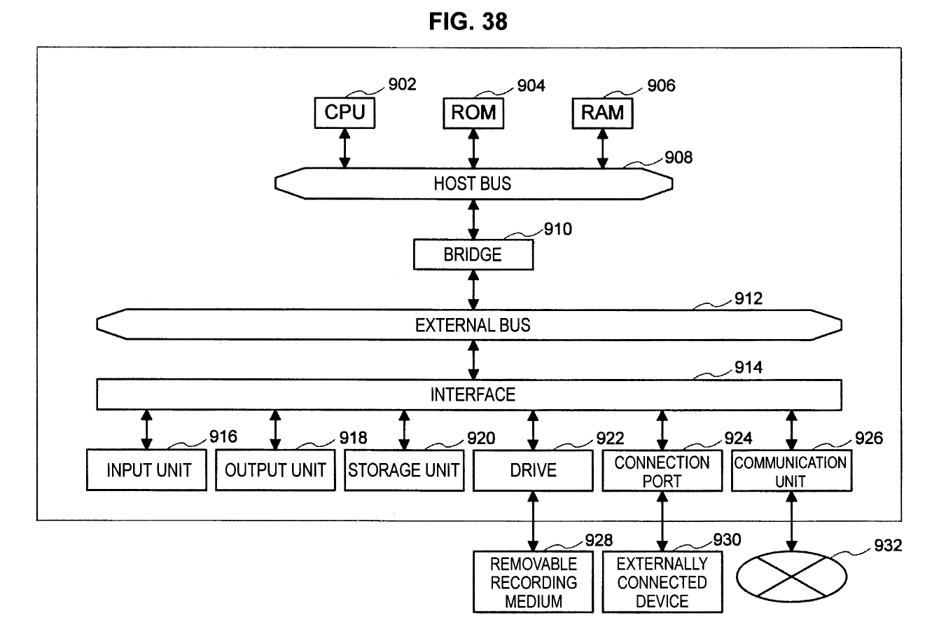

Next, an extending scheme of applying the efficient algorithm according to the first or second embodiment to a multivariable polynomial of the order 2 or higher. Next, a mechanism to increase robustness of an interactive protocol according to the first or second embodiment of the present technology will be described. Also, a mechanism to avoid leakage of a secret key resulting from irregular requests and a mechanism to deny opportunities of falsification with reference to FIGS. 36 and 37. Next, a hardware configuration example of an information processing apparatus capable of realizing each algorithm according to the first and second embodiments of the present technology with reference to FIG. 38.

Lastly, technical ideas of the embodiments will be summarized and operation effects obtained from the technical ideas will briefly be described.

(Description Items)

1: Introduction

1-1: Algorithm of the public key authentication scheme
1-2: Algorithm of the digital signature scheme
1-3: n-pass public key authentication scheme

2: First embodiment
2-1: Algorithm of the public key authentication scheme
2-2: Extended algorithm
2-3: Parallel algorithm
2-4: Concrete example (when a second-order polynomial is used)
2-5: Efficient algorithm
2-6: Modification to the digital signature scheme
   2-6-1: Modification method
   2-6-2: Making the digital signature algorithm more efficient
2-7: Form of a multi-order multivariable simultaneous equation
   2-7-1: Form of the common key block cipher
   2-7-2: Form of the hash function
   2-7-3: Form of the stream cipher
2-8: Serial/parallel hybrid algorithm

3: Second embodiment
3-1: Algorithm of the public key authentication scheme
3-2: Extended algorithm
3-3: Parallel algorithm
3-4: Concrete example (when a second-order polynomial is used)
3-5: Efficient algorithm
3-6: Serial/parallel hybrid algorithm

4: Extension of the efficient algorithm
4-1: Higher-order multivariable polynomial
4-2: Extension scheme (addition of a high-order term)

5: Mechanism to enhance robustness
5-1: Setting method of system parameters
5-2: Method of responding to irregular requests
   5-2-1: Response method by the prover
   5-2-2: Response method by the verifier

6: Hardware configuration example

7: Conclusion

### 1: Introduction

First, before starting the description of the embodiments according to the present technology in detail, an overview of the algorithm of the public key authentication method, algorithm of the digital signature scheme, and n-pass public key authentication method will briefly be provided.

[1-1: Algorithm of the Public Key Authentication Scheme]

First, an overview of the algorithm of a public key authentication scheme will be provided with reference to FIG. 1. FIG. 1 is an explanatory view illustrating an overview of the algorithm of a public key authentication scheme.

Public key authentication is used so that some person (prover) can convince another person (verifier) of the identity of the prover by using a public key pk and a secret key sk. For example, a public key pk_{A} of a prover A is made public to a verifier B. On the other hand, a secret key sk_{A} of the prover A is managed in secret by the prover A. In the mechanism of public key authentication, the person knowing the secret key sk_{A} corresponding to the public key pk_{A} is considered to be the prover A.

In order for the prover A to prove to the verifier B that the prover A is the person identified as the prover A by using the mechanism of public key authentication, the prover A may show evidence to the verifier B that the prover A knows the secret key sk_{A} corresponding to the public key pk_{A} via an interactive protocol. Then, if the prover A shows evidence to the verifier B that the prover A knows the secret key sk_{A} and the verifier B verifies the evidence, the authenticity (identity) of the prover A is verified.

However, the following conditions are attached to the mechanism of public key authentication to secure safety.

The first condition is to “minimize the probability that falsification by a falsifier having no secret key sk is established when an interactive protocol is executed”. Establishment of the first condition is called “soundness”. That is, the soundness can be expressed, in other words, as “falsification will not be established with a non-negligible probability by a falsifier having no secret key sk during interactive protocol”. The second condition is that “even if an interactive protocol is executed, information about the secret key sk_{A} held by the prover A is not leaked to the verifier B at all”. Establishment of the second condition is called “zero knowledge”.

To perform public key authentication safely, it is necessary to use a dialog protocol having soundness and zero knowledge. If authentication processing is performed by using an interactive protocol having no soundness or zero knowledge, no one can deny the possibility of falsification or the possibility of leakage of information about the secret key and thus, even if the processing is successfully completed, the authenticity of the prover is not yet verified. Thus, how to guarantee soundness and zero knowledge becomes important.

(Model)

In a mode of the public key authentication scheme, as shown in FIG. 1, two entities called a prover and a verifier exist. The prover generates a pair of the secret key sk and the public key pk specific to the prover by using a key generation algorithm Gen. Next, the prover executes an interactive protocol with the verifier by using the generated pair of the secret key sk and the public key pk using the key generation algorithm Gen. At this point, the prover executes the interactive protocol by using a prover algorithm P. As described above, the prover uses the prover algorithm P to show evidence to the verifier than the prover holds the secret key sk during the dialog.

On the other hand, the verifier executes the interactive protocol by using a verifier algorithm V to verify whether the prover holds the secret key corresponding to the public key made public by the prover. That is, the verifier is an entity that verifies whether the prover holds the secret key corresponding to the public key. Thus, the model of the public key authentication scheme includes two entities of the prover and verifier and three algorithms of the key generation algorithm Gen, the prover algorithm P, and the verifier algorithm V.

In the description that follows, the expressions of “prover” and “verifier” are used and these expressions mean entities in a strict sense. Therefore, the main body executing the key generation algorithm Gen and the prover algorithm P is an information processing apparatus corresponding to the entity of the “prover”. Similarly, the main body executing the verifier algorithm V is an information processing apparatus. The hardware configuration of these information processing apparatuses is, for example, as shown in FIG. 38. That is, the key generation algorithm Gen, the prover algorithm P, and the verifier algorithm V are executed by a CPU 902 or the like based on a program recorded in a ROM 904, a RAM 906, a storage unit 920, a removable recording medium 928 or the like.

(Key Generation Algorithm Gen)

The key generation algorithm Gen is used by the prover. The key generation algorithm Gen is an algorithm that generates a pair of the secret key sk and the public key pk specific to the prover. The public key pk generated by the key generation algorithm Gen is made public. Then, the public key pk made public is used by the verifier. On the other hand, the secret key sk generated by the key generation algorithm Gen is managed in secret by the prover. Then, the secret key sk managed in secret by the prover is used to prove to the verifier that the prover holds the secret key sk corresponding to the public key pk. The key generation algorithm Gen is formally expressed as an algorithm that takes a security parameter 1^{λ} (λ is an integer equal to 0 or greater) as input and outputs the secret key sk and the public key pk like the following formula (1):

(sk,pk)←Gen(1^{λ}) (1)

(Prover Algorithm P)

The prover algorithm P is used by the prover. The prover algorithm P is an algorithm to prove to the verifier that the prover holds the secret key sk corresponding to the public key pk. That is, the prover algorithm P is an algorithm that takes the secret key sk and the public key pk as input to execute the interactive protocol.

(Verifier Algorithm V)

The verifier algorithm V is used by the verifier. The verifier algorithm V is an algorithm to verify whether the prover holds the secret key sk corresponding to the public key pk during interactive protocol. The verifier algorithm V is an algorithm that takes the public key pk as input to output 0 or 1 (1 bit) in accordance with the execution result of the interactive protocol. The verifier judges that the prover is invalid if the verifier algorithm V outputs 0 and judges that the prover is valid if the verifier algorithm V outputs 1. The verifier algorithm V is formally expressed like the following formula (2):

0/1←V(pk) (2)

To realize meaningful public key authentication, as described above, it is necessary for the interactive protocol to satisfy two conditions of soundness and zero knowledge. However, to prove that the prover holds the secret key sk, it is necessary for the prover to perform a procedure dependent on the secret key sk and notify the verifier of the result before causing the verifier to make verification based on the notification content. It is necessary to perform a procedure dependent on the secret key sk to secure the soundness. On the other hand, it is necessary to prevent leakage of information about the secret key sk to the verifier. Thus, to meet such requirements, it is necessary to design the key generation algorithm Gen, the prover algorithm P, and the verifier algorithm V adeptly.

In the foregoing, an overview of algorithms in the public key authentication scheme has been provided.

[1-2: Algorithm of the Digital Signature Scheme]

Next, an overview of the algorithm of a digital signature scheme will be provided with reference to FIG. 2. FIG. 2 is an explanatory view illustrating an overview the algorithm of a digital signature scheme.

In contrast to paper documents, it is difficult to put a stamp or affix a signature to digitized data. Thus, to prove the creator of digitized data, an electronic mechanism achieving an effect similar to putting a stamp or affixing a signature is necessary. The mechanism is the digital signature. The digital signature is a mechanism in which signature data known only to the creator of data is provided to a recipient by associating with the data and the signature data is verified by the recipient.

(Model)

In a model of the digital signature scheme, as shown in FIG. 2, two entities called a signer and a verifier exist. Then, the model of the digital signature scheme includes three algorithms of the key generation algorithm Gen, a signature generation algorithm Sig, and a signature verification algorithm Ver.

The signer generates a pair of a signature key sk and a verification key pk specific to the signer by using the key generation algorithm Gen. The signer also generates a digital signature σ to be attached to a document M by using the signature generation algorithm Sig. That is, the signer is an entity that attaches a digital signature to the document M. On the other hand, the verifier verifies the digital signature σ attached to the document M by using the signature verification algorithm Ver. That is, the verifier is an entity that verifies the digital signature σ to check whether the creator of the document M is the signer.

In the description that follows, the expressions of “signer” and “verifier” are used and these expressions mean entities in a strict sense. Therefore, the main body executing the key generation algorithm Gen and the signature generation algorithm Sig is an information processing apparatus corresponding to the entity of the “signer”. Similarly, the main body executing the signature verification algorithm Ver is an information processing apparatus. The hardware configuration of these information processing apparatuses is, for example, as shown in FIG. 38. That is, the key generation algorithm Gen, the signature generation algorithm Sig, and the signature verification algorithm Ver are executed by the CPU 902 or the like based on a program recorded in the ROM 904, the RAM 906, the storage unit 920, the removable recording medium 928 or the like.

(Key Generation Algorithm Gen)

The key generation algorithm Gen is used by the signer. The key generation algorithm Gen is an algorithm that generates a pair of the signature key sk and the verification key pk specific to the signer. The verification key pk generated by the key generation algorithm Gen is made public. On the other hand, the signature key sk generated by the key generation algorithm Gen is managed in secret by the signer. Then, the signature key sk is used for the generation of the digital signature σ to be attached to the document M. For example, the key generation algorithm Gen takes a security parameter 1^{λ} (λ is an integer equal to 0 or greater) as input and outputs the signature key sk and the verification key pk. In this case, the key generation algorithm Gen can be expressed formally like the following formula (3):

(sk,pk)←Gen(1^{λ}) (3)

(Signature Generation Algorithm Sig)

The signature generation algorithm Sig is used by the signer. The signature generation algorithm Sig is an algorithm that generates the digital signature a to be attached to the document M. The signature generation algorithm Sig is an algorithm that takes the signature key sk and the document M as input and outputs the digital signature σ. The signature generation algorithm Sig can formally be expressed like the following formula (4):

σ←Sig(sk,M) (4)

(Signature Verification Algorithm Ver)

The signature verification algorithm Ver is used by the verifier. The signature verification algorithm Ver is an algorithm to verify whether the digital signature σ is a valid digital signature to the document M. The signature verification algorithm Ver is an algorithm that takes the verification key pk of the signer, the document M, and the digital signature σ as input and outputs 0 or 1 (1 bit). The signature verification algorithm Ver can formally be expressed like the following formula (5): The verifier judges that the digital signature σ is invalid if the signature verification algorithm Ver outputs 0 (the verification key pk rejects the document M and the digital signature σ) and judges that the digital signature σ is valid if the signature verification algorithm Ver outputs 1 (the verification key pk accepts the document M and the digital signature σ).

0/1←Ver(pk,M,σ) (5)

In the foregoing, an overview of algorithms in the digital signature scheme has been provided.

[1-3: N-Pass Public Key Authentication Scheme]

Next, an n-pass public key authentication scheme will be described with reference to FIG. 3. FIG. 3 is an explanatory view illustrating an n-pass public key authentication scheme.

The public key authentication scheme is, as described above, an authentication scheme that proves to the verifier that the prover holds the secret key sk corresponding to the public key pk during interactive protocol. Moreover, it is necessary for the interactive protocol to satisfy two conditions of soundness and zero knowledge. Thus, as shown in FIG. 3, the prover and the verifier exchange information n times while each performing respective processing.

In the n-pass public key authentication scheme, processing (process #1) is performed by the prover by using the prover algorithm P and information T₁ is transmitted to the verifier. Next, processing (process #2) is performed by the verifier by using the verifier algorithm V and information T₂ is transmitted to the prover. Further, processing is performed and information Tₖ is transmitted sequentially for k=3 to n before processing (process #n+1) is performed lastly. The scheme by which information is transmitted and received n times as described above is called the “n-pass” public key authentication scheme.

In the foregoing, the n-pass public key authentication scheme has been described.

### 2: First Embodiment

The first embodiment of the present technology will be described below. The present embodiment relates to a public key authentication scheme and a digital signature scheme whose safety is grounded on difficulty of solving a problem of a multi-order multivariable simultaneous equation. However, in contrast to the scheme in related art like the HFE digital signature scheme, the present embodiment relates to a public key authentication scheme and a digital signature scheme using a multi-order multivariable simultaneous equation having no method (trapdoor) of efficiently solving the equation.

[2-1: Algorithm of the Public Key Authentication Scheme]

First, the algorithm of the public key authentication scheme according to the present embodiment (hereinafter, called the present scheme) will be described with reference to FIG. 4. FIG. 4 is an explanatory view illustrating the algorithm of the present scheme. The present scheme includes the key generation algorithm Gen, the prover algorithm P, and the verifier algorithm V. The configuration of each algorithm will be described below.

(Key Generation Algorithm Gen)

The key generation algorithm Gen generates m multivariable polynomials f₁(x₁, . . . , xₙ), . . . , fₘ(x₁, . . . , xₙ) defined on a ring K and a vector s=(s₁, . . . , sₙ)εKⁿ. Next, the key generation algorithm Gen calculates y=(y₁, . . . , yₘ)←(f₁(s), . . . , fₘ(s)). Then, the key generation algorithm Gen sets (f₁(x₁, . . . , x₁), . . . , fₘ(x₁, . . . , x₁), y) as the public key pk and s as the secret key. The vector (x₁, . . . , x₁) will be denoted as x and a set of multivariable polynomials (f₁(x), . . . , fₘ(x)) will be denoted as F(x) below.

(Prover Algorithm P, Verifier Algorithm V)

Next, processing performed by the prover algorithm P and processing performed by the verifier algorithm V during interactive protocol will be described with reference to FIG. 4.

During the above interactive protocol, the prover proves to the verifier that “the prover knows s satisfying y=F(s)” without leaking information about the secret key s to the verifier at all. On the other hand, the verifier verifies whether the prover knows s satisfying y=F(s). It is assumed that the public key pk is made public to the verifier. It is also assumed that the secret key s is managed in secret by the prover. The description will be provided below along the flow chart shown in FIG. 4.

Process #1:

First, the prover algorithm P selects any number w. Next, the prover algorithm P generates a vector rεKⁿ and a number w^{A} by applying the number w to a pseudo random number generator G₁. That is, the prover algorithm P calculates (r, w^{A})←G₁(w). Next, the prover algorithm P generates a multivariable polynomial F^{A}(x)=(f^{A}₁(x), . . . , f^{A}ₘ(x)) by applying the number w^{A} to a pseudo random number generator G₂. That is, the prover algorithm P calculates F^{A}←G₂(w^{A}).

Process #1(Continued):

Next, the prover algorithm P calculates z←s−r. This calculation corresponds to an operation to mask the secret key s with the vector r. Further, the prover algorithm P calculates F^{B}(x)←F(x+r)+F^{A}(x). This calculation corresponds to an operation to mask a multivariable polynomial F(x+r) regarding x with a multivariable polynomial F^{A}(x).

Process #1(Continued):

Next, the prover algorithm P generates a hash value c₁ of F^{A}(z) and z. That is, the prover algorithm P calculates c₁←H₁(F^{A}(z), z). The prover algorithm P also generates a hash value c₂ of the number w^{A}. That is, the prover algorithm P calculates c₂←H₂(w^{A}). Further, the prover algorithm P generates a hash value c₃ of the multivariable polynomial F^{B}. That is, the prover algorithm P calculates c₃←H₃(F^{B}(x)). H₁( . . . ), H₂( . . . ), and H₃( . . . ) shown above are hash functions. The hash values (c₁, c₂, c₃) are transmitted to the verifier algorithm V as a message. Note that information about s, information about r, and information about z are not leaked to the verifier at all.

Process #2:

The verifier algorithm V that receives the message (c₁, c₂, c₃) makes a selection of which verification pattern of the three verification patterns to use. For example, the verifier algorithm V selects one number from three numbers {0, 1, 2} representing the verification patterns and sets the selected number to a request d.

The request d is transmitted to the prover algorithm P.

Process #3:

The prover algorithm P that receives the request d generates a response σ to be transmitted to the verifier algorithm V in accordance with the received request d. If d=0, the prover algorithm P generates the response σ=w. If d=1, the prover algorithm P generates the response σ=(w^{A}, z). If d=2, the prover algorithm P generates the response σ=(F^{B}(z), z). The response σ generated in process #3 is transmitted to the verifier algorithm V. Note that information about z when d=0 is not leaked to the verifier at all or information about r when d=1 or 2 is not leaked to the verifier at all.

Process #4:

The verifier algorithm V that receives the response σ performs the following verification processing by using the received response σ.

If d=0, the verifier algorithm V calculates (r^{A}, w^{B})←G₁(σ). Further, the verifier algorithm V calculates F^{C}←G₂(w^{B}). Then, the verifier algorithm V verifies whether c₂=H₂(w^{B}) holds. The verifier algorithm V also verifies whether c₃=H₃(F(x+r^{A})+F^{C}(x)) holds. The verifier algorithm V outputs the value 1 indicating successful authentication if the verifications are all successful and outputs the value 0 indicating an authentication failure if a failure occurs in one of verifications.

If d=1, the verifier algorithm V sets (w^{B}, z^{A})←σ. Further, the verifier algorithm V calculates F^{C}←G₂(w^{B}). Then, the verifier algorithm V verifies whether c₁=H₁(F^{C}(z^{A}), z^{A})) holds. The verifier algorithm V also verifies whether c₂=H₂(w^{B}) holds. The verifier algorithm V outputs the value 1 indicating successful authentication if the verifications are all successful and outputs the value 0 indicating an authentication failure if a failure occurs in one of verifications.

If d=2, the verifier algorithm V sets (F^{D}, z^{A})←σ. Then, the verifier algorithm V verifies whether c₁=H₁(F^{D}(z^{A})−y,z^{A})) holds. Further, the verifier algorithm V verifies whether c₃=H₃(F^{D}) holds. The verifier algorithm V outputs the value 1 indicating successful authentication if the verifications are all successful and outputs the value 0 indicating an authentication failure if a failure occurs in one of verifications.

In the foregoing, the configuration of each algorithm according to the present scheme has been described.

(Soundness of the Present Scheme)

The soundness of the present scheme will supplementarily be described. The soundness of the present scheme is guaranteed based on a logic that “if the prover algorithm P returns the correct response σ to all requests d=0, 1, 2 that can be selected by the verifier algorithm V, F^{D}, F^{C}, r^{A}, and z^{A} satisfying the following equations (6) and (7) become calculable”

F^{D}(x)F(x+r^{A})+F^{C}(x) (6)

F^{D}(z^{A})−y=F^{C}(z^{A}) (7)

With the above soundness guaranteed, it is guaranteed to be difficult to be successful in falsification with a probability higher than ⅔ as long as a problem of a multi-order multivariable simultaneous equation is not solved. That is, to be able to respond correctly to all requests d=0, 1, 2 of the verifier, it is necessary for the falsifier to be able to calculate F^{D}, F^{C}, r^{A}, and z^{A} satisfying the following equations (6) and (7). In other words, it is necessary for the falsifier to be able to calculate s satisfying F(s)=y. However, there is still a possibility that the falsifier can respond correctly up to two requests d=0, 1, 2 of the verifier. Thus, the probability of successful falsification becomes ⅔. By executing the above interactive protocol a sufficient number of times, the probability of successful falsification can be made negligibly small.

In the foregoing, the soundness of the present scheme has been described.

(Modification)

A modification of the above algorithm will be presented. The above key generation algorithm Gen calculates y←F(s) and then sets (F, y) as the public key. In the present modification, on the other hand, the key generation algorithm Gen calculates (y₁, . . . , yₘ)←F(s) and (f₁*(x), fₘ*(x))←(f₁(x)−y₁, . . . , fₘ(x)−yₘ) and then sets (f₁*, . . . , fₘ*) as the public key. With the above modification, it becomes possible to execute the interactive protocol by setting y=0.

The above prover algorithm P generates the message c₁ from F^{B}(z) and z. However, if a modification is made to generate the message c₁ from F^{A}(z) and z, the same interactive protocol can be realized due to the relationship F^{B}(z)=F^{A}(z). The configuration of the prover algorithm P may also be modified so that a hash value of F^{B}(z) and a hash value of z are separately calculated and each hash value is transmitted to the verifier algorithm V as a message.

The above prover algorithm P generates a vector r and a number w^{A} by applying a number w to the pseudo random number generator G₁. Also, the above prover algorithm P generates a multivariable polynomial F^{A}(x) by applying a number w^{A} to the pseudo random number generator G₂. However, the configuration of the prover algorithm P may be modified so that w=(r, F^{A}) is calculated from the start by setting G₁ as an identity mapping. In this case, it is not necessary to apply the number w to G₁. This also applies to G₂.

In the above interactive protocol, (F, y) is set as the public key. A multivariable polynomial F contained in the public key is a parameter independent of the secret key sk. Thus, instead of setting the multivariable polynomial F for each prover, the multivariable polynomial F common throughout the system may be used. In this case, the public key to be set for each prover is only y, which allows the size of the public key smaller. However, from the viewpoint of safety, some cases in which it is desirable to set the multivariable polynomial F for each prover can also be considered. The method of setting the multivariable polynomial F in such a case will be described in detail later.

In the above interactive protocol, (f₁, . . . , fₘ, y) is set as the public key, but F=(f₁, . . . , fₘ) is a parameter that may be selected conveniently. Thus, the prover and the verifier may calculate, for example, F←G*(wₚₖ) by providing a seed wₚₖ of random numbers and using a pseudo random number generator G*. In this case, the (wₚₖ, y) becomes the public key and the public key can be made smaller in size compared with a case when (F, y) is made public as the public key.

According to the above algorithm, c₁, c₂, and c₃ are calculated by using the has functions H₁, H₂, H₃, but a commitment function COM may be used in place of the has functions. The commitment function COM is a function that takes two arguments of a character string S and a random number p. Examples of the commitment function include a system published by Shai Halevi and Silvio Micali at the international conference CRYPT01996.

If a commitment function is used, random numbers ρ₁, ρ₂, ρ₃ are provided before calculating c₁, c₂, and c₃ and commitment functions COM(,ρ₁), COM(,ρ₂), COM(,ρ₂) are applied, instead of the hash functions H₁(), H₂(), H₃(), to generate c₁, c₂, and c₃. Incidentally, p, necessary for the verifier to generate cᵢ, is transmitted by being included in the response cr. These modifications can be applied to all algorithms described later.

In the foregoing, a modification of the present scheme has been described.

[2-2: Extended Algorithm]

Next, the algorithm of a public key authentication scheme extending the present scheme (hereinafter, called the extending scheme) will be described with reference to FIG. 5. FIG. 5 is an explanatory view illustrating the flow of the interactive protocol based on the extending scheme.

According to the extending scheme described here, the message (c₁, c₂, c₃) to be transmitted in the first pass is converted into one hash value c and then transmitted to the verifier. Any message that cannot be restored even by using the response σ transmitted in the third pass is transmitted to the verifier together with the response σ. If the extending scheme is applied, the amount of information to be transmitted to the verifier during interactive protocol can be reduced. The configuration of each algorithm according to the extending scheme will be described in detail below.

(Key Generation Algorithm Gen)

The key generation algorithm Gen generates m multivariable polynomials f₁(x₁, . . . , xₙ), . . . , fₘ(x₁, . . . , xₙ) defined on a ring K and a vector s=(s₁, . . . , sₙ)εKⁿ. Next, the key generation algorithm Gen calculates y=(y₁, . . . , yₘ)←(f₁(s), . . . , fₘ(s)). Then, the key generation algorithm Gen sets (f₁(x₁, . . . , xₙ), . . . , fₘ(x₁, . . . , xₙ), y) as the public key pk and s as the secret key. The vector (x₁, . . . , xₙ) will be denoted as x and a set of multivariable polynomials (f₁(x), . . . , fₘ(x)) will be denoted as F(x) below.

(Prover Algorithm P, Verifier Algorithm V)

Next, processing performed by the prover algorithm P and processing performed by the verifier algorithm V during interactive protocol will be described with reference to FIG. 5.

During the above interactive protocol, the prover proves to the verifier that “the prover knows s satisfying y=F(s)” without leaking information about the secret key s to the verifier at all. On the other hand, the verifier verifies whether the prover knows s satisfying y=F(s). It is assumed that the public key pk is made public to the verifier. It is also assumed that the secret key s is managed in secret by the prover. The description will be provided below along the flow chart shown in FIG. 5.

Process #1:

First, the prover algorithm P selects any number w. Next, the prover algorithm P generates a vector rεKⁿ and a number w^{A} by applying the number w to the pseudo random number generator G₁. That is, the prover algorithm P calculates (r, w^{A})←G₁(w). Next, the prover algorithm P generates a multivariable polynomial F^{A}(x)=(f^{A}₁(x), . . . , f^{A}ₘ(x)) by applying the number w^{A} to the pseudo random number generator G₂. That is, the prover algorithm P calculates F^{A}←G₂(w^{A}).

Process #1(Continued):

Next, the prover algorithm P calculates z←s−r. This calculation corresponds to an operation to mask the secret key s with the vector r. Further, the prover algorithm P calculates F^{B}(x)←F(x+r)+F^{A}(x). This calculation corresponds to an operation to mask a set of multivariable polynomials F(x+r) regarding x with a set of multivariable polynomials F^{A}(x).

Process #1(Continued):

Next, the prover algorithm P generates a hash value c₁ of F^{B}(z) and z. That is, the prover algorithm P calculates c₁←H₁(F^{B}(z), z). The prover algorithm P also generates a hash value c₂ of the number w^{A}. That is, the prover algorithm P calculates c₂←H₂(w^{A}). Further, the prover algorithm P generates a hash value c₃ of a set of multivariable polynomials F^{B}. That is, the prover algorithm P calculates c₃←H₃(F^{B}). H₁( . . . ), H₂( . . . ), and H₃( . . . ) shown above are hash functions. In the extending scheme, the prover algorithm P generates a hash value c by applying a set of hash values (c₁, c₂, c₃) to a hash function H and transmits the generated hash value c to the verifier algorithm V.

Process #2:

The verifier algorithm V that receives the hash value c makes a selection of which verification pattern of the three verification patterns to use. For example, the verifier algorithm V selects one number from three numbers {0, 1, 2} representing the verification patterns and sets the selected number to a request d. The request d is transmitted to the prover algorithm P.

Process #3:

The prover algorithm P that receives the request d generates a response σ to be transmitted to the verifier algorithm V in accordance with the received request d. If d=0, the prover algorithm P generates the response (σ, c*)=(w, c₁). If d=1, the prover algorithm P generates the response (σ, c*)=((w^{A}, z), c₃). If d=2, the prover algorithm P generates the response (σ, c*)=((F^{B}, z), c₂). The response (σ, c*) generated in process #3 is transmitted to the verifier algorithm V.

Process #4:

The verifier algorithm V that receives the response (σ, c*) performs the following verification processing by using the received response (σ, c*).

If d=0, the verifier algorithm V calculates (r^{A}, w^{B})←G₁(σ). Next, the verifier algorithm V calculates F^{C}←G₂(w^{B}). Next, the verifier algorithm V calculates c₂^{A}=H₂(w^{B}). Next, the verifier algorithm V calculates c₃^{A}=H₃(F(x+r^{A})+F^{C}(x)). Then, the verifier algorithm V verifies whether c=H(c*, c₂^{A}, c₃^{A}) holds. Then, the verifier algorithm V outputs the value 1 indicating successful authentication if the verification is successful and outputs the value 0 indicating an authentication failure if the verification fails.

If d=1, the verifier algorithm V sets (w^{B}, z^{A})←σ. Next, the verifier algorithm V calculates F^{C}←G₂(w^{B}). Next, the verifier algorithm V calculates c₁^{A}=H₁(Fc(z^{A}), z^{A}).) Next, the verifier algorithm V calculates c₂^{A}=H₂(w^{B}). Then, the verifier algorithm V verifies whether c=H(c₁^{A}, c₂^{A}, c*). Then, the verifier algorithm V outputs the value 1 indicating successful authentication if the verification is successful and outputs the value 0 indicating an authentication failure if the verification fails.

If d=2, the verifier algorithm V sets (F^{D}, z^{A})←σ. Next, the verifier algorithm V calculates c₁^{A}=H₁ (F^{D}(z^{A})−y, z^{A}).) Next, the verifier algorithm V calculates c₃^{A}=H₃(F^{D}). Then, the verifier algorithm V verifies whether c=H(c₁^{A}, c*, c₃^{A}) holds. Then, the verifier algorithm V outputs the value 1 indicating successful authentication if the verification is successful and outputs the value 0 indicating an authentication failure if the verification fails.

In the foregoing, the configuration of each algorithm according to the extending scheme has been described. By applying the extending scheme, the amount of information transmitted and received during interactive protocol can be reduced.

[2-3: Parallel Algorithm]

If, as described above, the interactive protocol according to the present scheme or the extending scheme is applied, the probability with which falsification is successful can be suppressed to ⅔ or below. Therefore, if the interactive protocol is executed twice, the probability with which falsification is successful can be suppressed to (⅔)² or below. Further, if the interactive protocol is executed N times, the probability with which falsification is successful becomes (⅔)^{N} and if N is set to a sufficiently large number (for example, N=140), the probability with which falsification is successful can be made negligibly small.

As methods of executing the interactive protocol a plurality of times, for example, a serial method by which exchanges of messages, requests, and responses are sequentially repeated a plurality of times and a parallel method by which exchanges of messages, requests, and responses for a plurality of times are made by exchanges at a time can be considered. Here, a method of extending the interactive protocol according to the present scheme to an interactive protocol according to a parallel method (hereinafter, called the parallel algorithm) will be described. For example, the parallel algorithm looks as shown in FIG. 6. The content of the parallel algorithm will be described below with reference to FIG. 6.

(Key Generation Algorithm Gen)

The key generation algorithm Gen generates m multivariable polynomials f₁(x₁, . . . , xₙ), fₘ(x₁, . . . , xₙ) defined on a ring K and a vector s=(s₁, sₙ)εKⁿ. Next, the key generation algorithm Gen calculates y=(y₁, yₘ)←(f₁(s), fₘ(s)). Then, the key generation algorithm Gen sets (f₁(x₁, . . . xₙ), . . . , fₘ(x₁, . . . , xₙ), y) as the public key pk and s as the secret key. The vector (x₁, . . . , xₙ) will be denoted as x and a set of multivariable polynomials (f₁(x), . . . , fₘ(x)) will be denoted as F(x) below.

(Prover Algorithm P, Verifier Algorithm V)

Next, processing performed by the prover algorithm P and processing performed by the verifier algorithm V during interactive protocol will be described with reference to FIG. 6.

During the above interactive protocol, the prover proves to the verifier that “the prover knows s satisfying y=F(s)” without leaking information about the secret key s to the verifier at all. On the other hand, the verifier verifies whether the prover knows s satisfying y=F(s). It is assumed that the public key pk is made public to the verifier. It is also assumed that the secret key s is managed in secret by the prover. The description will be provided below along the flow chart shown in FIG. 6.

Process #1:

First, the prover algorithm P performs processing (1) to processing (8) shown below for i=1 to N.

Processing (1): The prover algorithm P selects any number wᵢ.

Processing (2): The prover algorithm P generates a vector r₁εKⁿ and a number wᵢ^{A} by applying the number w, to the pseudo random number generator G₁. That is, the prover algorithm P calculates (rᵢ, wᵢ^{A})←G₁(wᵢ).

Processing (3): The prover algorithm P generates a set of multivariable polynomials Fᵢ^{A}(x) by applying the number wᵢ^{A} to the pseudo random number generator G₂. That is, the prover algorithm P calculates Fᵢ^{A}←G₂(wᵢ^{A}).

Processing (4): The prover algorithm P generates zᵢ←sᵢ−rᵢ. This calculation corresponds to an operation to mask the secret key sᵢ with the vector rᵢ.

Processing (5): The prover algorithm P calculates Fᵢ^{B}(x)←F(x+rᵢ)+Fᵢ^{A}(x). This calculation corresponds to an operation to mask a set of multivariable polynomials F(x+rᵢ) regarding x with a set of multivariable polynomials Fᵢ^{A}(x).

Processing (6): The prover algorithm P generates a hash value c_{1,i} of Fᵢ^{B}(zᵢ) and zᵢ. That is, the prover algorithm P calculates c_{1,i}←H₁(Fᵢ^{B}(z), z₁).

Processing (7): The prover algorithm P generates a hash value c_{2,i} of the number wᵢ^{A}. That is, the prover algorithm P calculates c_{2,i}←H₂(wᵢ^{A}).

Processing (8): The prover algorithm P generates a hash value c_{3,i} of a set of polynomials Fᵢ^{B}. That is, the prover algorithm P calculates c_{3,i}←H₃(Fᵢ^{B}).

H₁( . . . ), H₂( . . . ), and H₃( . . . ) shown above are hash functions. The hash value (c_{1,i}, c_{2,i}, c_{3,i}) is a message.

After the above processing (1) to processing (8) being performed for i=1 to N, the messages (c_{1,i}, c_{2,i}, c_{3,i}) (i=1 to N) generated in process #1 are transmitted to the verifier algorithm V.

Process #2:

The verifier algorithm V that receives the messages (c_{1,i}, c_{2,i}, c_{3,i}) (i=1 to N) makes a selection of which verification pattern of the three verification patterns to use for each of i=1 to N. For example, the verifier algorithm V selects one number from three numbers {0, 1, 2} representing the verification patterns and sets the selected number to a request dᵢ for each of i=1 to N. The request dᵢ is transmitted to the prover algorithm P.

Process #3:

The prover algorithm P that receives the request dᵢ(i=1 to N) generates a response σᵢ to be transmitted to the verifier algorithm V in accordance with the received request dᵢ. At this point, the prover algorithm P performs processing (1) to processing (3) shown below for i=1 to N.

Processing (1): If dᵢ=0, the prover algorithm P generates a response σᵢ=wᵢ.

Processing (2): If dᵢ=1, the prover algorithm P generates a response σᵢ=(wᵢ^{A}, zᵢ).

Processing (3): If dᵢ=2, the prover algorithm P generates a response σᵢ=(Fᵢ^{B}, zᵢ).

After the above processing (1) to processing (3) being performed, the responses σᵢ (i=1 to N) are transmitted to the verifier algorithm V.

Process #4:

The verifier algorithm V that receives the responses σᵢ (i=1 to N) performs the following verification processing by using the received responses σᵢ (i=1 to N). The following processing is performed for i=1 to N.

If dᵢ=0, the verifier algorithm V calculates (rᵢ^{A}, wᵢ^{B})←G₁(σᵢ). Further, the verifier algorithm V calculates F₁^{C}←G₂(wᵢ^{B}). Then, the verifier algorithm V verifies whether c_{2,i}=H₂(wᵢ^{B}) holds. The verifier algorithm V also verifies whether c_{3,i}=H₃(F(x+rᵢ^{A})+Fᵢ^{C}(x)) holds. The verifier algorithm V outputs the value 1 indicating successful authentication if the verifications are all successful and outputs the value 0 indicating an authentication failure if a failure occurs in one of verifications.

If d₁=1, the verifier algorithm V sets (wᵢ^{B}, z₁^{A})←σ₁. Further, the verifier algorithm V calculates F₁^{C}←G₂(wᵢ^{B}). Then, the verifier algorithm V verifies whether c_{1,i}=H₁(F₁^{C}(zᵢ^{A}), zᵢ^{A}) holds. The verifier algorithm V also verifies whether c₂=H₂(wᵢ^{B}) holds. The verifier algorithm V outputs the value 1 indicating successful authentication if the verifications are all successful and outputs the value 0 indicating an authentication failure if a failure occurs in one of verifications.

If dᵢ=2, the verifier algorithm V sets (Fᵢ^{D}, zᵢ^{A})←σᵢ. Then, the verifier algorithm V verifies whether c_{1,i}=H₁(Fᵢ^{D}(zᵢ^{A})−y, z₁^{A}) holds. Further, the verifier algorithm V verifies whether c_{3,i}=H₃(Fᵢ^{D}(x)) holds. The verifier algorithm V outputs the value 1 indicating successful authentication if the verifications are all successful and outputs the value 0 indicating an authentication failure if a failure occurs in one of verifications.

In the foregoing, the method of executing the interactive protocol according to the present scheme in parallel has been described. By repeatedly executing the interactive protocol according to the present scheme as described above, the probability with which falsification is successful can be reduced to a negligible level.

Incidentally, a modification may be made so that after process #1, instead of (c_{1,1}, c_{1,2}, c_{1,3}, . . . , c_{N,1}, c_{N,2}, c_{N,3}) being transmitted to the verifier, a hash value c=H(c_{1,1}, c_{1,2}, c_{1,3}, . . . , c_{N,1}, c_{N,2}, c_{N,3}) is transmitted. However, considering the existence of messages that cannot be restored from responses, it is necessary to modify the interactive protocol so that such messages are transmitted from the prover to the verifier together with a response. If the modification is applied, only one hash value c is transmitted in the first pass, reducing the amount of communication significantly. For example, if configured to repeat N times in parallel, the number of pieces of information to be transmitted can be reduced by 2N−1.

(Method of Setting Preferred Parameters)

The interactive protocol according to the present embodiment has guaranteed safety against passive attacks. However, if the above method of repeatedly executing the dialog protocol in parallel is applied, conditions shown below are necessary to be able to prove that safety against active attacks are reliably secured.

The above interactive protocol is an algorithm to cause the verifier to verify that “the prover knows s satisfying y=F(s) regarding y” by using a pair of keys (a public key y, a secret key s). Thus, if a dialog received during verification is performed, there is no denying the possibility that information of “the prover used s during dialog” is known to the verifier. Moreover, difficulty of collision of multivariable polynomials F is not guaranteed. Thus, if the above interactive protocol is repeatedly executed in parallel, it is difficult to unconditionally prove that safety against active attacks is reliably secured.

Thus, the inventor of the present technology considered a method of preventing the verifier from knowing the information of “the prover used s during dialog” even if a dialog received during verification is performed. Then, the inventor of the present technology invented a method of making possible to secure safety against active attacks even if the above interactive protocol is repeatedly executed in parallel. The method is to set the number m of multivariable polynomials f₁, . . . , fₘ used as the public key sufficiently smaller than the number n of variables thereof. For example, m and n are set so that 2^{m-n}<<1 is satisfied (if, for example, n=160 and m=80, 2⁻⁸⁰<<1).

In a scheme whose safety is grounded on difficulty of solving a problem of a multi-order multivariable simultaneous equation, if a secret key s₁ and a public key pk corresponding thereto are given, it is difficult to generate another secret key s₂ corresponding to the public key pk. Thus, if it is guaranteed that two or more secret keys s corresponding to the public key pk exist, it becomes possible to prevent the verifier from knowing the information of “the prover used s during dialog” even if a dialog received during verification is performed. That is, if the guarantee can be provided, safety against active attacks can be secured even if the interactive protocol is repeatedly executed in parallel.

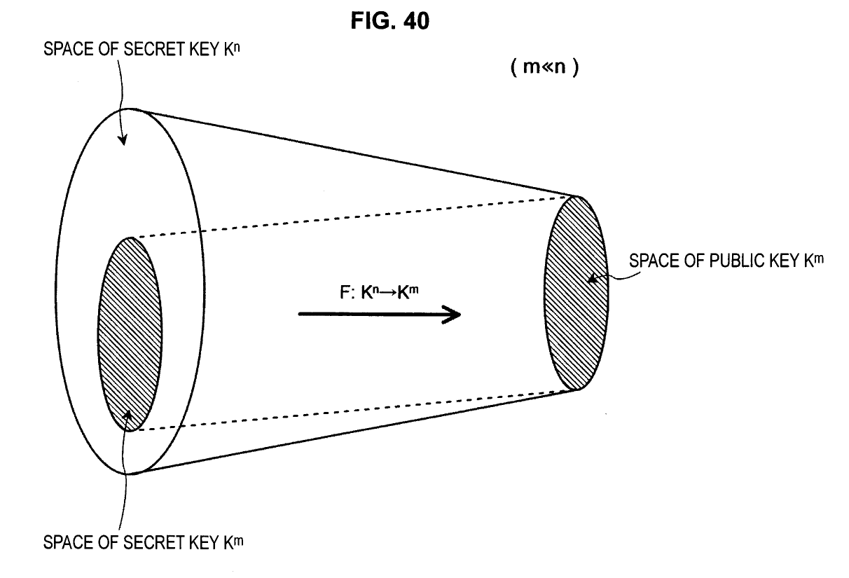

Considering a function F: Kⁿ→K^{m} constituted of m n-variable multi-order polynomials (n>m) with reference to FIG. 40, the number of elements of the domain having no second inverse image is maximally |K|^{m}−1. Thus, if |K|^{m-n} is made sufficiently small, the probability with which an element of the domain having no second inverse image is selected can be made negligibly small. That is, if the number m of n-variable multi-order polynomials f₁, . . . , fₘ is set to a value sufficiently smaller than the number n of variables thereof, the existence of two or more secret keys s corresponding to the public key pk can be guaranteed. As a result, it becomes possible to prevent the verifier from knowing the information of “the prover used s during dialog” even if a dialog received during verification is performed and safety against active attacks can be secured even when the interactive protocol is repeatedly executed in parallel.

By imposing, as described above, the setting condition of setting the number m of n-variable multi-order polynomials f₁, . . . , fₘ to a value sufficiently smaller than the number n of variables thereof (n>m, preferably 2^{m-n}<<1), it becomes possible to secure safety when the interactive protocol is repeatedly executed in parallel.

[2-4: Concrete Example (when a Second-Order Polynomial is Used)]

Next, a case when an n-variable second-order polynomial is used as a multivariable polynomial F will be described with reference to FIG. 7. FIG. 7 is an explanatory view illustrating a concrete example of the present scheme.

(Key Generation Algorithm Gen)

The key generation algorithm Gen generates m second-order polynomials fₘ(x₁, . . . , xₙ) . . . , fₘ(x₁, . . . , xₙ) defined on a ring K and a vector s=(s₁, . . . , sₙ)εKⁿ. Next, the key generation algorithm Gen calculates y=(y₁, . . . , yₘ)←(f₁(s), . . . , fₘ(s)). Then, the key generation algorithm Gen sets (f₁, . . . , fₘ, y) as the public key pk and s as the secret key. The vector (x₁, . . . , xₙ) will be denoted as x and a set of second-order polynomials (f₁(x), . . . , fₘ(x)) will be denoted as F(x) below. It is assumed that the second-order polynomial fᵢ(x) is expressed as the following formula (8):

$${f}_{i} ( {x}_{1} , … , {x}_{n} ) = {\sum }_{j , k}^{ } {a}_{i , j , k} {x}_{j} {x}_{k} + {\sum }_{j}^{ } {b}_{i , j} {x}_{j} \qquad ( 8 )$$

(Prover Algorithm P, Verifier Algorithm V)

Next, processing performed by the prover algorithm P and the verifier algorithm V during interactive protocol will be described with reference to FIG. 7.

Process #1:

First, the prover algorithm P selects any number w. Next, the prover algorithm P generates a vector rεKⁿ and a number w^{A} by applying the number w to the pseudo random number generator G₁. That is, the prover algorithm P calculates (r, w^{A})←G₁(w). Next, the prover algorithm P generates a set of first-order polynomials f₁^{A}(x), . . . , fₘ^{A}(x) by applying the number w^{A} to the pseudo random number generator G₂. That is, the prover algorithm P calculates (f₁^{A}, . . . , fₘ^{A})←G₂(w^{A}). The first-order polynomial fᵢ^{A}(x) is expressed as the following formula (9):A set of first-order polynomials (f₁^{A}(x), . . . , fₘ^{A}(x)) will be denoted as F^{A}(x).

$${f}_{i}^{A} ( {x}_{1} , … , {x}_{n} ) = {\sum }_{j}^{ } {b}_{i , j}^{A} {x}_{j} \qquad ( 9 )$$

Process #1(Continued):

Next, the prover algorithm P calculates z←s−r. This calculation corresponds to an operation to mask the secret key s with the vector r. Further, the prover algorithm P calculates F^{B}(x)←F(x+r)+F^{A}(x). This calculation corresponds to an operation to mask the second-order polynomial F(x+r) regarding x with the first-order polynomial F^{A}(x). Information about r appears only in a first-order term of x in F(x+r). Thus, information about r is all masked by F^{A}(x).

Process #1(Continued):

Next, the prover algorithm P generates a hash value c₁ of F^{A}(z) and z. That is, the prover algorithm P calculates c₁←H₁(F^{A}(z), z). The prover algorithm P also generates a hash value c₂ of the number w^{A}. That is, the prover algorithm P calculates c₂←H₂(w^{A}). Further, the prover algorithm P generates a hash value c₃ of the multivariable polynomial F^{B}. That is, the prover algorithm P calculates c₃←H₃(F^{B}). H₁( . . . ), H₂( . . . ), and H₃( . . . ) shown above are hash functions. The message (c₁, c₂, c₃) generated in process #1 is transmitted to the verifier algorithm V.

Process #2:

The verifier algorithm V that receives the message (c₁, c₂, c₃) makes a selection of which verification pattern of the three verification patterns to use. For example, the verifier algorithm V selects one number from three numbers {0, 1, 2} representing the verification patterns and sets the selected number to a request d. The request d is transmitted to the prover algorithm P.

Process #3:

The prover algorithm P that receives the request d generates a response σ to be transmitted to the verifier algorithm V in accordance with the received request d. If d=0, the prover algorithm P generates the response σ=w. If d=1, the prover algorithm P generates the response σ=(w^{A}, z). If d=2, the prover algorithm P generates the response σ=(F^{B}(z), z). The response σ generated in process #3 is transmitted to the verifier algorithm V.

Process #4:

The verifier algorithm V that receives the response 6 performs the following verification processing by using the received response σ.

If d=0, the verifier algorithm V calculates (r^{A}, w^{B})←G₁(σ). Further, the verifier algorithm V calculates F^{C}←G₂(w^{B}). Then, the verifier algorithm V verifies whether c₂=H₂(w^{B}) holds. The verifier algorithm V also verifies whether c₃=H₃(F(x+r^{A})+F^{C}(x)) holds. The verifier algorithm V outputs the value 1 indicating successful authentication if the verifications are all successful and outputs the value 0 indicating an authentication failure if a failure occurs in one of verifications.

If d=1, the verifier algorithm V sets (w^{B}, z^{A})←σ. Further, the verifier algorithm V calculates F^{C}←G₂(w^{B}). Then, the verifier algorithm V verifies whether c₁=H₁(F^{C}(z^{A}), z^{A}) holds. The verifier algorithm V also verifies whether c₂=H₂(w^{B}) holds. The verifier algorithm V outputs the value 1 indicating successful authentication if the verifications are all successful and outputs the value 0 indicating an authentication failure if a failure occurs in one of verifications.

If d=2, the verifier algorithm V sets (F^{D}, z^{A})←σ. Then, the verifier algorithm V verifies whether c₁=H₁(P^{D}(z^{A})−y,z^{A})) holds. Further, the verifier algorithm V verifies whether c₃=H₃(F^{D}) holds. The verifier algorithm V outputs the value 1 indicating successful authentication if the verifications are all successful and outputs the value 0 indicating an authentication failure if a failure occurs in one of verifications.

In the foregoing, a concrete example of the present scheme has been described.

[2-5: Efficient Algorithm]

Next, the method of making an algorithm according to the present scheme efficient will be described. A set of second-order polynomials (f₁(x), . . . , fₘ(x)) can be expressed as the following formula (10), where x=(x₁, . . . , xₙ). A₁, . . . , Aₘ are n×n matrices. Further, each of b₁, . . . , bₘ is an n×1 vector.

$$F ( x ) = ( \begin{matrix}{f}_{1} ( x ) \\ ⋮ \\ {f}_{m} ( x )\end{matrix} ) = ( \begin{matrix}{x}^{T} {A}_{1} x + {b}_{1}^{T} x \\ ⋮ \\ {x}^{T} {A}_{m} x + {b}_{m}^{T} x\end{matrix} ) \qquad ( 10 )$$

Using the above expressions, the multivariable polynomial F can be expressed like the formula (11) and the formula (12). The validity of the expression can easily be checked from the following formula (13).

$$\begin{matrix}F ( x + y ) = F ( x ) + F ( y ) + {F}_{b} ( x , y ) & ( 11 ) \\ {F}_{b} ( x , y ) = ( \begin{matrix}{y}^{T} ( {A}_{1}^{T} + {A}_{1} ) x \\ ⋮ \\ {y}^{T} ( {A}_{m}^{T} + {A}_{m} ) x\end{matrix} ) & ( 12 ) \\ \begin{matrix}{f}_{l} ( x + y ) = {( x + y )}^{T} {A}_{l} ( x + y ) + {b}_{l}^{T} ( x + y ) \\ = {x}^{T} {A}_{l} x + {x}^{T} {A}_{l} y + {y}^{T} {A}_{l} x + {y}^{T} {A}_{l} y + {b}_{l}^{T} x + {b}_{l}^{T} y \\ = {f}_{l} ( x ) + {f}_{l} ( y ) + {x}^{T} {A}_{l} y + {y}^{T} {A}_{l} x \\ = {f}_{l} ( x ) + {f}_{1} ( y ) + {{x}^{T} ( {A}_{l}^{T} )}^{T} {( {A}_{1}^{T} )}^{T} y + {y}^{T} {A}_{1} x \\ = {f}_{1} ( x ) + {f}_{l} ( y ) + {( {A}_{l}^{T} x )}^{T} y + {y}^{T} {A}_{l} x \\ = {f}_{l} ( x ) + {f}_{l} ( y ) + {y}^{T} ( {A}_{l}^{T} x ) + {y}^{T} {A}_{l} x \\ = {f}_{l} ( x ) + {f}_{l} ( y ) + {y}^{T} ( {A}_{l}^{T} + {A}_{l} ) x\end{matrix} & ( 13 )\end{matrix}$$

If F(x+y) is divided into a first portion dependent on x, a second portion dependent on y, and a third portion dependent on both x and y, a term F_{b}(x,y) corresponding to the third portion becomes bilinear regarding x and y. If this property is used, an efficient algorithm can be constructed.

For example, a multivariable polynomial F^{A}(x) used for masking of a multivariable polynomial F(x+r) is expressed as F^{A}(x)=F_{b}(x,t)+e by using vectors tεKⁿ, eεK^{m}. In this case, the sum of the multivariable polynomials F(x+r) and F^{A}(x) is expressed like the following formula (14).

If set like t^{A}=r+t and e^{A}=F(r)+e, the multivariable polynomial F^{B}(x)=F(x+r)+F^{A}(x) can be expressed by vectors t^{A}εKⁿ, e^{A}εK^{m}. Thus, if set like F^{A}(x)=F_{b}(x,t)+e, F^{A} and F^{B} can be expressed by using a vector on Kⁿ and a vector on K^{m} so that the size of data necessary for communication can significantly be reduced. More specifically, communication efficiency is improved by a few thousand to a few tens of thousand times.

$$\begin{matrix}F ( x + r ) + {F}^{A} ( x ) = F ( x ) + F ( r ) + {F}_{b} ( x , r ) + {F}_{b} ( x , t ) + e \\ = F ( x ) + {F}_{b} ( x , r + t ) + F ( r ) + e\end{matrix} \qquad ( 14 )$$

Incidentally, no information about r is leaked from F^{B} (or F^{A}) at all by the above modification. For example, even if e^{A} and t^{A} (or e and t) are given, it is difficult to know information about r as long as e and t (or e^{A} and t^{A}) are not known. Therefore, if the above modification is applied to the present scheme, zero knowledge is guaranteed. Efficient algorithms according to the present scheme will be described below with reference to FIGS. 8 to 10. The configuration of the key generation algorithm Gen is unchanged and thus, a detailed description thereof is omitted.

(Configuration Example 1 of the Efficient Algorithm: FIG. 8)

First, the configuration of the efficient algorithm shown in FIG. 8 will be described.

Process #1:

The prover algorithm P selects any number w. Next, the prover algorithm P generates a vector rεKⁿ and a number w^{A} by applying the number w to the pseudo random number generator G₁. That is, the prover algorithm P calculates (r,w^{A})←G₁(w). Next, the prover algorithm P generates two vectors tεKⁿ and eεK^{m} by applying the number w^{A} to the pseudo random number generator G₂. That is, the prover algorithm P calculates (t,e)←G₂(w^{A}). Next, the prover algorithm P calculates z←s−r. This calculation corresponds to an operation to mask the secret key s with the vector r. Further, the prover algorithm P calculates t^{A}←r+t. Next, the prover algorithm P calculates e^{A}←F(r)+e.

Process #1(Continued):

Next, the prover algorithm P calculates F_{b}(z,t) based on the above formula (14) to generate a hash value c₁ of F_{b}(z,t)+e and z. That is, the prover algorithm P calculates c₁←H₁(F_{b}(z,t)+e,z). The prover algorithm P also generates a hash value c₂ of the number w^{A}. That is, the prover algorithm P calculates c₂←H₂(w^{A}). Further, the prover algorithm P generates a hash value c₃ of the two vectors t^{A} and e^{A}. That is, the prover algorithm P calculates c₃←H₃(t^{A}, e^{A}). H₁( . . . ), H₂( . . . ), and H₃( . . . ) shown above are hash functions. The message (c₁, c₂, c₃) generated in process #1 is transmitted to the verifier algorithm V.

Process #2:

The verifier algorithm V that receives the message (c₁, c₂, c₃) makes a selection of which verification pattern of the three verification patterns to use. For example, the verifier algorithm V selects one number from three numbers {0, 1, 2} representing the verification patterns and sets the selected number to a request d. The request d is transmitted to the prover algorithm P.

Process #3:

The prover algorithm P that receives the request d generates a response σ to be transmitted to the verifier algorithm V in accordance with the received request d. If d=0, the prover algorithm P generates the response σ=w. If d=1, the prover algorithm P generates the response σ=(w^{A}, z). If d=2, the prover algorithm P generates the response σ=(t^{A}, e^{A},z). The response σ generated in process #3 is transmitted to the verifier algorithm V.

Process #4:

The verifier algorithm V that receives the response σ performs the following verification processing by using the received response σ.

If d=0, the verifier algorithm V calculates (r^{A}, w^{B})*—G₁(σ). Further, the verifier algorithm V calculates (t^{B}, e^{B})←G₂(w^{B}). Then, the verifier algorithm V verifies whether c₂=H₂(w^{B}) holds. The verifier algorithm V also verifies whether c₃=H₃(r^{A}+t^{B}, F(r^{A})+e^{B}) holds. The verifier algorithm V outputs the value 1 indicating successful authentication if the verifications are all successful and outputs the value 0 indicating an authentication failure if a failure occurs in one of verifications.

If d=1, the verifier algorithm V sets (w^{B}, z^{A})←σ. Further, the verifier algorithm V calculates (t^{B}, e^{B})←G₂(w^{B}). Then, the verifier algorithm V verifies whether c₁=H₁(F_{b}(z^{A}, t^{B})+e^{B}, z^{A}) holds. The verifier algorithm V also verifies whether c₂=H₂(w^{B}) holds. The verifier algorithm V outputs the value 1 indicating successful authentication if the verifications are all successful and outputs the value 0 indicating an authentication failure if a failure occurs in one of verifications.

If d=2, the verifier algorithm V sets (t^{C}, e^{C}, z^{A})←σ. Then, the verifier algorithm V verifies whether c₁=H₁(F(z^{A})+F_{b}(z^{A}, t^{C})+e^{C}−y, z^{A}) holds. Further, the verifier algorithm V verifies whether c₃=H₃(t^{C}, e^{C}) holds. The verifier algorithm V outputs the value 1 indicating successful authentication if the verifications are all successful and outputs the value 0 indicating an authentication failure if a failure occurs in one of verifications.

In the foregoing, Configuration example 1 of the efficient algorithm has been described. By using the efficient algorithm, the size of data necessary for communication can significantly be reduced. Moreover, because the calculation of F(x+r) is no longer necessary, calculation efficiency is also improved.

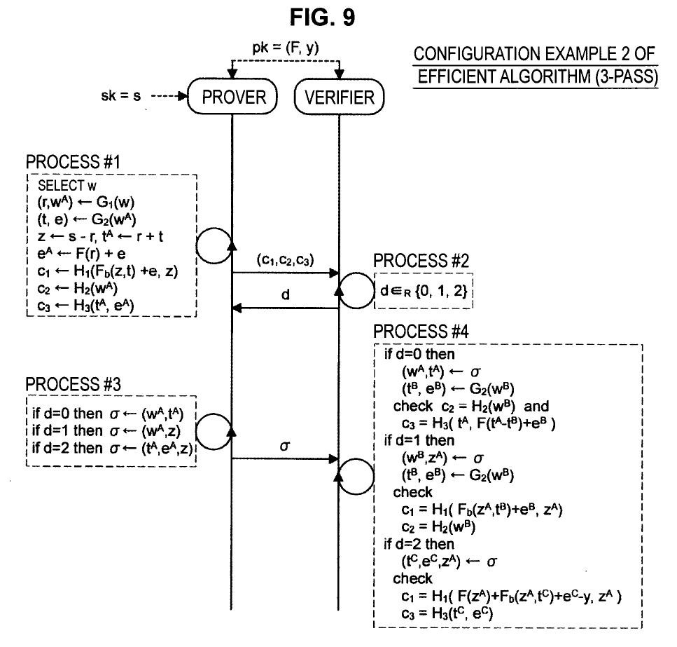

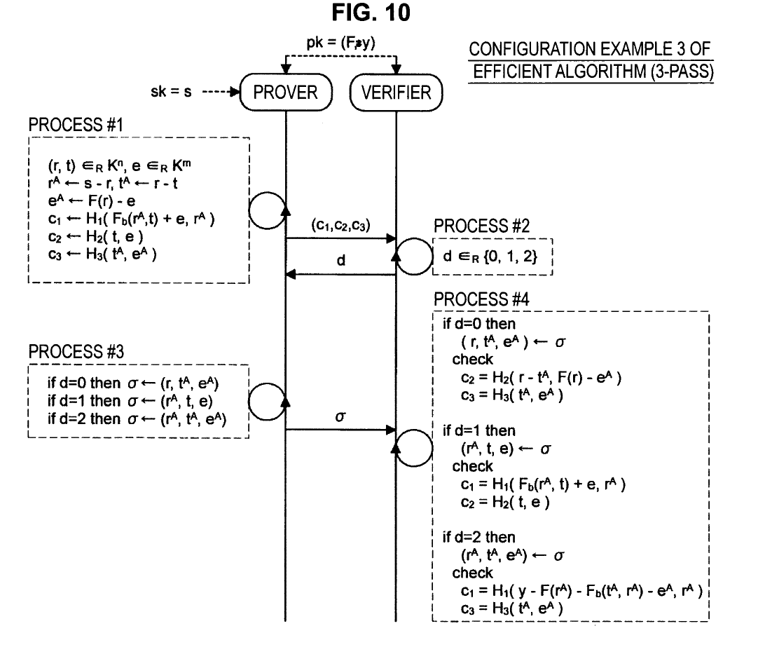

(Configuration Example 2 of the Efficient Algorithm: FIG. 9)

Next, the configuration of the efficient algorithm shown in FIG. 9 will be described. When the configuration shown in FIG. 9 is applied, like when the configuration shown in FIG. 8 is applied, an improvement effect of communication efficiency and calculation efficiency is obtained. However, only a difference from the configuration shown in FIG. 8 will be described here.

In process #3 of the algorithm shown in FIG. 8, w is set to a when d=0, but a to be set when d=0 may be any information that allows (r, t, e) to be restored. For example, as shown in FIG. 9, content of a to be set when d=0 in process #3 may be (w^{A}, t^{A}). However, if this modification is made, it is necessary to modify a portion of content of the verification performed by the verifier algorithm V in process #4. More specifically, the verification of c₃=H₃(r^{A}+t^{B}, F(r^{A})+e^{B}) of content of the verification performed by the verifier algorithm V when d=0 in process #4 is replaced by the verification of c₃=H₃(t^{A}, F(t^{A}−t^{B})+e^{B}).

In the foregoing, Configuration example 2 of the efficient algorithm has been described.

(Configuration Example 3 of the Efficient Algorithm: FIG. 10)

Next, the configuration of the efficient algorithm shown in FIG. 10 will be described.

Process #1:

The prover algorithm P generates any vectors r,tεKⁿ and eεK^{m}. Next, the prover algorithm P calculates r^{A}←s−r. This calculation corresponds to an operation to mask the secret key s with the vector r. Further, the prover algorithm P calculates t^{A}←r−t. Next, the prover algorithm P calculates e^{A}←F(r)−e.

Process #1(Continued):

Next, the prover algorithm P calculates c₁←H₁(F_{b}(r^{A},t)+e, r^{A}). Next, the prover algorithm P calculates c₂←H₂(t,e). Next, the prover algorithm P calculates c₃←H₃(t^{A}, e^{A}). H₂( . . . ), and H₃( . . . ) shown above are hash functions. The message (c₁, c₂, c₃) generated in process #1 is transmitted to the verifier algorithm V.

Process #2:

The verifier algorithm V that receives the message (c₁, c₂, c₃) makes a selection of which verification pattern of the three verification patterns to use. For example, the verifier algorithm V selects one number from three numbers {0, 1, 2} representing the verification patterns and sets the selected number to a request d. The request d is transmitted to the prover algorithm P.

Process #3:

The prover algorithm P that receives the request d generates a response σ to be transmitted to the verifier algorithm V in accordance with the received request d. If d=0, the prover algorithm P generates the response σ=(r, t^{A}, e^{A}). If d=1, the prover algorithm P generates the response σ=(r^{A}, t, e). If d=2, the prover algorithm P generates the response σ=(r^{A}, t^{A}, e^{A}).) The response σ generated in process #3 is transmitted to the verifier algorithm V.

Process #4:

The verifier algorithm V that receives the response σ performs the following verification processing by using the received response σ.

If d=0, the verifier algorithm V verifies whether c₂=H₂(r−t^{A}, F(r)−e^{A}) holds. Further, the verifier algorithm V verifies whether c₃=H₃(t^{A}, e^{A}) holds. The verifier algorithm V outputs the value 1 indicating successful authentication if the verifications are all successful and outputs the value 0 indicating an authentication failure if a failure occurs in one of verifications.

If d=1, the verifier algorithm V verifies whether c₁=H₁(F_{b}(r^{A},t)+e, r^{A}) holds. Further, the verifier algorithm V verifies whether c₂=H₂(t,e) holds. The verifier algorithm V outputs the value 1 indicating successful authentication if the verifications are all successful and outputs the value 0 indicating an authentication failure if a failure occurs in one of verifications.

If d=2, the verifier algorithm V verifies whether c₁=H₁(y−F(r^{A})−F_{b}(t^{A}, r^{A})−e^{A}, r^{A}) holds. Further, the verifier algorithm V verifies whether c₃=H₃(t^{A}, e^{A}) holds. The verifier algorithm V outputs the value 1 indicating successful authentication if the verifications are all successful and outputs the value 0 indicating an authentication failure if a failure occurs in one of verifications.

In the foregoing, Configuration example 3 of the efficient algorithm has been described. By using the efficient algorithm, the size of data necessary for communication can significantly be reduced. Moreover, because the calculation of F(x+r) is no longer necessary, calculation efficiency is also improved.

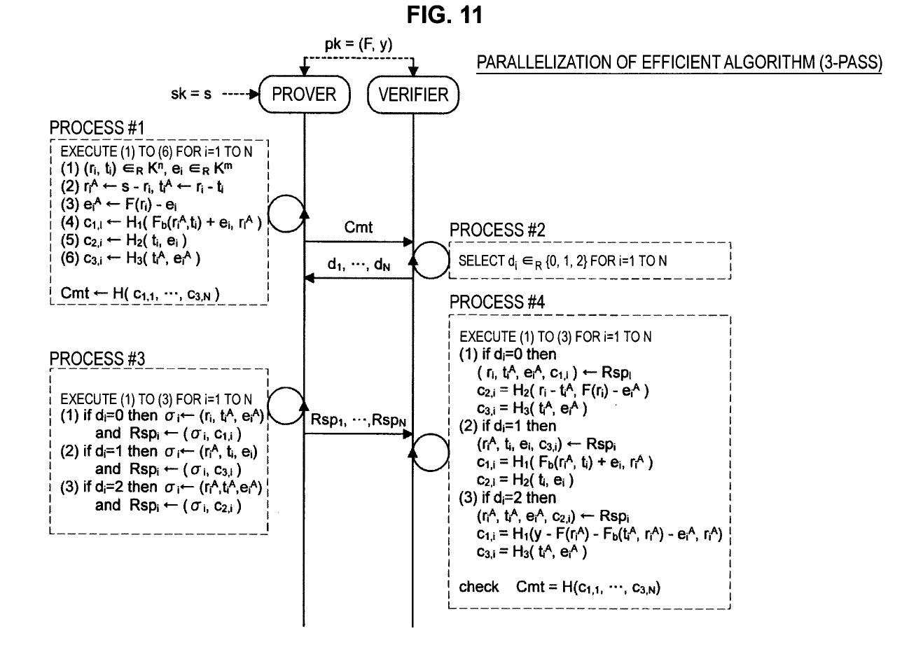

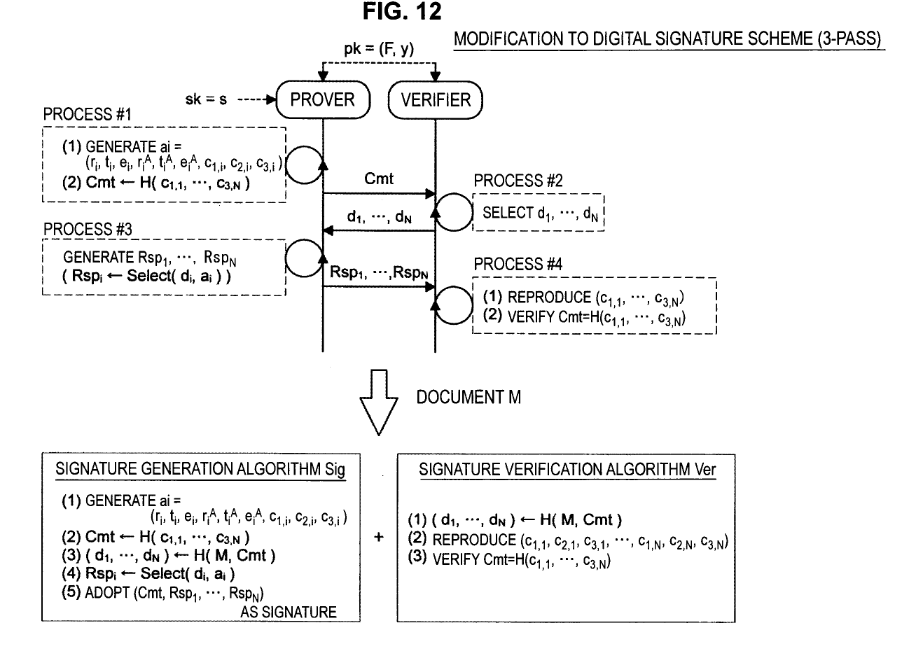

(Parallelization of the Efficient Algorithm: FIG. 11)

Next, the method of parallelizing the efficient algorithm will be described with reference to FIG. 11. The configuration shown in FIG. 11 (hereinafter, called the parallel algorithm) is obtained by parallelizing the above efficient algorithm of Configuration example 3.

Process #1:

The prover algorithm P performs processing (1) to processing (6) for i=1 to N.

Processing (1): The prover algorithm P generates any vectors rᵢ, tᵢεKⁿ and eᵢεK^{m}.

Processing (2): The prover algorithm P calculates rᵢ^{A}←s−rᵢ. This calculation corresponds to an operation to mask the secret key s with the vector rᵢ. Further, the prover algorithm P calculates tᵢ^{A}←rᵢ−tᵢ.

Processing (3): The prover algorithm P calculates eᵢ^{A}←F(rᵢ)−eᵢ.

Processing (4): The prover algorithm P calculates c_{1,i}←H₁(F_{b}(rᵢ^{A}, tᵢ)+eᵢ, rᵢ^{A}).

Processing (5): The prover algorithm P calculates c_{2,i}←H₂(tᵢ, eᵢ).

Processing (6): The prover algorithm P calculates c_{3,i}←H₃(tᵢ^{A}, eᵢ^{A}).

Process #1(Continued)

After the above processing (1) to processing (6) being performed for i=1 to N, the prover algorithm P calculates Cmt←H(c_{1,1}, c_{2,1}, c_{3,1}, . . . , c_{1,N}, c_{2,N}, C_{3,N}). H( . . . ), H₁( . . . ), H₂( . . . ), and H₃( . . . ) shown above are hash functions. The hash value Cmt generated in process #1 is transmitted to the verifier algorithm V. Thus, by transmitting the message (c_{1,1}, c_{2,1}, c_{3,1}, . . . , c_{1,N}, c_{2,N}, c_{3,N}) to the verifier algorithm V after the message being converted into a hash value, the amount of communication can be reduced.

Process #2:

The verifier algorithm V that receives the hash value Cmt makes a selection of which verification pattern of the three verification patterns to use for each of i=1 to N. For example, the verifier algorithm V selects one number from three numbers {0, 1, 2} representing the verification patterns and sets the selected number to a request dᵢ for each of i=1 to N. These requests d₁, . . . , d_{N} are transmitted to the prover algorithm P.

Process #3:

The prover algorithm P that receives the requests d₁, . . . , d_{N} generates responses Rsp₁, . . . , Rsp_{N} to be transmitted to the verifier algorithm V in accordance with the respective received requests d₁, . . . , d_{N}. If dᵢ=0, the prover algorithm P generates σᵢ=(rᵢ, tᵢ^{A}, eᵢ^{A}). Further, the prover algorithm P generates Rspᵢ=(σᵢ, c_{1,i}). If dᵢ=1, the prover algorithm P generates σᵢ=(rᵢ^{A}, tᵢ, eᵢ). Further, the prover algorithm P generates Rspᵢ=(σᵢ, c_{3,i}). If dᵢ=2, the prover algorithm P generates σᵢ=(rᵢ^{A}, tᵢ^{A}, eᵢ^{A}). Further, the prover algorithm P generates Rspᵢ=(σ₁, e_{2,i}).

The responses Rsp₁, . . . , Rsp_{N} generated in process #3 are transmitted to the verifier algorithm V.

Process #4:

The verifier algorithm V that receives the responses Rsp₁, . . . , Rsp_{N} performs processing (1) to processing (3) shown below for i=1 to N by using the received responses Rsp₁, . . . , Rsp_{N}. The verifier algorithm V performs the processing (1) when dᵢ=0, the processing (2) when dᵢ=1, and the processing (3) when dᵢ=2.

Processing (1): If dᵢ=0, the verifier algorithm V extracts (rᵢ, tᵢ^{A}, eᵢ^{A}, c_{1,i}) from Rspᵢ. Next, the verifier algorithm V calculates c_{2,i}=H₂(rᵢ−tᵢ^{A}, F(rᵢ)−eᵢ^{A}). Further, the verifier algorithm V calculates c_{3,i}=H₃(tᵢ^{A}, eᵢ^{A}). Then, the verifier algorithm V holds (c_{1,i}, c_{2,i}, c_{3,i}).

Processing (2): If dᵢ=1, the verifier algorithm V extracts (rᵢ^{A}, tᵢ, eᵢ, c_{3,i}) from Rspᵢ. Next, the verifier algorithm V calculates c_{1,i}=H₁(F_{b}(rᵢ^{A}, tᵢ)+eᵢ, rᵢ^{A}). Further, the verifier algorithm V calculates c_{2,i}=H₂(tᵢ, eᵢ). Then, the verifier algorithm V holds (C_{1,i}, c_{2,i}, c_{3,i}).

Processing (3): If dᵢ=2, the verifier algorithm V extracts (rᵢ^{A}, tᵢ^{A}, eᵢ^{A}, c_{2,i}) from Rspᵢ. Next, the verifier algorithm V calculates c_{1,i}=H₁(y−F(rᵢ^{A})−F_{b}(tᵢ^{A}, rᵢ^{A})−eᵢ^{A}, rᵢ^{A}). Further, the verifier algorithm V calculates c_{3,i}=H₃(tᵢ^{A}, eᵢ^{A}). Then, the verifier algorithm V holds (c_{1,i}, c_{2,i}, c_{3,i}).

After the processing (1) to processing (3) being performed for i=1 to N, the verifier algorithm V verifies whether Cmt=H(c_{1,1}, c_{2,i}, c_{3,i}, . . . , c_{1,N}, c_{2,N}, c_{3,N}) holds. The verifier algorithm V outputs the value 1 indicating successful authentication if the verification is successful and outputs the value 0 indicating an authentication failure if the verification fails.

In the foregoing, parallelization of the efficient algorithm has been described. Incidentally, the parallel algorithm shown in FIG. 11 is designed to transmit a message after being converted into a hash value. The communication efficiency is improved by this design.

[2-6: Modification to the Digital Signature Scheme]

A method of modifying a public key authentication scheme according to the present scheme into a digital signature scheme will be presented. If the prover in a model of the public key authentication scheme is made to correspond to the signer in the digital signature scheme, it is easily understood that the model of the public key authentication scheme is similar to the model of the digital signature scheme in that the prover alone can convince the verifier. Based on such an idea, the method of modifying a public key authentication scheme according to the present scheme into a digital signature scheme will be described.

(2-6-1: Modification Method>

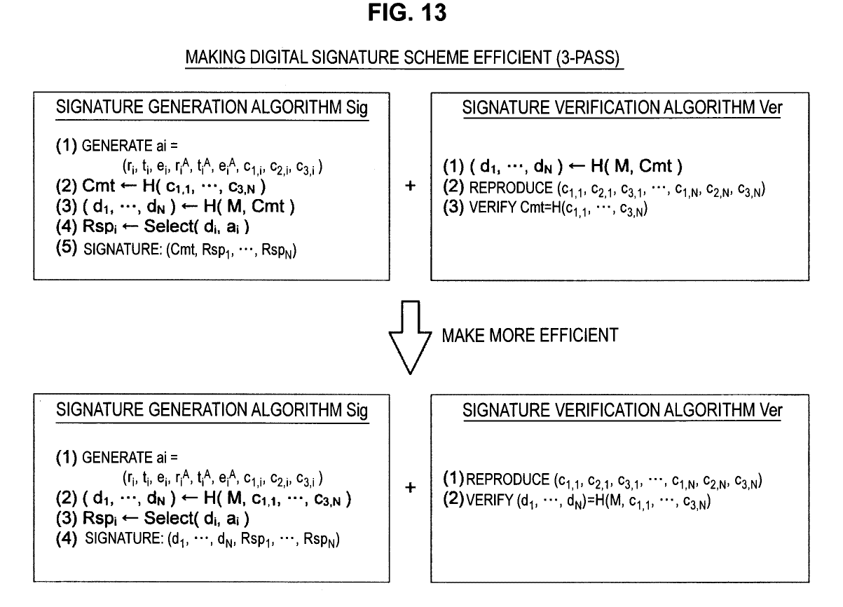

The method of modifying Configuration example 3 of the efficient algorithm described above into the algorithm of digital signature scheme is taken as an example. As shown in FIG. 12, the algorithm according to Configuration example 3 can roughly be expressed by four processes of process #1 to process #4 shown below.

Process #1 includes processing (1) to generate aᵢⱼ=(rᵢ, tᵢ, eᵢ, rᵢ^{A}, tᵢ^{A}, eᵢ^{A}, c_{1,i}, c_{2,i}, c_{3,i}) and processing (2) to calculate Cmt←H(c_{1,1}, c_{2,1}, c_{3,1}, . . . , c_{1,N}, c_{2,N}, C_{3,N}). In process #1, Cmt generated by the prover algorithm P is transmitted to the verifier algorithm V.

Process #2 includes processing to select d₁, . . . , d_{N}. d₁, . . . , d_{N} selected by the verifier algorithm V in process #2 are transmitted to the prover algorithm P.

Process #3 includes processing to generate Rsp₁, . . . , Rsp_{N} by using d₁, . . . , d_{N} and a₁, . . . , a_{N}. This processing is expressed as Rspᵢ←Select(dᵢ, aᵢ). Rspᵢ, . . . , RsP_{N} generated by the prover algorithm P in process #3 are transmitted to the verifier algorithm V.

Process #4 includes processing (1) to reproduce c_{1,1}, c_{2,1}, c_{3,1}, . . . , c_{1,N}, c_{2,N}, c_{3,N} by using d₁, . . . , d_{N} and Rsp₁, Rsp_{N} and processing (2) to verify Cmt=H(c_{1,1}, c_{2,1}, c_{3,1}, . . . , c_{1,N}, c_{2,N}, c_{3,N}) by using the reproduced c_{1,1}, c_{2,2}, c_{3,3}, . . . , c_{1,N}, c_{2,N}, c_{3,N}.

The algorithm of the public key authentication scheme expressed by the above process #1 to process #4 is modified into the signature generation algorithm Sig, and the signature verification algorithm Ver as shown in FIG. 12.

(Signature Generation Algorithm Sig)

First, the configuration of the signature generation algorithm Sig will be described. The signature generation algorithm Sig includes processing (1) to processing (5) shown below:

Processing (1): The signature generation algorithm Sig generates aᵢ=(rᵢ, tᵢ, eᵢ, rᵢ^{A},tᵢ^{A}, eᵢ^{A}, c_{1,i}, c_{2,i}, c_{3,i}).

Processing (2): The signature generation algorithm Sig calculates Cmk←H(c_{1,1}, c_{2,1}, c_{3,1}, . . . , c_{1,N}, c_{2,N}, c_{3,N}).

Processing (3): The signature generation algorithm Sig calculates (d₁, d_{N})←H(M, Cmt). M is a document to which a signature is attached.

Processing (4): The signature generation algorithm Sig calculates Rspᵢ←Select(dᵢ, aᵢ).

Processing (5): The signature generation algorithm Sig sets (Cmt, Rsp₁, . . . , Rsp_{N}) to a signature.

(Signature Verification Algorithm Ver)

Next, the configuration of the signature verification algorithm Ver will be described. The signature verification algorithm Ver includes processing (1) to processing (3) shown below:

Processing (1): The signature verification algorithm Ver calculates (d₁, . . . , d_{N})←H(M, Cmt).

Processing (2): The signature verification algorithm Ver generates c_{1,1}, c_{2,1}, c_{3,1}, . . . , c_{1,N}, c_{2,N}, c_{3,N} by using d₁, . . . , d_{N} and Rsp₁, . . . , Rsp_{N}.

Processing (3): The signature verification algorithm Ver verifies Cmt=H(c_{1,1}, c_{2,1}, c_{3,1}, . . . , c_{1,N}, c_{2,N}, c_{3,N}) by using the reproduced c_{1,1}, c_{2,1}, c_{3,1}, . . . , c_{1,N}, c_{2,N}, c_{3,N}.

By making the prover in a model of the public key authentication scheme to correspond to the signer in the digital signature scheme, as described above, the algorithm of the public key authentication scheme can be modified into the algorithm of the digital signature scheme.

[2-6-2: Making the Digital Signature Algorithm More Efficient]

Focusing on the configuration of the signature generation algorithm Sig shown in FIG. 13 reveals that a hash value is calculated in the processing (2) and the processing (3). Focusing on the configuration of the signature verification algorithm Ver reveals that the same hash value as in the processing (3) of the signature generation algorithm Sig is calculated in the processing (1). By focusing on such processing to refine the configurations of the signature generation algorithm Sig and the signature verification algorithm Ver as shown in FIG. 13, calculation efficiency can further be improved.

(Signature Generation Algorithm Sig)

First, the refined configuration of the signature generation algorithm Sig will be described. The signature generation algorithm Sig includes processing (1) to processing (4) shown below:

Processing (1): The signature generation algorithm Sig generates aᵢ=(rᵢ, tᵢ, eᵢ, rᵢ^{A}, tᵢ^{A}, eᵢ^{A}, c_{1,i}, c_{2,i}, c_{3,i}).

Processing (2): The signature generation algorithm Sig calculates (d₁, . . . , d_{N})←H(M, c_{1,1}, c_{2,2}, c_{3,3}, . . . , c_{1,N}, c_{2,N}, c_{3,N}). M is a document to which a signature is attached.

Processing (3): The signature generation algorithm Sig calculates Rspᵢ←Select(dᵢ, aᵢ).

Processing (4): The signature generation algorithm Sig sets (d₁, . . . , d_{N}, Rsp₁, . . . , Rsp_{N}) to a signature.

(Signature Verification Algorithm Ver)

Next, the refined configuration of the signature verification algorithm Ver will be described. The signature verification algorithm Ver includes processing (1) and processing (2) shown below:

Processing (1): The signature verification algorithm Ver generates c_{1,1}, c_{2,2}, c_{3,3}, . . . , c_{1,N}, c_{2,N}, c_{3,N} by using d₁, d_{N} and Rsp₁, . . . , Rsp_{N}.

Processing (2): The signature verification algorithm Ver verifies (d₁, . . . , d_{N})=H(M, c_{1,1}, c_{2,1}, c_{3,1}, . . . , c_{1,N}, c_{2,N}, c_{3,N}) by using the reproduced c_{1,1}, c_{2,1}, C_{3,1}, . . . , c_{1,N}, c_{2,N}, c_{3,N}.

By refining the configurations of the signature generation algorithm Sig and the signature verification algorithm Ver as described above, one calculation of a hash value is reduced in each algorithm. As a result, calculation efficiency can further be improved. [2-7: Form of a Multi-Order Multivariable Simultaneous Equation]

As has been described above, the present scheme is a scheme whose safety is grounded on difficulty of solving a problem of a multi-order multivariable simultaneous equation. The present scheme is also characterized in that a complex multi-order multivariable simultaneous equation can be used. The form of a multi-order multivariable simultaneous equation is not specifically limited in the above description, but it is desirable to use, for example, a multi-order multivariable simultaneous equation containing encryption constituent technology whose difficulty is sufficiently guaranteed in the expression thereof. Concrete examples of the multi-order multivariable simultaneous equation applicable to the present scheme will be presented.

(2-7-1: Form of the Common Key Block Cipher)

Common key block cipher technology such as AES, DES, and KATAN is a constituent technology that has been sufficiently analyzed and whose safety and reliability are high. Such a common key block cipher can be represented by a multi-order multivariable simultaneous equation having a common key block cipher key, plain text, and cipher text as variables. If values are substituted into variables representing plain text and cipher text in the multi-order multivariable simultaneous equation, the multi-order multivariable simultaneous equation becomes an equation having only a variable representing the key.

Solving a multi-order multivariable simultaneous equation representing such a common key block cipher corresponds to restoring the key of the common key block cipher from the plain text and cipher text. That is, as long as safety of the common key block cipher is maintained, difficulty of solving the multi-order multivariable simultaneous equation representing the common key block cipher can be guaranteed. Thus, if a multi-order multivariable simultaneous equation representing some common key block cipher scheme is applied to the present scheme, a public key authentication scheme having safety equivalent to safety of the common key block cipher scheme is realized.

However, if a common key block cipher is represented by a multi-order multivariable simultaneous equation having the key, plain text, and cipher text as variables, the order of polynomials increases, leading to an increased size of data to represent the simultaneous equation. Thus, in addition to the key, plain text, and cipher text, a variable to represent an internal state of each round is introduced. If the variable is introduced, the order of the multi-order multivariable simultaneous equation representing the common key block cipher can be decreased. For example, suitable values are substituted into the variables representing plain text and cipher text to introduce a simultaneous equation of variables representing the key and internal state. By adopting such a method, though the number of variables increases, the representation of the multi-order multivariable simultaneous equation becomes more compact because the order decreases.

(2-7-2: Form of the Hash Function)

Similarly, a multi-order multivariable simultaneous equation regarding a hash function such as SHA-1 and SHA-256 can also be applied to the present scheme. Such a hash function can be represented by a multi-order multivariable simultaneous equation having a message as input of the hash function and a hash value as output thereof as variables. If a suitable value is substituted into the variable representing the hash value in the multi-order multivariable simultaneous equation, a multi-order multivariable simultaneous equation of a variable representing the corresponding input can be obtained.

Solving such a multi-order multivariable simultaneous equation corresponds to restoring the value of an original message from the hash value. That is, as long as safety (unidirectionality) of the hash function is maintained, difficulty of solving the multi-order multivariable simultaneous equation representing the hash function can be guaranteed. Thus, if a multi-order multivariable simultaneous equation representing some hash function is applied to the present scheme, a public key authentication scheme based on safety of the hash function is realized.

However, if a hash function is represented by a multi-order multivariable simultaneous equation having the input message and hash value as variables, the order of polynomials increases, leading to an increased size of data to represent the simultaneous equation. Thus, in addition to the input message and hash value, a variable to represent the internal stated is introduced. If the variable is introduced, the order of the multi-order multivariable simultaneous equation representing the hash function can be decreased. For example, a suitable value is substituted into the variable representing hash value to introduce a simultaneous equation of variables representing the input message and internal state. By adopting such a method, though the number of variables increases, the representation of the multi-order multivariable simultaneous equation becomes more compact because the order decreases.

(2-7-3: Form of the Stream Cipher)

Similarly, a multi-order multivariable simultaneous equation regarding a stream cipher such as Trivium can also be applied to the present scheme. Such a stream cipher can be represented by a multi-order multivariable simultaneous equation regarding a variable representing the initial internal state of the stream cipher and a variable representing an output stream. In this case, if a suitable value is substituted into the variable representing the output stream, a multi-order multivariable simultaneous equation of the variable representing the corresponding initial internal state can be obtained.

Solving such a multi-order multivariable simultaneous equation corresponds to restoring the variable representing the original initial internal state. That is, as long as safety of the stream cipher is secured, difficulty of solving the multi-order multivariable simultaneous equation representing the stream cipher can be guaranteed. Thus, if a multi-order multivariable simultaneous equation representing some stream cipher is applied to the present scheme, a public key authentication scheme based on safety of the stream cipher is realized.

However, if a stream cipher is represented by a multi-order multivariable simultaneous equation having the initial internal state and output stream as variables, the order of polynomials increases, leading to an increased size of data to represent the simultaneous equation. Thus, in addition to the initial internal state and output stream, a variable to represent the internal state of each round is introduced. If the variable is introduced, the order of the multi-order multivariable simultaneous equation representing the stream cipher can be decreased. For example, a suitable value is substituted into the variable representing the output stream to introduce a simultaneous equation of the variable representing the initial internal state and round. By adopting such a method, though the number of variables increases, the representation of the multi-order multivariable simultaneous equation becomes more compact because the order decreases.

In the foregoing, concrete examples of the multi-order multivariable simultaneous equation applicable to the present scheme have been presented. [2-8: Serial/Parallel Hybrid Algorithm]

The necessity to execute the interactive protocol a plurality of times has been described to reduce the probability with which falsification is successful to a negligible level. As methods of executing the interactive protocol a plurality of times, the serial method and the parallel method have been presented. Particularly, the parallel method has been described by showing the concrete parallel algorithm.

Algorithms of the hybrid type combining the serial method and the parallel method will be presented.

(Hybrid Configuration 1)

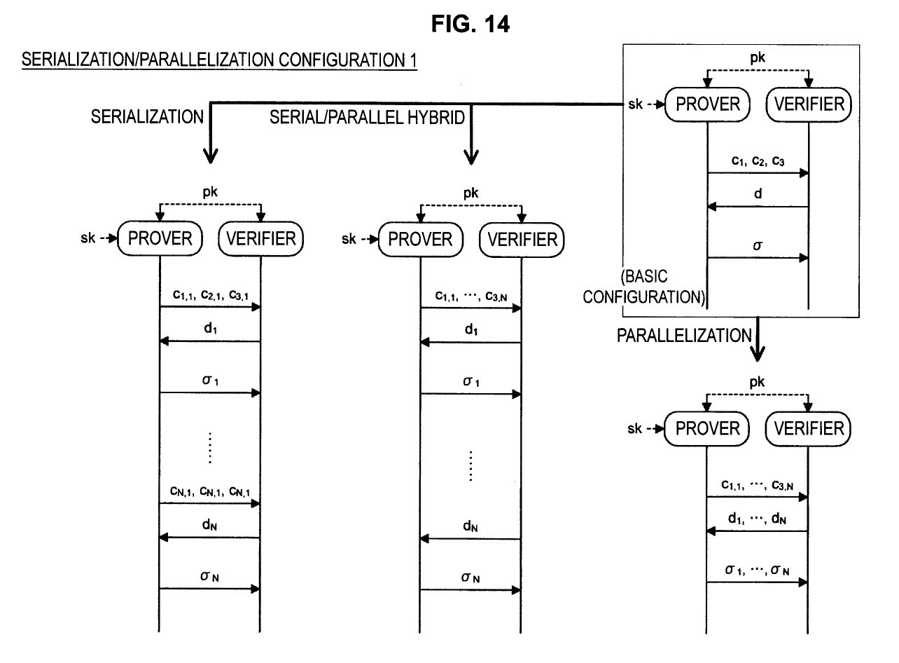

An algorithm of the hybrid type (hereinafter, called the parallel-serial algorithm) will be described with reference to FIG. 14. FIG. 14 shows a basic configuration according to the present scheme, a serial algorithm serializing the basic configuration, a parallel algorithm parallelizing the basic configuration, and a parallel-serial algorithm.

In the basic configuration, a message (c₁, c₂, c₃) is transmitted from the prover to the verifier in the first pass. In the second pass, a request d is transmitted from the verifier to the prover. In the third pass, a response σ is transmitted from the prover to the verifier.

If the above basic configuration is parallelized, messages (c_{1,1}, c_{2,1}, c_{3,1}, . . . , c_{1,N}, c_{2,N}, c_{3,N}) for N times are transmitted from the prover to the verifier in the first pass. In the second pass, requests (d₁, . . . , d_{N}) for N times are transmitted from the verifier to the prover. In the third pass, response (σ₁, . . . , σ_{N}) for N times are transmitted from the prover to the verifier. Safety against passive attacks are secured by the parallel-serial algorithm according to the present scheme. Moreover, the number of times of dialog can be reduced to 3. Further, communication efficiency can be improved by putting together N messages transmitted in the first pass into one hash value.

On the other hand, if the basic configuration is serialized, a message (c_{1,1}, c_{2,1}, c_{3,1}) for one time is transmitted from the prover to the verifier in the first pass. In the second pass, a request d₁ for one time is transmitted from the verifier to the prover. In the third pass, a response σ₁ for one time is transmitted from the prover to the verifier. In the fourth pass, a message (c_{1,2}, c_{2,2}, c_{3,2}) for one time is transmitted from the prover to the verifier. In the fifth pass, a request d₂ for one time is transmitted from the verifier to the prover. In the sixth pass, a response σ₂ for one time is transmitted from the prover to the verifier. In the same manner, the dialog is repeatedly performed until a response σ_{N} is transmitted from the prover to the verifier. Safety against active attacks is secured by the serial algorithm. It is also possible to prove that the probability of falsification is reliably reduced.

The parallel-serial algorithm is an algorithm combining properties of a parallel algorithm and properties of a serial algorithm. According to the parallel-serial algorithm shown in FIG. 14, in the first pass, messages (c_{1,1}, c_{2,1}, c_{3,1}, . . . , c_{1,N}, c_{2,N}, c_{3,N}) for N times are transmitted from the prover to the verifier. In the second pass, a request d₁ for one time is transmitted from the verifier to the prover. In the third pass, a response σ₁ for one time is transmitted from the prover to the verifier. Then, requests d₂, . . . , d_{N} and responses σ₂, . . . , σ_{N} are exchanged between the prover and the verifier.

According to the parallel-serial algorithm based on the present scheme, safety against passive attacks is secured. Moreover, the number of times of dialog can be reduced to 2N+1. Further, communication efficiency can be improved by putting together N messages transmitted in the first pass into one hash value.

(Hybrid Configuration 2)

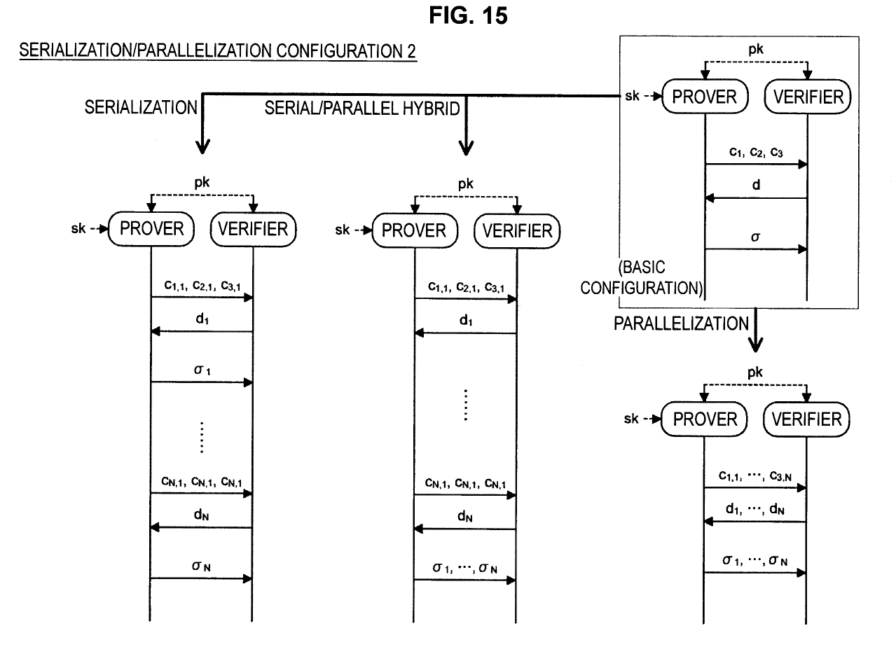

An algorithm of another hybrid type (hereinafter, called the serial-parallel algorithm) will be described with reference to FIG. 15. FIG. 15 shows the basic configuration according to the present scheme, the serial algorithm serializing the basic configuration, the parallel algorithm parallelizing the basic configuration, and a serial-parallel algorithm. The configurations and properties of the basic configuration, the serial algorithm, and the parallel algorithm are as described above.

The serial-parallel algorithm shown in FIG. 15 is an algorithm combining properties of a parallel algorithm and properties of a serial algorithm. According to the serial-parallel algorithm shown in FIG. 15, a message (c_{1,1}, c_{2,1}, c_{3,1}) for one time is transmitted from the prover to the verifier in the first pass. In the second pass, a request d₁ for one time is transmitted from the verifier to the prover. Then, messages (c_{1,2}, c_{2,2}, c_{3,2}), . . . , (c_{1,N}, c_{2,N}, c_{3,N}) and requests d₂, . . . , d_{N} are exchanged between the prover and the verifier. After a request d_{N} being transmitted from the verifier to the prover, responses σ₁, . . . , σ_{N} for N times are transmitted from the prover to the verifier.

Safety against active attacks is secured by the serial-parallel algorithm based on the present scheme. Moreover, the number of times of dialog can be reduced to 2N+1.

In the foregoing, the algorithms of the hybrid types based on the present scheme have been described.

In the foregoing, the first embodiment of the present technology has been described.

### 3: Second Embodiment

Next, the second embodiment of the present technology will be described. The 3-pass public key authentication scheme has been described. In the present embodiment, a 5-pass public key authentication scheme (hereinafter, called the present scheme) will be described. The present scheme is a scheme that secures the soundness of the public key authentication scheme by setting 2q verification patterns by the verifier.

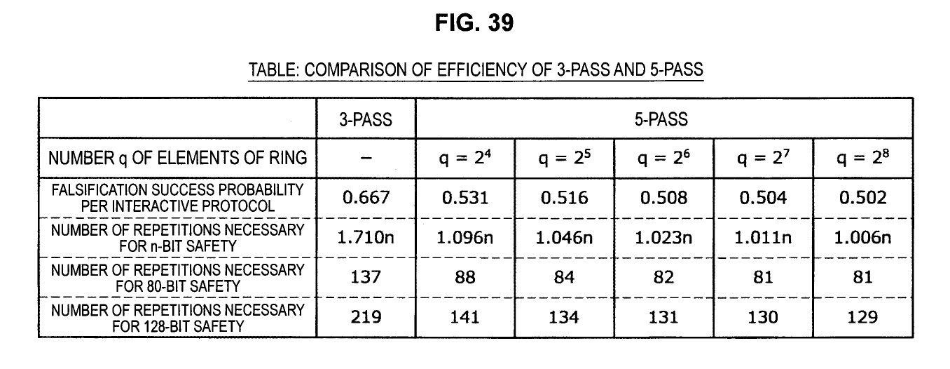

While the falsification probability per interactive protocol is ⅔ in the above 3-pass public key authentication scheme according to the first embodiment, the falsification probability per interactive protocol in the present scheme is, as will be described below, ½+1/q. q is the order of a ring to be used. Therefore, if the order of the ring is sufficiently large, as shown in FIG. 39, the present scheme can reduce the falsification probability per interactive protocol more than the first embodiment so that the falsification probability can be made sufficiently small with a less number of times of executing the interactive protocol.

The interactive protocol according to the 5-pass public key authentication scheme may seem less efficient than the interactive protocol according to the 3-pass public key authentication scheme. However, if the order of the ring is sufficiently large in the 5-pass public key authentication scheme, the falsification probability per interactive protocol is close to ½, which reduces the number of times of executing the interactive protocol necessary to achieve the same level of security.

If, for example, the falsification probability should be reduced to ½ⁿ or less, it is necessary to execute the interactive protocol n/(log 3−1)=1.701n times or more according to the 3-pass public key authentication scheme. According to the 5-pass public key authentication scheme, on the other hand, it is necessary to execute the interactive protocol n/(1−log(1+1/q)) times or more. If, for example, q=24 as shown in FIG. 39, the amount of communication necessary to achieve the same level of security becomes less for the 5-pass public key authentication scheme than the 3-pass public key authentication scheme. [3-1: Algorithm of the Public Key Authentication Scheme]

The configuration of an algorithm according to the 5-pass public key authentication scheme (present scheme) will be described with reference to FIG. 16. FIG. 16 is an explanatory view illustrating the configuration of the algorithm according to the present scheme.

(Key Generation Algorithm Gen)

The key generation algorithm Gen generates m multivariable polynomials f₁(x₁, . . . , xₙ), . . . , fₘ(x₁, . . . , xₙ) defined on a ring K and a vector s=(s₁, . . . , sₙ)εKⁿ. Next, the key generation algorithm Gen calculates y=(y₁, . . . , yₘ)←f₁(s), . . . , fₘ(s). Then, the key generation algorithm Gen sets (f₁, . . . , fₘ, y) as the public key pk and s as the secret key. The vector (x₁, . . . , xₙ) will be denoted as x and a set of multivariable polynomials (f₁(x), . . . , fₘ(x)) will be denoted as F(x) below.

(Prover Algorithm P, Verifier Algorithm V)

Next, processing performed by the prover algorithm P and by the verifier algorithm V during interactive protocol will be described with reference to FIG. 16. During the above interactive protocol, the prover proves to the verifier that “the prover knows s satisfying y=F(s)” without leaking information about the secret key s to the verifier at all. On the other hand, the verifier verifies whether the prover knows s satisfying y=F(s). It is assumed that the public key pk is made public to the verifier. It is also assumed that the secret key s is managed in secret by the prover. The description will be provided below along the flow chart shown in FIG. 16.

Process #1:

First, the prover algorithm P selects any number w. Next, the prover algorithm P generates a vector rεKⁿ and a set of n-variable polynomials F^{A}(x)=(f₁^{A}(x), . . . , fₘ^{A}(x)) by applying the number w to a pseudo random number generator G. That is, the prover algorithm P calculates (r,F^{A})←G(w). Next, the prover algorithm P calculates z←s−r. This calculation corresponds to an operation to mask the secret key s with the vector r.

Process #1(Continued):

Next, the prover algorithm P generates a hash value c₁ of F^{A}(z) and z. That is, the prover algorithm P calculates c₁←H₁(F^{A}(z), z). The prover algorithm P also generates a hash value c₂ of the number w. That is, the prover algorithm P calculates c₂←H₂(w). H₁( . . . ) and H₂( . . . ) shown above are hash functions. The message (c₁, c₂) generated in process #1 is transmitted to the verifier. Note that information about s, information about r, and information about z are not leaked to the verifier at all.

Process #2:

The verifier algorithm V randomly selects one number α from q elements existing in the ring K and transmits the selected number α to the prover algorithm P.

Process #3:

The prover algorithm P that receives the number α calculates F^{B}(x)←αF(x+r)+F^{A}(x). This calculation corresponds to an operation to mask the multivariable polynomial F(x+r) regarding x with the multivariable polynomial F^{A}(x). The multivariable polynomial F^{B} generated in process #3 is transmitted to the verifier algorithm V. Note that information about z when d=0 is not leaked to the verifier at all or information about r when d=1 is not leaked to the verifier at all.

Process #4:

The verifier algorithm V that receives the multivariable polynomial F^{B} makes a selection of which verification pattern of the two verification patterns to use. For example, the verifier algorithm V selects one number from two numbers {0, 1} representing the verification patterns and sets the selected number to a request d. The request d is transmitted to the prover algorithm P.

Process #5:

The prover algorithm P that receives the request d generates a response σ to be transmitted to the verifier algorithm V in accordance with the received request d. If d=0, the prover algorithm P generates a response σ=w. If d=1, the prover algorithm P generates a response σ=z. The response σgenerated in process #5 is transmitted to the verifier algorithm V.

Process #6:

The verifier algorithm V that receives the response σ performs the following verification processing by using the received response σ.

If d=0, the verifier algorithm V calculates (r^{A}, F^{C})←G(σ). Then, the verifier algorithm V verifies whether c₂=H₂(σ) holds. The verifier algorithm V also verifies whether F^{B}(x)=σF(x+r^{A})+F^{C}(x) holds. The verifier algorithm V outputs the value 1 indicating successful authentication if the verifications are all successful and outputs the value 0 indicating an authentication failure if a failure occurs in one of verifications.

If d=1, the verifier algorithm V calculates z^{A}←σ. Then, the verifier algorithm V verifies whether c₁=H₁(F^{C}(z^{A})−αy, z^{A}) holds. The verifier algorithm V outputs the value 1 indicating successful authentication if the verification is successful and outputs the value 0 indicating an authentication failure if a failure occurs in the verification.

In the foregoing, the configuration of each algorithm according to the present scheme has been described.

(Soundness in the Present Scheme)

The soundness of the present scheme is guaranteed from the fact that if the prover algorithm P responds correctly to the requests d=0 and 1 regarding (c₁, c₂) and two responses (α₁, α₂) selected by the verifier algorithm V, F₁^{D}, F₂^{D}, F^{C}, r^{A}, and z^{A} satisfying the following formulas (15) to (17) can be calculated from response content thereof.

F₁^{D}(x)=α₁F(x+r^{A})+F^{C}(x) (15)

F₂^{D}(x)=α₂F(x+r^{A})+F^{C}(x) (16)

F₁D(z^{A})−α₁y=F₂^{D}(z^{A})−α₂y (17)

With the above soundness guaranteed, it is guaranteed to be difficult to be successful in falsification with a probability higher than ½+1/q as long as a problem of a multi-order multivariable simultaneous equation is not solved. That is, to be able to respond correctly to all requests d=0, 1 of the verifier, it is necessary for the falsifier to be able to calculate F₁^{D}, F₂^{D}, F^{C}, r^{A}, and z^{A} satisfying the following equations (15) to (17). In other words, it is necessary for the falsifier to be able to calculate s satisfying F(s)=y. Therefore, as long as a problem of a multi-order multivariable simultaneous equation is not solved, it is difficult for the falsifier to be successful in falsification with a probability higher than ½+1/q. By executing the above interactive protocol a sufficient number of times, the probability of successful falsification can be made negligibly small.

(Modification)

The above key generation algorithm Gen calculates y←F(s) and then sets (F, y) as the public key. However, the key generation algorithm Gen may also be configured to set (y₁, . . . , yₘ)←F(s) and calculate (f₁*(x), . . . , fₘ*(x))←(f₁(x)−y₁, . . . , fₘ(x)−yₘ) to set (f₁*, . . . , fₘ*) as the public key. With the above modification, it becomes possible to execute the interactive protocol between the prover algorithm P and the verifier algorithm V by setting y=0.

Alternatively, the prover algorithm P may calculate the hash value of F^{B}(z) and the hash value of z separately to transmit each to the verifier as a message.

The verifier algorithm P described above generates the vector r and the number w^{A} by applying the number w to the random number generator G₁. Further, the verifier algorithm P described above generates the multivariable polynomial F^{A}(x) by applying the number w^{A} to the random number generator G₂. However, the prover algorithm P may be configured so that w=(r, F^{A}) is calculated from the start by setting G₁ as an identity mapping. In this case, it is not necessary to apply the number w to G₁. This also applies to G₂.

In the foregoing, a modification of the present scheme has been described.

[3-2: Extended Algorithm]

Next, the algorithm of a public key authentication scheme extending the present scheme (hereinafter, called the extending scheme) will be described with reference to FIG. 17. FIG. 17 is an explanatory view illustrating the flow of interactive protocol based on the extending scheme.

The extending scheme described here is a scheme by which a multivariable polynomial F^{B} transmitted in the third pass is converted into one hash value c₃ before being transmitted to the verifier. By extending the present scheme in this manner, the amount of communication when the multivariable polynomial F^{B} whose representation size is large is transmitted to the verifier algorithm V during interactive protocol can be reduced by half so that the average data size to be exchanged can be reduced. The configuration of each algorithm in the extending scheme will be described in detail below.

(Key Generation Algorithm Gen)

The key generation algorithm Gen generates m multivariable polynomials f₁(x₁, . . . , xₙ), . . . , fₘ(x₁, . . . , xₙ) defined on the ring K and a vector 5=(s₁, . . . , sₙ)εKⁿ. Next, the key generation algorithm Gen calculates y=(y₁, . . . , yₘ)←(f₁(s), . . . , fₘ(s)). Then, the key generation algorithm Gen sets (f₁, . . . , fₘ, y) as the public key pk and s as the secret key. The vector (x₁, . . . , xₙ) will be denoted as x and a set of multivariable polynomials (f₁(x), . . . , fₘ(x)) will be denoted as F(x) below.

(Prover Algorithm P, Verifier Algorithm V)

Next, processing performed by the prover algorithm P and by the verifier algorithm V during interactive protocol will be described with reference to FIG. 17. During the above interactive protocol, the prover proves to the verifier that “the prover knows s satisfying y=F(s)” without leaking information about the secret key s to the verifier at all. On the other hand, the verifier verifies whether the prover knows s satisfying y=F(s). It is assumed that the public key pk is made public to the verifier. It is also assumed that the secret key s is managed in secret by the prover. The description will be provided below along the flow chart shown in FIG. 17.

Process #1:

First, the prover algorithm P selects any number w. Next, the prover algorithm P generates a vector rεKⁿ and a F^{A}(x) by applying the number w to the pseudo random number generator G. That is, the prover algorithm P calculates (r,F^{A})←G(w). Next, the prover algorithm P calculates z←s−r. This calculation corresponds to an operation to mask the secret key s with the vector r.

Process #1(Continued):

Next, the prover algorithm P generates a hash value c₁ of F^{A}(z) and z. That is, the prover algorithm P calculates c₁←H₁(F^{A}(z), z). The prover algorithm P also generates a hash value c₂ of the number w. That is, the prover algorithm P calculates c₂←H₂(w). H₁( . . . ) and H₂( . . . ) shown above are hash functions. The message (c₁, c₂) generated in process #1 is transmitted to the verifier algorithm V.

Process #2:

The verifier algorithm V that receives the message (c₁, c₂) randomly selects one number α from q elements existing in the ring K and transmits the selected number α to the prover algorithm P.

Process #3:

The prover algorithm P that receives the number α calculates F^{B}(x)←αF(x+r)+F^{A}(x). This calculation corresponds to an operation to mask the multivariable polynomial F(x+r) regarding x with the multivariable polynomial F^{A}(x). Further, the prover algorithm P generates a hash value c₃ of a set of multivariable polynomials F^{B}. That is, the prover algorithm P calculates c₃←H₃(F^{B}(x)). H₃( . . . ) shown above is a hash function. The message c₃ generated in process #3 is transmitted to the verifier.

Process #4:

The verifier algorithm V that receives the message c₃ makes a selection of which verification pattern of the two verification patterns to use. For example, the verifier algorithm V selects one number from two numbers {0, 1} representing the verification patterns and sets the selected number to a request d. The request d is transmitted to the prover algorithm P.

Process #5:

The prover algorithm P that receives the request d generates a response a to be transmitted to the verifier algorithm V in accordance with the received request d. If d=0, the prover algorithm P generates a response σ=w. If d=1, the prover algorithm P generates a response σ=(z, F^{B}). The response σ generated in process #5 is transmitted to the verifier algorithm V.

Process #6:

The verifier algorithm V that receives the response σ performs the following verification processing by using the received response σ.

If d=0, the verifier algorithm V calculates (r^{A}, F^{C})←G(σ). Then, the verifier algorithm V verifies whether c₂=H₂(σ) holds. The verifier algorithm V also verifies whether c₃=H₃(σF(x+r^{A})+F^{C}(x)) holds. The verifier algorithm V outputs the value 1 indicating successful authentication if the verifications are all successful and outputs the value 0 indicating an authentication failure if a failure occurs in one of verifications.

If d=1, the verifier algorithm V calculates (z^{A}, F^{C})←σ. Then, the verifier algorithm V verifies whether c₁=H₁(F^{C}(z^{A})−αy, z^{A}) holds. The verifier algorithm V also verifies whether c₂=H₂(F^{C}(x)) holds. The verifier algorithm V outputs the value 1 indicating successful authentication if the verifications are all successful and outputs the value 0 indicating an authentication failure if a failure occurs in one of verifications.

In the foregoing, the processing performed by each algorithm during interactive protocol in the extending scheme has been described. By extending the present scheme in this manner, the amount of communication when the multivariable polynomial F^{B} whose representation size is large is transmitted to the verifier algorithm V during interactive protocol can be reduced by half so that the average data size to be exchanged can be reduced.

[3-3: Parallel Algorithm]

If, as described above, the interactive protocol according to the present scheme or extending scheme is applied, the probability with which falsification is successful can be suppressed to (½+1/q) or below. Therefore, if the interactive protocol is executed twice, the probability with which falsification is successful can be suppressed to (½+1/q)² or below. Further, if the interactive protocol is executed N times, the probability with which falsification is successful becomes (½+1/q)^{N} and if N is set to a sufficiently large number (for example, N=80), the probability with which falsification is successful can be made negligibly small.

As methods of executing the interactive protocol a plurality of times, for example, a serial method by which exchanges of messages, requests, and responses are sequentially repeated a plurality of times and a parallel method by which exchanges of messages, requests, and responses for a plurality of times are made by exchanges at a time can be considered. Here, a method of extending the interactive protocol according to the present scheme to an interactive protocol according to a parallel method (hereinafter, called the parallel algorithm) will be described. For example, the parallel algorithm looks as shown in FIG. 18. The content of the parallel algorithm will be described below with reference to FIG. 18.

(Key Generation Algorithm Gen)

The key generation algorithm Gen generates m multivariable polynomials f₁(x₁, . . . , xₙ), . . . , fₘ(x₁, . . . , xₙ) defined on the ring K and a vector s=(s₁, . . . , sₙ)εKⁿ. Next, the key generation algorithm Gen calculates y=(y₁, . . . , yₘ)←(f₁(s), . . . , fₘ(s)). Then, the key generation algorithm Gen sets (f₁, . . . , yₘ, y) as the public key pk and s as the secret key. The vector (x₁, . . . , xₙ) will be denoted as x and a set of multivariable polynomials (f₁(x), . . . , fₘ(x)) will be denoted as F(x) below.

(Prover Algorithm P, Verifier Algorithm V)

Next, processing performed by the prover algorithm P and processing performed by the verifier algorithm V during interactive protocol will be described with reference to FIG. 18.

During the above interactive protocol, the prover proves to the verifier that “the prover knows s satisfying y=F(s)” without leaking information about the secret key s to the verifier at all. On the other hand, the verifier verifies whether the prover knows s satisfying y=F(s). It is assumed that the public key pk is made public to the verifier. It is also assumed that the secret key s is managed in secret by the prover. The description will be provided below along the flow chart shown in FIG. 18.

Process #1:

First, the prover algorithm P performs processing (1) to processing (5) shown below for i=1 to N.

Processing (1): The prover algorithm P selects any number wᵢ.

Processing (2): The prover algorithm P generates a vector rᵢεKⁿ and a set of polynomials Fᵢ^{A}(x) by applying the number w, to the pseudo random number generator G. That is, the prover algorithm P calculates (rᵢ, Fᵢ^{A})←G(wᵢ).

Processing (3): The prover algorithm P calculates zᵢ←s−rᵢ. This calculation corresponds to an operation to mask the secret key s with the vector rᵢ.

Processing (4): The prover algorithm P generates a hash value c_{1,i} of Fᵢ^{A}(zᵢ) and zᵢ. That is, the prover algorithm P calculates c_{1,i}←H₁(Fᵢ^{A}(zᵢ), zᵢ).

Processing (5): The prover algorithm P generates a hash value c_{2,i} of the number wᵢ^{A}. That is, the prover algorithm P calculates c_{2,i}←H₂(wᵢ^{A}).

After the above processing (1) to processing (5) being performed for i=1 to N, the messages (c_{1,i}, c_{2,i}) (i=1 to N) generated in process #1 are transmitted to the verifier algorithm V.

Process #2:

The verifier algorithm V that receives the messages (c_{1,i}, c_{2,i}) (i=1 to N) randomly selects N numbers α₁, . . . , α_{N} from q elements existing in the ring K. Then, the verifier algorithm V transmits the selected numbers α₁, . . . , α_{N} to the prover algorithm P.

Process #3:

The prover algorithm P that receives the numbers α₁, . . . , α_{N} calculates Fᵢ^{B}(x)←αᵢF(x+rᵢ)+Fᵢ^{A}(x) for i=1 to N. This calculation corresponds to an operation to mask the multivariable polynomial F(x+rᵢ) regarding x with the multivariable polynomial Fᵢ^{A}(x). Then, the prover algorithm P transmits the multivariable polynomials F₁^{B}, . . . , F_{N}^{B} to the verifier algorithm V.

Process #4:

The verifier algorithm V that receives the multivariable polynomials F₁^{B}, . . . , F_{N}^{B} makes a selection of which verification pattern of the two verification patterns to use for each of i=1 to N. For example, the verifier algorithm V selects one number from two numbers {0, 1} representing the verification patterns and sets the selected number to a request dᵢ for each of i=1 to N. The request dᵢ is transmitted to the prover algorithm P.

Process #5:

The prover algorithm P that receives the request dᵢ(i=1 to N) generates a response σᵢ to be transmitted to the verifier algorithm V in accordance with the received request dᵢ. The prover algorithm P performs processing (1) and processing (2) shown below for i=1 to N.

Processing (1): If dᵢ=0, the prover algorithm P generates a response σᵢ=wᵢ.

Processing (2): If dᵢ=1, the prover algorithm P generates a response σᵢ=zᵢ.

After the above processing (1) and processing (2) being performed, the response σᵢ(i=1 to N) is transmitted to the verifier algorithm V.

Process #6:

The verifier algorithm V that receives the response σᵢ(i=1 to N) performs the following verification processing by using the received response σᵢ(i=1 to N). The following processing is performed for i=1 to N.

If dᵢ=0, the verifier algorithm V calculates (rᵢ^{A}, Fᵢ^{C})←G(σᵢ). Then, the verifier algorithm V verifies whether c_{2,i}=H₂(σᵢ) holds. The verifier algorithm V also verifies whether Fᵢ^{B}(x)=αᵢF(x+rᵢ^{A})+Fᵢ^{C}(x) holds. The verifier algorithm V outputs the value 1 indicating successful authentication if the verifications are all successful and outputs the value 0 indicating an authentication failure if a failure occurs in one of verifications.

If dᵢ=1, the verifier algorithm V calculates zᵢ^{A}←σᵢ. Then, the verifier algorithm V verifies whether c_{1,i}=H₁(Fᵢ^{C}(zᵢ^{A})−αᵢy, zᵢ) holds. The verifier algorithm V outputs the value 1 indicating successful authentication if the verification is successful and outputs the value 0 indicating an authentication failure if a failure occurs in the verification.

In the foregoing, the method of executing the interactive protocol of the present scheme in parallel has been described. By repeatedly executing the interactive protocol of the present scheme as described above, the probability with which falsification is successful can be made negligibly small. The extending scheme can similarly be parallelized.

(Modification)

After process #1 described above, instead of transmitting messages (c_{1,1} c_{1,2}, . . . , c_{N,1}, c_{N,2}) to the verifier algorithm V, the configuration of the interactive protocol may be modified so that messages are transmitted after being put together as a hash value H (c_{1,1}, c_{1,2}, . . . , c_{N,1}, c_{N,2}). If the modification is applied, only one hash value is transmitted in the first pass, reducing the amount of communication significantly. However, considering the existence of messages that are difficult to restore by the verifier algorithm V even if information transmitted from the prover algorithm P is used, it is also necessary to transmit such messages when a response is transmitted. According to the configuration, the number of pieces of information to be transmitted can be reduced by N−1 if configured to repeat N times in parallel.

(Parallel Algorithm According to the Extending Scheme)

The configuration of the parallel algorithm according to the extending scheme will be described with reference to FIG. 19. The configuration of the key generation algorithm Gen is the same as that of the parallel algorithm according to the present scheme and thus, a detailed description thereof is omitted.

Process #1:

First, the prover algorithm P performs processing (1) to processing (5) shown below for i=1 to N.

Processing (1): The prover algorithm P selects any number wᵢ.

Processing (2): The prover algorithm P generates a vector rᵢεKⁿ and a set of multivariable polynomials Fᵢ^{A}(x) by applying the number wᵢ to the pseudo random number generator G. That is, the prover algorithm P calculates (rᵢ, Fᵢ^{A})←G(wᵢ).

Processing (3): The prover algorithm P calculates zᵢ←s−rᵢ. This calculation corresponds to an operation to mask the secret key s with the vector rᵢ.

Processing (4): The prover algorithm P generates a hash value c_{1,i} of Fᵢ^{A}(zᵢ) and zᵢ. That is, the prover algorithm P calculates c_{1,i}←H₁(Fᵢ^{A}(zᵢ), zᵢ).

Processing (5): The prover algorithm P generates a hash value c_{2,i} of the number wᵢ. That is, the prover algorithm P calculates c_{2,i}←H₂(wᵢ).

After the above processing (1) to processing (5) being performed for i=1 to N, the messages (c_{1,i}, c_{2,i}) (i=1 to N) generated in process #1 are transmitted to the verifier algorithm V.

Process #2:

The verifier algorithm V that receives the messages (c_{1,i}, c_{2,i}) (i=1 to N) randomly selects N numbers α₁, . . . , α_{N} from q elements existing in the ring K. Then, the verifier algorithm V transmits the selected numbers α₁, . . . , α_{N} to the prover.

Process #3:

The prover algorithm P that receives the numbers α₁, . . . , α_{N} calculates Fᵢ^{B}(x)←αᵢF(x+rᵢ)+Fᵢ^{A}(x) for i=1 to N. This calculation corresponds to an operation to mask the multivariable polynomial F(x+rᵢ) regarding x with the multivariable polynomial Fᵢ^{A}(x). Next, the prover algorithm P generates a hash value c₃ of the multivariable polynomials F₁^{B}, . . . , F_{N}^{B}. That is, the prover algorithm P calculates c₃←H₃(F₁^{B}, . . . , F_{N}^{B}). H₃( . . . ) shown above is a hash function. The message c₃ generated in process #3 is transmitted to the verifier algorithm V.

Process #4:

The verifier algorithm V that receives the message c₃ makes a selection of which verification pattern of the two verification patterns to use for each of i=1 to N. For example, the verifier algorithm V selects one number from two numbers {0, 1} representing the verification patterns and sets the selected number to a request dᵢ for each of i=1 to N. The request dᵢ is transmitted to the prover algorithm P.

Process #5:

The prover algorithm P that receives the request dᵢ(i=1 to N) generates a response σᵢ to be transmitted to the verifier algorithm V in accordance with the received request dᵢ. The prover algorithm P performs processing (1) and processing (2) shown below for i=1 to N.

Processing 1: If dᵢ=0, the prover algorithm P generates a response σᵢ=wᵢ.

Processing 2: If dᵢ=1, the prover algorithm P generates a response σᵢ=(zᵢ, Fᵢ^{B}).

After the above processing (1) and processing (2) being performed, the response σᵢ(i=1 to N) is transmitted to the verifier algorithm V.

Process #6:

The verifier algorithm V that receives the response σᵢ(i=1 to N) performs the following verification processing by using the received response σᵢ(i=1 to N). The following processing is performed for i=1 to N.

If dᵢ=0, the verifier algorithm V calculates (rᵢ^{A}, Fᵢ^{C})←G(σᵢ). Further, the verifier algorithm V calculates Fᵢ^{D}←αᵢF(x+rᵢ^{A})+Fᵢ^{C}(x). Then, the verifier algorithm V verifies whether c_{2,i}=H₂(σᵢ) holds. The verifier algorithm V also verifies whether c₃=H₃(F₁^{D}, . . . , F_{N}^{D}) holds. The verifier algorithm V outputs the value 1 indicating successful authentication if the verifications are all successful and outputs the value 0 indicating an authentication failure if a failure occurs in one of verifications.

If dᵢ=1, the verifier algorithm V sets (zᵢ^{A},Fᵢ^{D})←σᵢ. Then, the verifier algorithm V verifies whether c_{1,i}=H₁(Fᵢ^{D}(zᵢ^{A})−αᵢγ, zᵢ^{A}) holds. Further, the verifier algorithm V verifies whether c₃=H₃(F₁^{D}, . . . , F_{N}^{D}) holds. The verifier algorithm V outputs the value 1 indicating successful authentication if the verifications are all successful and outputs the value 0 indicating an authentication failure if a failure occurs in one of verifications.

In the foregoing, the configuration of the parallel algorithm according to the extending scheme has been described.

(Method of Setting Preferred Parameters)

Like the interactive protocol according to the first embodiment, the interactive protocol according to the present embodiment secures a level of safety against passive attacks. However, if the above method of repeatedly executing the dialog protocol in parallel is applied, conditions shown below are necessary to be able to prove that a level of safety against active attacks are reliably secured.

The above interactive protocol is to prove to the verifier by the prover through a dialog that “the prover knows s satisfying y=F(s)” by using a pair of keys (a public key y, a secret key s) without leaking information about the secret key s to the verifier at all. Thus, if a dialog received during verification is performed, there is no denying the possibility that information of “the prover used s during dialog” is known to the verifier. Moreover, difficulty of collision of multivariable polynomials F is not guaranteed. Thus, if the above interactive protocol is repeatedly executed in parallel, it is difficult to unconditionally prove that safety against active attacks is reliably secured.

Thus, the inventor of the present technology considered a method of preventing the verifier from knowing the information of “the prover used s during dialog” even if a dialog received during verification is performed. Then, the inventor of the present technology invented a method of making possible to prove that safety against active attacks is secured even if the above interactive protocol is repeatedly executed in parallel. The method is to impose a setting condition of setting the number m of n-variable multi-order polynomials f₁, . . . , fₘ used as the public key sufficiently smaller than the number n of variables thereof. For example, m and n are set so that 2^{m-n}<<1 is satisfied (if, for example, n=160 and m=80, 2⁻⁸⁰<<1).

In a scheme whose safety is grounded on difficulty of solving a problem of a multi-order multivariable simultaneous equation as described above, if a secret key s₁ and a public key pk corresponding thereto are given, it is difficult to generate another secret key s₂ corresponding to the public key pk. Thus, if it is guaranteed that two or more secret keys s corresponding to the public key pk exist, it becomes possible to prevent the verifier from knowing the information of “the prover used s during dialog” even if a dialog received during verification is performed. That is, if the guarantee can be provided, safety against active attacks can be secured even if the interactive protocol is repeatedly executed in parallel.

Considering a function F: Kⁿ→K^{m} constituted of m n-variable multi-order polynomials (n>m) with reference to FIG. 40, the number of elements of the domain having no second inverse image is maximally |K|^{m}−1. Thus, if |K|^{m-n} is made sufficiently small, the probability with which an element of the domain having no second inverse image is selected can be made negligibly small. That is, if the number m of n-variable multi-order polynomials f₁, . . . , fₘ is set to a value sufficiently smaller than the number n of variables thereof, the existence of two or more secret keys s corresponding to the public key pk can be guaranteed. As a result, it becomes possible to prevent the verifier from knowing the information of “the prover used s during dialog” even if a dialog received during verification is performed and safety against active attacks can be secured even when the interactive protocol is repeatedly executed in parallel.

By imposing, as described above, the setting condition of setting the number m of n-variable multi-order polynomials fₘ to a value sufficiently smaller than the number n of variables thereof (n>m, preferably 2^{m-n}<<1), it becomes possible to secure safety when the interactive protocol is repeatedly executed in parallel.

[3-4: Concrete Example (when a Second-Order Polynomial is Used)]

Next, a case when an n-variable second-order polynomial is used as a multivariable polynomial F will be described with reference to FIG. 20. FIG. 20 is an explanatory view illustrating a concrete example of the present scheme.

(Key Generation Algorithm Gen)

The key generation algorithm Gen generates m second-order polynomials f₁(x₁, . . . , xₙ), fₘ(x₁, . . . , xₙ) defined on a ring K and a vector s=(s₁, . . . , sₙ)εKⁿ. Next, the key generation algorithm Gen calculates y=(y₁, . . . , yₘ)←(f₁(s), . . . , fₘ(s)). Then, the key generation algorithm Gen sets (f₁, . . . , fₘ, y) as the public key pk and s as the secret key. The vector (x₁, . . . , xₙ) will be denoted as x and a set of second-order polynomials (f₁(x), . . . , fₘ(x)) will be denoted as F(x) below.

(Prover Algorithm P, Verifier Algorithm V)

Next, processing performed by the prover algorithm P and by the verifier algorithm V during interactive protocol will be described with reference to FIG. 20.

Process #1:

First, the prover algorithm P selects any number w. Next, the prover algorithm P generates a vector rεKⁿ and a set of multivariable polynomials F^{A}(x)=(f₁^{A}(x), . . . , fₘ^{A}(x)) by applying the number w to the pseudo random number generator G. That is, the prover algorithm P calculates (r,F^{A})←G(w). Next, the prover algorithm P calculates z←s−r. This calculation corresponds to an operation to mask the secret key s with the vector r. The second-order polynomial fᵢ^{A}(x) is expressed like the following formula (18).

$${f}_{i}^{A} ( x ) = {\sum }_{j}^{ } {b}_{i , j}^{A} {x}_{j} \qquad ( 18 )$$

Process #1(Continued):

Next, the prover algorithm P generates a hash value c₁ of F^{A}(z) and z. That is, the prover algorithm P calculates c₁←H₁(F^{A}(z), z). The prover algorithm P also generates a hash value c₂ of the number w. That is, the prover algorithm P calculates c₂←H₂(w). H₁( . . . ) and H₂( . . . ) shown above are hash functions. The message (c₁, c₂) generated in process #1 is transmitted to the verifier algorithm V.

Process #2:

The verifier algorithm V that receives the message (c₁, c₂) randomly selects one number α from q elements existing in the ring K and transmits the selected number α to the prover algorithm P.

Process #3:

The prover algorithm P that receives the number α calculates F^{B}(x)←αF(x+r)+F^{A}(x). This calculation corresponds to an operation to mask the multivariable polynomial F(x+r) regarding x with the multivariable polynomial F^{A}(x). The multivariable polynomial F^{B} generated in process #3 is transmitted to the verifier algorithm V.

Process #4:

The verifier algorithm V that receives the multivariable polynomial F^{B} makes a selection of which verification pattern of the two verification patterns to use. For example, the verifier algorithm V selects one number from two numbers {0, 1} representing the verification patterns and sets the selected number to a request d. The request d is transmitted to the prover algorithm P.

Process #5:

The prover algorithm P that receives the request d generates a response σ to be transmitted to the verifier algorithm V in accordance with the received request d. If d=0, the prover algorithm P generates a response σ=w. If d=1, the prover algorithm P generates a response σ=z. The response σ generated in process #5 is transmitted to the verifier algorithm V.

Process #6:

The verifier algorithm V that receives the response σ performs the following verification processing by using the received response σ.

If d=0, the verifier algorithm V calculates (r^{A}, F^{C})←G(σ). Then, the verifier algorithm V verifies whether c₂=H₂(σ) holds. The verifier algorithm V also verifies whether F^{B}(x)=αF(x+r^{A})+F^{C}(x) holds. The verifier algorithm V outputs the value 1 indicating successful authentication if the verifications are all successful and outputs the value 0 indicating an authentication failure if a failure occurs in one of verifications.

If d=1, the verifier algorithm V sets z^{A}←σ. Then, the verifier algorithm V verifies whether c₁=H₁(F^{B}(z^{A})−αy, z^{A}) holds. The verifier algorithm V outputs the value 1 indicating successful authentication if the verification is successful and outputs the value 0 indicating an authentication failure if a failure occurs in the verification.

In the foregoing, a concrete example of the present scheme has been described.

[3-5: Efficient Algorithm]

Next, the method of making an algorithm according to the present method efficient will be described. Like the method of making an algorithm more efficient considered in the first embodiment, a multivariable polynomial F^{A}(x) used for masking of a multivariable polynomial F(x+r) is expressed as F^{A}(x)=F_{b}(x, t)+e by using two vectors tεKⁿ, eεK^{m}. If the above expression is used, the relationship expressed in the following formula (19) is obtained for the multivariable polynomial F(x+r).

$$\begin{matrix}α F ( x + r ) + {F}^{A} ( x ) = α F ( x ) + α F ( r ) + α {F}_{b} ( x , r ) + \\ {F}_{b} ( x , t ) + e \\ = α F ( x ) + {F}_{b} ( x , α r + t ) + α F ( r ) + e\end{matrix} \qquad ( 19 )$$

Thus, if set like t^{A}=αr+t and e^{A}=αF(r)+e, the masked multivariable polynomial F^{B}(x)=αF(x+r)+F^{A}(x) can also be expressed by two vectors t^{A}εKⁿ, e^{A}εK^{m}. For the above reason, if set like F^{A}(x)=F_{b}(x,t)+e, F^{A} and F^{B} can be expressed by using a vector on Kⁿ and a vector on K^{m} so that the size of data necessary for communication can significantly be reduced. More specifically, communication costs are reduced by a factor of a few thousands to a few tens of thousands.

Incidentally, no information about r is leaked from F^{B} (or F^{A}) at all by the above modification. For example, even if e^{A} and t^{A} (or e and t) are given, it is difficult to know information about r as long as e and t (or e^{A} and t^{A}) are not known. Therefore, if the above modification is applied to the present scheme, zero knowledge is guaranteed. Efficient algorithms according to the present scheme will be described below with reference to FIGS. 21 to 27. The configuration of the key generation algorithm Gen is unchanged and thus, a detailed description thereof is omitted.

(Configuration Example 1 of the Efficient Algorithm: FIG. 21)

First, the configuration of the efficient algorithm shown in FIG. 21 will be described.

Process #1:

First, the prover algorithm P selects any number w. Next, the prover algorithm P generates vectors rεKⁿ, tεKⁿ, eεK^{m} by applying the number w to the pseudo random number generator G. That is, the prover algorithm P calculates (r,t,e)←G(w). Next, the prover algorithm P calculates z←s−r. This calculation corresponds to an operation to mask the secret key s with the vector r.

Process #1(Continued):

Next, the prover algorithm P generates a hash value c₁ of F_{b}(z,t)+e and z. That is, the prover algorithm P calculates c₁←H₁(F_{b}(z,t)+e, z) The prover algorithm P also generates a hash value c₂ of the number w. That is, the prover algorithm P calculates c₂←H₂(w). H₁( . . . ) and H₂( . . . ) shown above are hash functions. The message (c₁, c₂) generated in process #1 is transmitted to the verifier algorithm V.

Process #2:

The verifier algorithm V that receives the message (c₁, c₂) randomly selects one number α from q elements existing in the ring K and transmits the selected number α to the prover algorithm P.

Process #3:

The prover algorithm P that receives the number α calculates t^{A}←αr+t. Further, the prover algorithm P calculates e^{A}←αF(r)+e. Then, the prover algorithm P transmits t^{A} and e^{A} to the verifier algorithm V.

Process #4:

The verifier algorithm V that receives t^{A} and e^{A} makes a selection of which verification pattern of the two verification patterns to use. For example, the verifier algorithm V selects one number from two numbers {0, 1} representing the verification patterns and sets the selected number to a request d. The request d is transmitted to the prover algorithm P.

Process #5:

The prover algorithm P that receives the request d generates a response σ to be transmitted to the verifier algorithm V in accordance with the received request d. If d=0, the prover algorithm P generates a response σ=w. If d=1, the prover algorithm P generates a response σ=z. The response σ generated in process #5 is transmitted to the verifier algorithm V.

Process #6:

The verifier algorithm V that receives the response σ performs the following verification processing by using the received response σ.

If d=0, the verifier algorithm V calculates (r^{A}, t^{B}, e^{B})←G(σ). Then, the verifier algorithm V verifies whether c₂=H₂(σ) holds. The verifier algorithm V also verifies whether t^{A}=σr^{A}+t^{B} holds. Further, the verifier algorithm V verifies whether e^{A}=σF(r^{A})+e^{B} holds. The verifier algorithm V outputs the value 1 indicating successful authentication if the verifications are all successful and outputs the value 0 indicating an authentication failure if a failure occurs in one of verifications.

If d=1, the verifier algorithm V executes z^{A}←σ. Then, the verifier algorithm V verifies whether c₁=H(α(F(z^{A})−y)+F_{b}(z^{A}, t^{A})+e^{A}, z^{A}) holds. The verifier algorithm V outputs the value 1 indicating successful authentication if the verification is successful and outputs the value 0 indicating an authentication failure if a failure occurs in the verification.

In the foregoing, Configuration example 1 of the efficient algorithm has been described. By using the efficient algorithm, the size of data necessary for communication can significantly be reduced. Moreover, because the calculation of F(x+r) is no longer necessary, calculation efficiency is also improved.

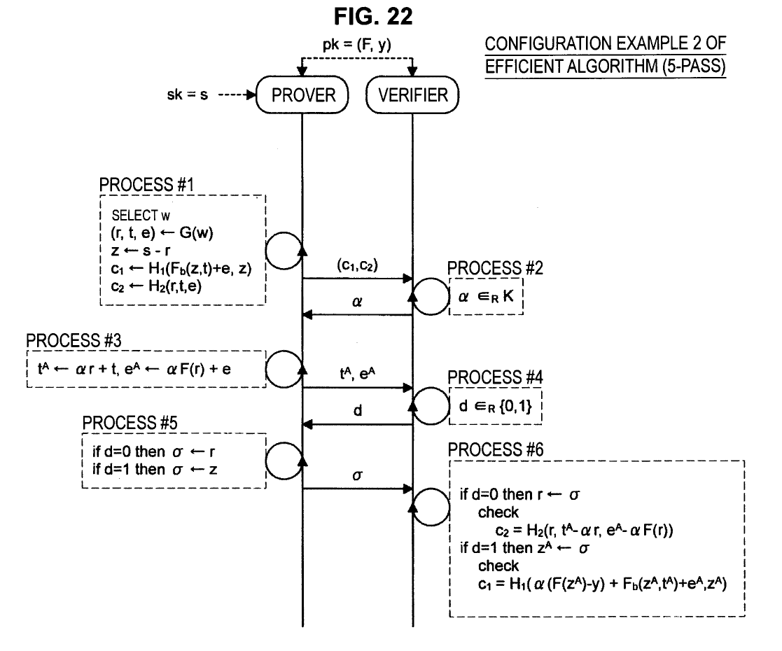

(Configuration Example 2 of the Efficient Algorithm: FIG. 22)

Next, the configuration of the efficient algorithm shown in FIG. 22 will be described. Also when the configuration shown in FIG. 22 is applied, like when the configuration shown in FIG. 20 is applied, an improvement effect of communication efficiency and calculation efficiency is obtained. However, only a difference from the configuration shown in FIG. 20 will be described here.

In process #5 of the algorithm shown in FIG. 20, w is set to a when d=0, but a to be set when d=0 may be any information that allows (r, t, e) to be restored by using together with (t^{A}, e^{B}). For example, as shown in FIG. 22, content of a set when d=0 in process #5 may be changed to r. When this modification is made, it is necessary to modify the calculation c₂←H₂(w) in process #1 to c₂←H₂(r,t,e). Also, content of verification performed by the verifier algorithm V when d=0 in process #6 is replaced by the verification of c₂=H₂(r, t^{A}−αr, e^{A}−αF(r)).

In the foregoing, Configuration example 2 of the efficient algorithm has been described.

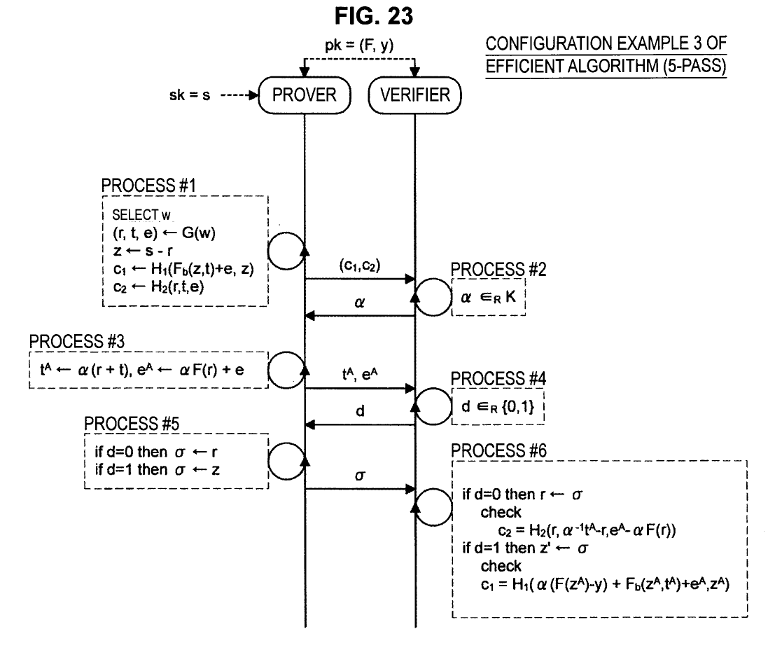

(Configuration Example 3 of the Efficient Algorithm: FIG. 23)

Next, the configuration of the efficient algorithm shown in FIG. 23 will be described. Also when the configuration shown in FIG. 23 is applied, like when the configuration shown in FIG. 20 is applied, an improvement effect of communication efficiency and calculation efficiency is obtained. However, only a difference from the configuration shown in FIG. 22 will be described here.

The calculation t^{A}←αr+t is performed in process #3 shown in FIG. 22, but the calculation may be modified to the calculation t^{A}←α(r+t) shown in FIG. 23. However, if this modification is made, content of verification performed by the verifier algorithm V when d=0 in process #6 is replaced by the verification of c₂=H₂(r, α⁻¹t^{A}−r, e^{A}−αF(r)).

In the foregoing, Configuration example 3 of the efficient algorithm has been described.

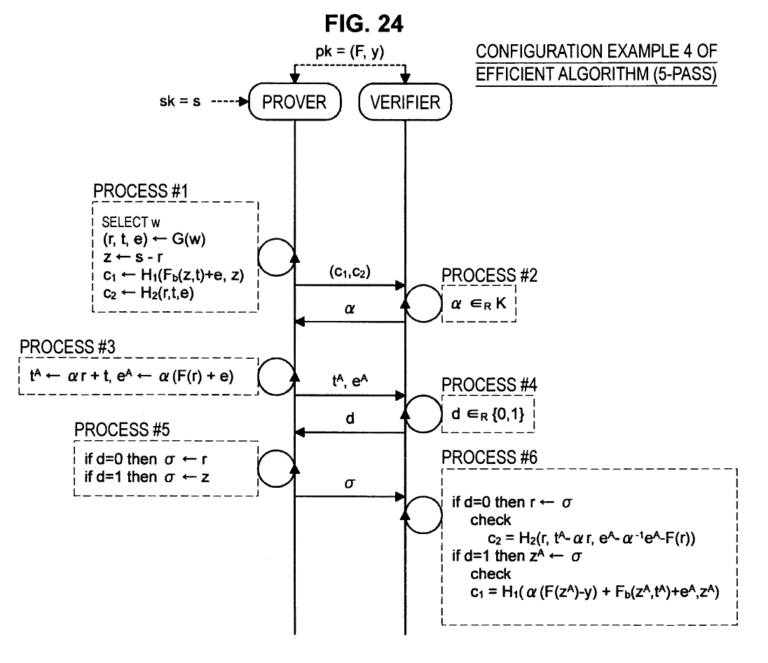

(Configuration Example 4 of the Efficient Algorithm: FIG. 24)

Next, the configuration of the efficient algorithm shown in FIG. 24 will be described. Also when the configuration shown in FIG. 24 is applied, like when the configuration shown in FIG. 20 is applied, an improvement effect of communication efficiency and calculation efficiency is obtained. However, only a difference from the configuration shown in FIG. 22 will be described here.

The calculation e^{A}←αF(r)+e is performed in process #3 shown in FIG. 22, but the calculation may be modified to the calculation e^{A}←α(F(r)+e) shown in FIG. 24. However, if this modification is made, content of verification performed by the verifier algorithm V when d=0 in process #6 is replaced by the verification of c₂=H₂(r, t^{A}−αr, e^{A}−α⁻¹e^{A}−F(r)).

In the foregoing, Configuration example 4 of the efficient algorithm has been described.

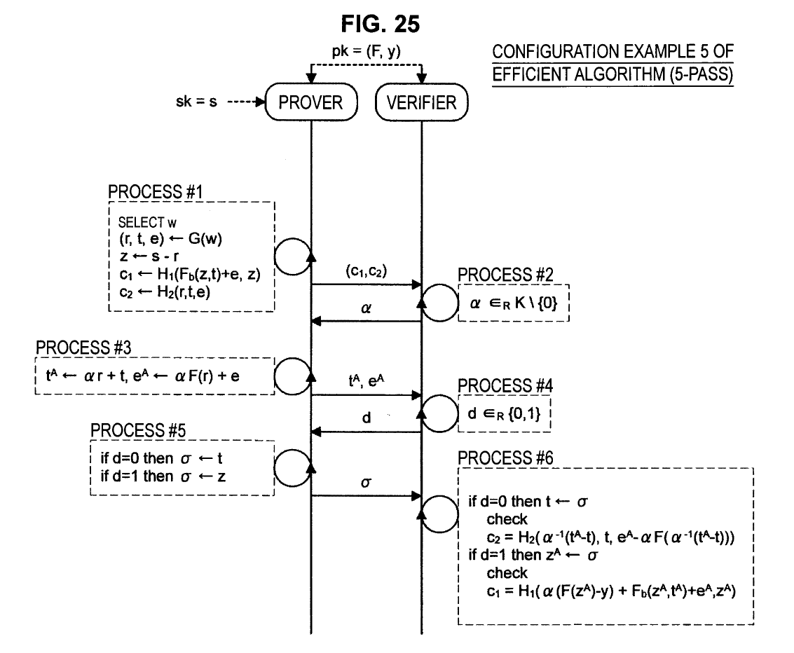

(Configuration Example 5 of the Efficient Algorithm: FIG. 25)

Next, the configuration of the efficient algorithm shown in FIG. 25 will be described. Also when the configuration shown in FIG. 25 is applied, like when the configuration shown in FIG. 20 is applied, an improvement effect of communication efficiency and calculation efficiency is obtained. However, only a difference from the configuration shown in FIG. 22 will be described here.

In process #5 of the algorithm shown in FIG. 22, r is set to σ when d=0, but σ to be set when d=0 may be any information that allows (r, t, e) to be restored by using together with (t^{A}, e^{B}). For example, as shown in FIG. 25, content of σ set when d=0 in process #5 may be changed to t. However, if this modification is made, α is made to be selected from αε_{R}K¥{0} in process #2. Moreover, content of verification performed by the verifier algorithm V when d=0 in process #6 is replaced by the verification of c₂=H₂(α⁻¹(t^{A}−t), t, e^{A}−αF(α⁻¹(t^{A}−t))).

In the foregoing, Configuration example 5 of the efficient algorithm has been described.

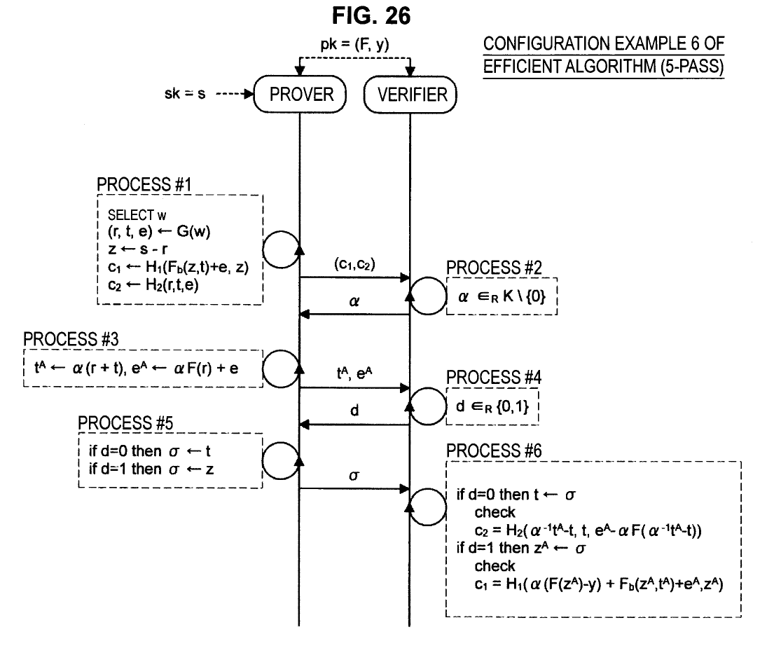

(Configuration Example 6 of the Efficient Algorithm: FIG. 26)

Next, the configuration of the efficient algorithm shown in FIG. 26 will be described. Also when the configuration shown in FIG. 26 is applied, like when the configuration shown in FIG. 20 is applied, an improvement effect of communication efficiency and calculation efficiency is obtained. However, only a difference from the configuration shown in FIG. 25 will be described here.

The calculation t^{A}←αr+t is performed in process #3 shown in FIG. 25, but the calculation may be modified to the calculation t^{A}←α(r+t) shown in FIG. 26. However, if this modification is made, content of verification performed by the verifier algorithm V when d=0 in process #6 is replaced by the verification of c₂=H₂(α⁻¹t^{A}−t, t, e^{A}−αF(α^{-α}t^{A}−t)).

In the foregoing, Configuration example 6 of the efficient algorithm has been described.

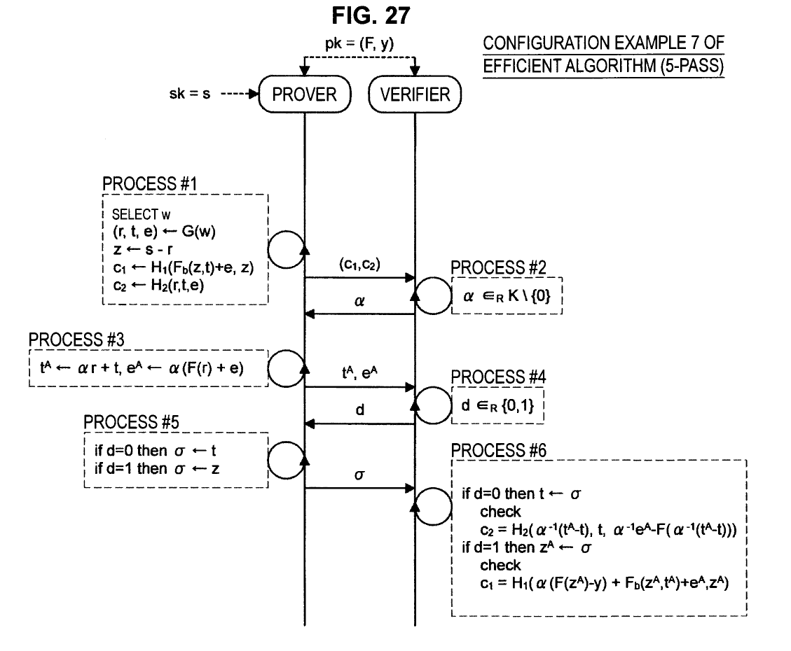

(Configuration Example 7 of the Efficient Algorithm: FIG. 27)

Next, the configuration of the efficient algorithm shown in FIG. 27 will be described. Also when the configuration shown in FIG. 27 is applied, like when the configuration shown in FIG. 20 is applied, an improvement effect of communication efficiency and calculation efficiency is obtained. However, only a difference from the configuration shown in FIG. 25 will be described here.

The calculation e^{A}←αF(r)+e is performed in process #3 shown in FIG. 25, but the calculation may be modified to the calculation e^{A}←α(F(r)+e) shown in FIG. 27. However, if this modification is made, content of verification performed by the verifier algorithm V when d=0 in process #6 is replaced by the verification of c₂=H₂(α⁻¹(t^{A}−t), t, α⁻¹e^{A}−αF(α⁻¹(t^{A}−t))).

In the foregoing, Configuration example 7 of the efficient algorithm has been described.

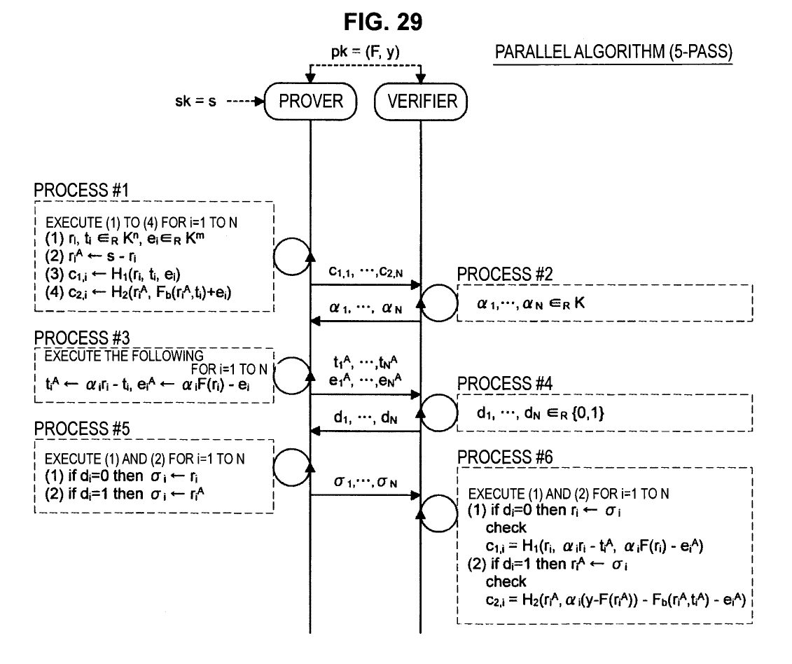

(Parallelization of the Efficient Algorithm: FIG. 29)

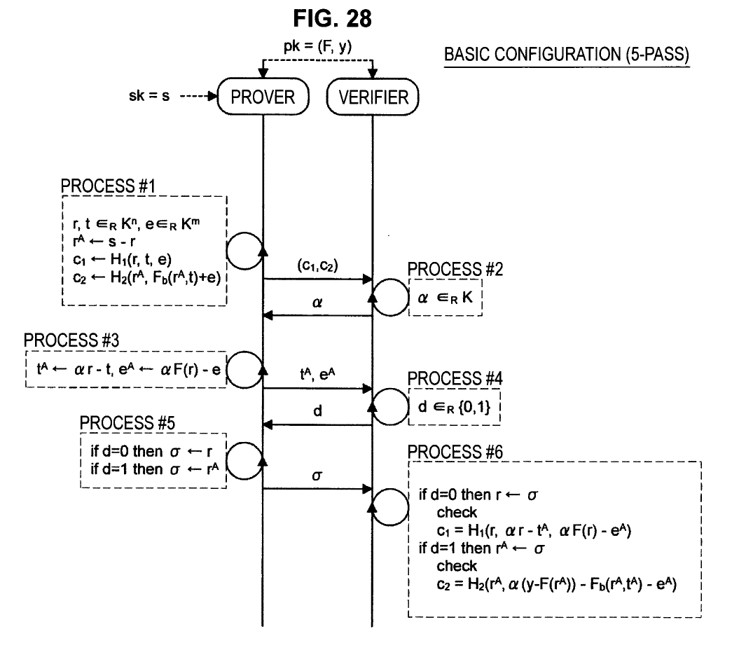

Next, the method of parallelizing the efficient algorithm will be described with reference to FIG. 29. The configuration shown in FIG. 29 (hereinafter, called the parallel algorithm) is obtained by parallelizing the efficient algorithm shown in FIG. 28. The efficient algorithm shown in FIG. 28 is an algorithm having substantially the same configuration as the efficient algorithm shown in FIG. 22. The description will be provided below along the flow chart shown in FIG. 29.

Process #1:

The prover algorithm P performs processing (1) to processing (4) for i=1 to N.

Processing (1): The prover algorithm P generates any vectors rᵢ, tᵢεKⁿ and eᵢεK^{m}.

Processing (2): The prover algorithm P calculates rᵢ^{A}←s−rᵢ. This calculation corresponds to an operation to mask the secret key s with the vector rᵢ.

Processing (3): The prover algorithm P calculates c_{1,i}←H₁(rᵢ, tᵢ, eᵢ).

Processing (4): The prover algorithm P calculates c_{2,i}←H₂(rᵢ^{A}, F_{b}(rᵢ^{A}, tᵢ)+eᵢ)

The message (c_{1,1}, c_{2,1}, . . . , c_{1,N}, c_{2,N}) generated in process #1 is transmitted to the verifier algorithm V.

Process #2:

The verifier algorithm V that receives the message (c_{1,1}, c_{2,1}, . . . , c_{1,N}, c_{2,N}) randomly selects, for each of i=1 to N, one number αᵢ from q elements existing in the ring K and transmits the selected number αᵢ to the prover algorithm P.

Process #3:

The prover algorithm P that receives the number αᵢ calculates tᵢ^{A}←αᵢrᵢ−tᵢ for each of i=1 to N. Further, the prover algorithm P calculates eᵢ^{A}←αᵢF(rᵢ)−eᵢ for each of i=1 to N. Then, the prover algorithm P transmits t₁^{A}, . . . , t_{N}^{A} and e₁^{A}, . . . , e_{N}^{A} to the verifier algorithm V.

Process #4:

The verifier algorithm V that receives t₁^{A}, . . . , t_{N}^{A} and e₁^{A}, . . . , e_{N}^{A} makes a selection, for each of i=1 to N, of which verification pattern of the two verification patterns to use. For example, the verifier algorithm V selects one number from two numbers {0, 1} representing the verification patterns and sets the selected number to a request dᵢ. The request dᵢ(i=1 to N) is transmitted to the prover algorithm P.

Process #5:

The prover algorithm P that receives the request dᵢ(i=1 to N) generates, for i=1 to N, a response σᵢ to be transmitted to the verifier algorithm V in accordance with the received request dᵢ. If dᵢ=0, the prover algorithm P generates a response σᵢ=rᵢ. If dᵢ=1, the prover algorithm P generates a response σᵢ=rᵢ^{A}. The response σᵢ generated in process #5 is transmitted to the verifier algorithm V.

Process #6:

The verifier algorithm V that receives the response σᵢ(i=1 to N) performs the following verification processing by using the received response σᵢ(i=1 to N).

If dᵢ=0, the verifier algorithm V executes rᵢ←σᵢ. Then, the verifier algorithm V verifies whether c_{1,i}=H₁(rᵢ, αᵢF(rᵢ)−eᵢ^{A}) holds. The verifier algorithm V outputs the value 1 indicating successful authentication if the verification is successful and outputs the value 0 indicating an authentication failure if a failure occurs in the verification.

If dᵢ=1, the verifier algorithm V executes rᵢ^{A}←σᵢ. Then, the verifier algorithm V verifies whether c_{2,i}=H₂(rᵢ^{A}, σᵢ(y−F(rᵢ^{A}))−F_{b}(tᵢ^{A}, rᵢ^{A})−eᵢ^{A}) holds. The verifier algorithm V outputs the value 1 indicating successful authentication if the verification is successful and outputs the value 0 indicating an authentication failure if a failure occurs in the verification.

In the foregoing, parallelization of the efficient algorithm has been described.

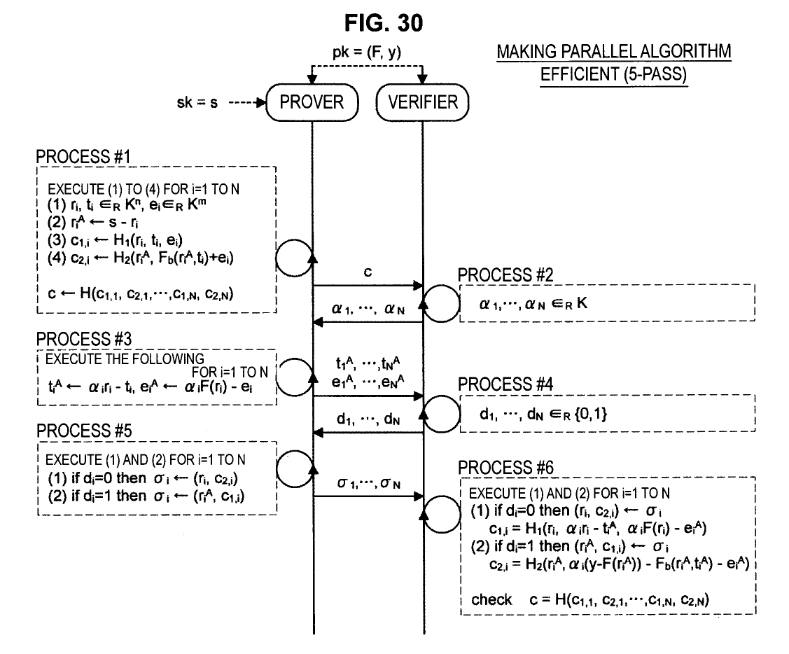

(Making the Parallel Algorithm Efficient: FIG. 30)

The parallel algorithm shown in FIG. 29 can be made, as shown in FIG. 30, efficient. As shown in FIG. 30, the parallel algorithm is configured to convert messages (c_{1,1}, c_{2,1}, . . . , c_{1,N}, c_{2,N}) into a hash value c and to transmit the hash value c from the prover algorithm P to the verifier algorithm V in the first pass in process #1. The parallel algorithm is also configured to generate a response σᵢ=(rᵢ, c_{2,i}) when dᵢ=0 and a response σᵢ=(rᵢ^{A}, c_{1,i}) when dᵢ=1 in process #5. Further, the parallel algorithm is configured to perform the following processing in process #6.

Process #6:

First, the verifier algorithm V performs processing (1) and processing (2) for i=1 to N. Actually, the processing (1) is performed when d₁=0 and the processing (2) is performed when dᵢ=1.

Processing (1): If dᵢ=0, the verifier algorithm V executes (rᵢ, c_{2,i})←σᵢ. Further, the verifier algorithm V calculates c_{1,i}=H₁(rᵢ, αᵢrᵢ−tᵢ^{A}, αᵢF(r)−eᵢ^{A}). Then, the verifier algorithm V holds (c_{1,i}, c_{2,i}).

Processing (2): If dᵢ=1, the verifier algorithm V executes (rᵢ^{A}, c_{1,i})←σᵢ. Further, the verifier algorithm V calculates c_{1,i}=H₂(rᵢ^{A}, αᵢ(y−F(rᵢ^{A}))−F_{b}(tᵢ^{A}, rᵢ^{A})−eᵢ^{A}).

Then, the verifier algorithm V holds (c_{1,i}, c_{2,1}).

After the above processing (1) and processing (2) being performed for i=1 to N, the verifier algorithm V verifies whether c=H(c_{1,1}, c_{2,1}, . . . , c_{1,N}, c_{2,N}) holds. The verifier algorithm V outputs the value 1 indicating successful authentication if the verification is successful and outputs the value 0 indicating an authentication failure if a failure occurs in the verification.

In the foregoing, making the parallel algorithm efficient has been described.

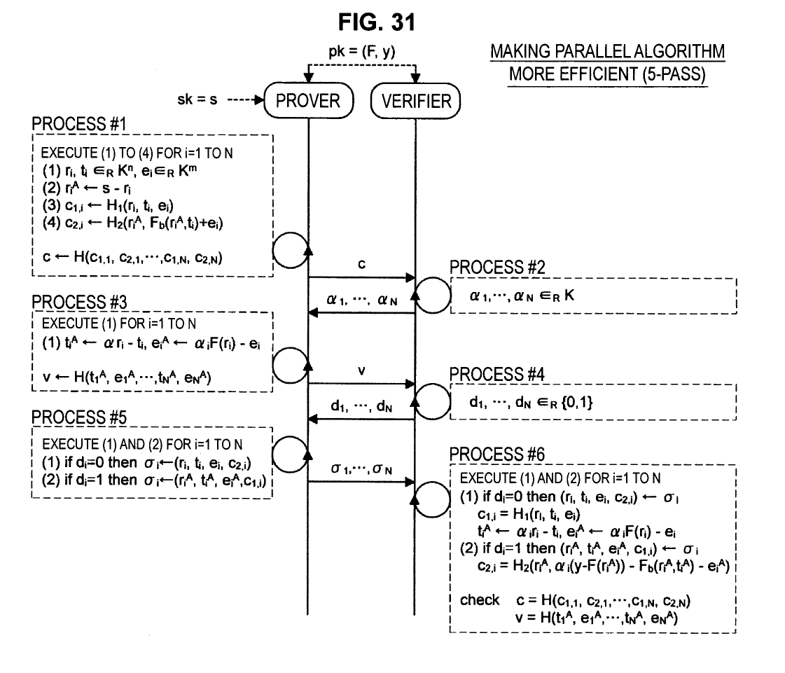

(Making the Parallel Algorithm More Efficient: FIG. 31)

The parallel algorithm shown in FIG. 30 can be made, as shown in FIG. 31, more efficient. As shown in FIG. 31, in process #3, the parallel algorithm is configured to convert (t₁^{A}, e₁^{A}, . . . , t_{N}^{A}, e_{N}^{A}) into a hash value v and to transmit the hash value v from the prover algorithm P to the verifier algorithm V in the third pass. The parallel algorithm is also configured to generate a response σᵢ=(rᵢ, tᵢ, eᵢ, c_{2,i}) when dᵢ=0 and a response σᵢ=(rᵢ^{A}, tᵢ^{A}, eᵢ^{A}, c_{1,i}) when dᵢ=1 in process #5. Further, the parallel algorithm is configured to perform the following processing in process #6.

Process #6:

First, the verifier algorithm V performs processing (1) and processing (2) for i=1 to N. Actually, the processing (1) is performed when dᵢ=0 and the processing (2) is performed when dᵢ=1.

Processing (1): If dᵢ=0, the verifier algorithm V executes (rᵢ, tᵢ, eᵢ, c_{2,i})←σᵢ. Then, the verifier algorithm V calculates c_{1,i}=H₁(rᵢ, tᵢ, eᵢ). Further, the verifier algorithm V calculates tᵢ^{A}←αᵢrᵢ−tᵢ and eᵢ^{A}←αᵢF(rᵢ)−eᵢ. Then, the verifier algorithm V holds c_{1,i}, c_{2,i}) and (tᵢ^{A}, eᵢ^{A}).

Processing (2): If dᵢ=1, the verifier algorithm V executes (rᵢ^{A}, tᵢ^{A}, eᵢ^{A}, c_{1,i})←σᵢ. Then, the verifier algorithm V calculates c_{2,i}=H₂(r₁^{A}, αᵢ(y−F(rᵢ^{A}))−F_{b}(rᵢ^{A}, tᵢ^{A})−eᵢ^{A}). Then, the verifier algorithm V holds (c_{1,i}, c_{2,i}) and (tᵢ^{A}, eᵢ^{A}).

After the above processing (1) and processing (2) being performed for i=1 to N, the verifier algorithm V verifies whether e=H(c_{1,i}, c_{2,1}, . . . , c_{1,N}, c_{2,N}) holds. Further, the verifier algorithm V verifies whether v=H(t₁^{A}, e₁^{A}, . . . , t_{N}^{A}, e_{N}^{A}) holds. The verifier algorithm V outputs the value 1 indicating successful authentication if the verifications are all successful and outputs the value 0 indicating an authentication failure if a failure occurs in one of verifications.

In the foregoing, the configuration capable of making the parallel algorithm more efficient has been described. By putting together a plurality of pieces of information exchanged between the prover algorithm P and the verifier algorithm V into a hash value as described above, the size of communication data in the third pass can be reduced. Further, by modifying the configuration of the algorithm to generate rᵢ, tᵢ, eᵢ from one random number seed in the above algorithm, the expected value of the communication data size is reduced. Moreover, if restrictions are imposed as the request dᵢ so that the number of 0 selections and the number of 1 selections are equal, the communication data size is reliably reduced.

If, for example, (q, n, m, N)=(2⁴, 45, 30, 88) is set, the public key has 120 bits, the secret key has 180 bits, and the communication data size becomes 42840 bits for the algorithm shown in FIG. 30. For the algorithm shown in FIG. 31, on the other hand, if (q, n, m, N)=(2⁴, 45, 30, 88) is set, the public key has 120 bits, the secret key has 180 bits, and the communication data size becomes 27512 bits. Thus, by making the above parallel algorithm more efficient, the communication data size can significantly be reduced.

[3-6: Serial/Parallel Hybrid Algorithm]

The necessity to execute the interactive protocol a plurality of times has been described to reduce the probability with which falsification is successful to a negligible level. As methods of executing the interactive protocol a plurality of times, the serial method and the parallel method have been presented. Particularly, the parallel method has been described by showing the concrete parallel algorithm. Algorithms of the hybrid type combining the serial method and the parallel method will be presented.

(Hybrid Configuration 1)

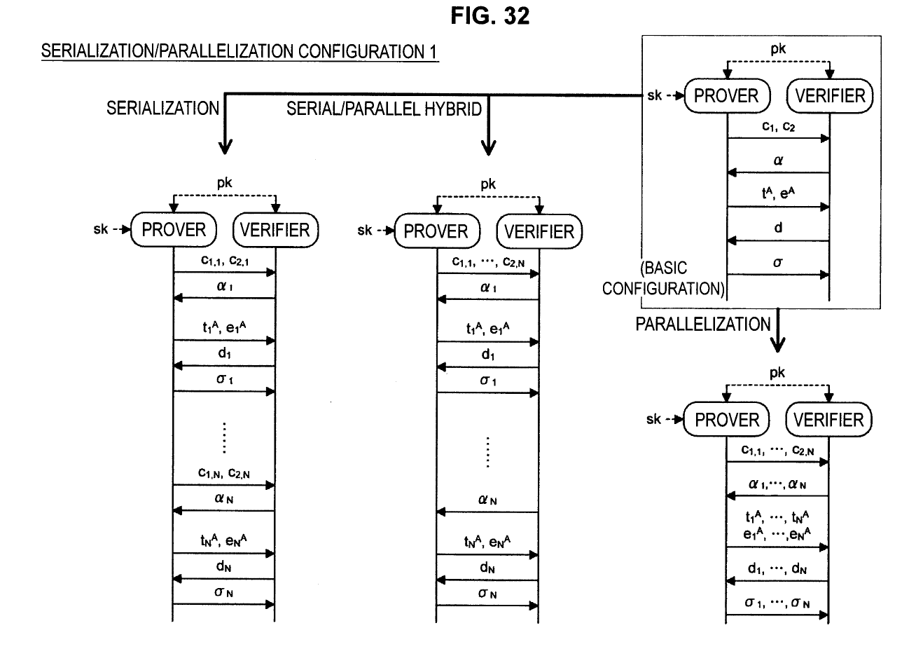

An algorithm of the hybrid type (hereinafter, called the parallel-serial algorithm) will be described with reference to FIG. 32. FIG. 32 shows a basic configuration according to the present scheme, a serial algorithm serializing the basic configuration, a parallel algorithm parallelizing the basic configuration, and a parallel-serial algorithm.

In the basic configuration, a message (c₁, c₂) is transmitted from the prover to the verifier in the first pass. In the second pass, a number α is transmitted from the verifier to the prover. In the third pass, vectors t^{A} and e^{A} are transmitted from the prover to the verifier. In the fourth pass, a request d is transmitted from the verifier to the prover. In the fifth pass, a response σ is transmitted from the prover to the verifier.

If the above basic configuration is parallelized, messages (c_{1,1}, c_{2,1}, . . . , c_{1,N}, c_{2,N}) for N times are transmitted from the prover to the verifier in the first pass. In the second pass, numbers (α₁, . . . , α_{N}) for N times are transmitted from the verifier to the prover. In the third pass, vectors (t₁^{A}, . . . , t_{N}^{A}, e₁^{A}, . . . , e_{N}^{A}) for N times are transmitted from the prover to the verifier. In the fourth pass, requests (d₁, . . . , d_{N}) for N times are transmitted from the verifier to the prover. In the fifth pass, responses (σ₁, . . . , σ_{N}) for N times are transmitted from the prover to the verifier.

Safety against passive attacks are secured by the parallel algorithm according to the present scheme. Moreover, the number of times of dialog can be reduced to 5. Further, by putting together messages for N times transmitted in the first pass and vectors for N times transmitted in the third pass into one hash value in each case, communication efficiency can be improved.

On the other hand, if the basic configuration is serialized, a message (c_{1,1}, c_{2,1}) for one time is transmitted from the prover to the verifier in the first pass. In the second pass, a number α₁ for one time is transmitted from the verifier to the prover. In the third pass, a vector (t₁^{A}, e₁^{A}) for one time is transmitted from the prover to the verifier. In the fourth pass, a request d₁ for one time is transmitted from the verifier to the prover. In the fifth pass, a response σ₁ for one time is transmitted from the prover to the verifier. In the same manner, the dialog is repeatedly performed until a response σ_{N} is transmitted from the prover to the verifier. Safety against active attacks is secured by the serial algorithm. It is also possible to prove that falsification probability is reliably reduced.

The parallel-serial algorithm is an algorithm combining properties of a parallel algorithm and properties of a serial algorithm. According to the parallel-serial algorithm shown in FIG. 32, messages (c_{1,1}, c_{2,1}, . . . , e_{1,N}, c_{2,N}) for N times are transmitted from the prover to the verifier in the first pass. In the second pass, a number α₁ for one time is transmitted from the verifier to the prover. In the third pass, a vector (t₁^{A}, e₁^{A}) for one time is transmitted from the prover to the verifier. In the fourth pass, a request d₁ for one time is transmitted from the verifier to the prover. In the fifth pass, a response σ₁ for one time is transmitted from the prover to the verifier. Then, α₂, . . . , α_{N}, t₂^{A}, e₂^{A}, . . . , t_{N}^{A}, e_{N}^{A}, d₂, . . . , d_{N}, σ₂, . . . , σ_{N} are exchanged between the prover and the verifier.

Safety against passive attacks is secured by the parallel-serial algorithm based on the present scheme. Moreover, the number of times of dialog can be reduced to 4N+1. Further, by putting together messages for N times transmitted in the first pass into one hash value, communication efficiency can be improved.

(Hybrid Configuration 2)

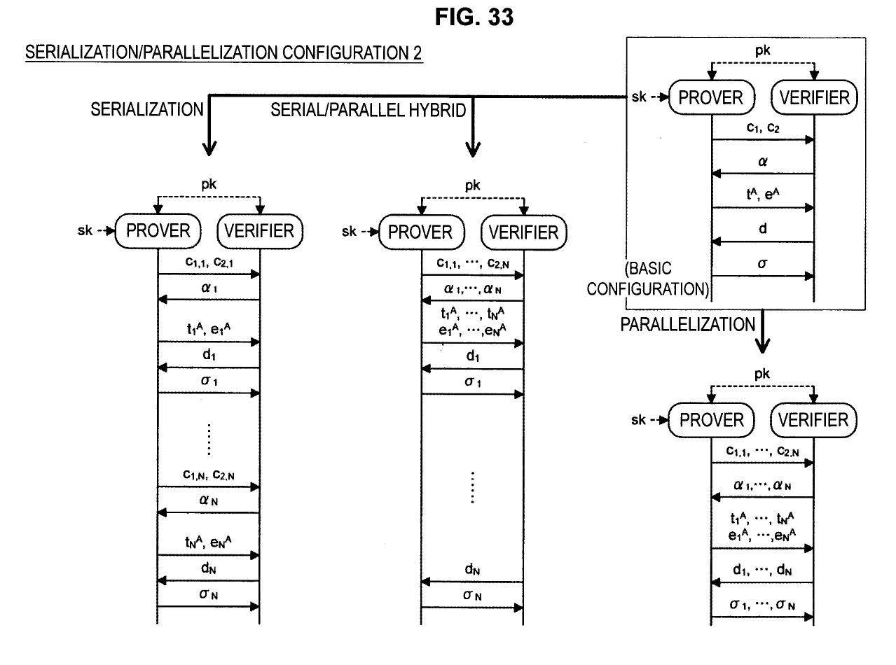

Another parallel-serial algorithm will be described with reference to FIG. 33. FIG. 33 shows the basic configuration according to the present scheme, the serial algorithm serializing the basic configuration, the parallel algorithm parallelizing the basic configuration, and a parallel-serial algorithm. The configurations and properties of the basic configuration, the serial algorithm, and the parallel algorithm are as described above.

The parallel-serial algorithm shown in FIG. 33 is an algorithm combining properties of a parallel algorithm and properties of a serial algorithm. According to the parallel-serial algorithm, messages (c_{1,1}, c_{2,1}, . . . , c_{1,N}, c_{2,N}) for N times are transmitted from the prover to the verifier in the first pass. In the second pass, numbers (α₁, . . . , α_{N}) for N times are transmitted from the verifier to the prover. In the third pass, vectors (t₁^{A}, e₁^{A}, . . . , t_{N}^{A}, e_{N}^{A}) for N times are transmitted from the prover to the verifier. In the fourth pass, a request d₁ for one time is transmitted from the verifier to the prover. In the fifth pass, a response σ₁ for one time is transmitted from the prover to the verifier. Then, d₂, . . . , d_{N}, σ₂, . . . , σ_{N} are exchanged between the prover and the verifier.

Safety against passive attacks is secured by the parallel-serial algorithm based on the present scheme. Moreover, the number of times of dialog can be reduced to 2N+3. Further, by putting together messages for N times transmitted in the first pass and vectors for N times transmitted in the third pass into one hash value in each case, communication efficiency can be improved.

(Hybrid Configuration 3)

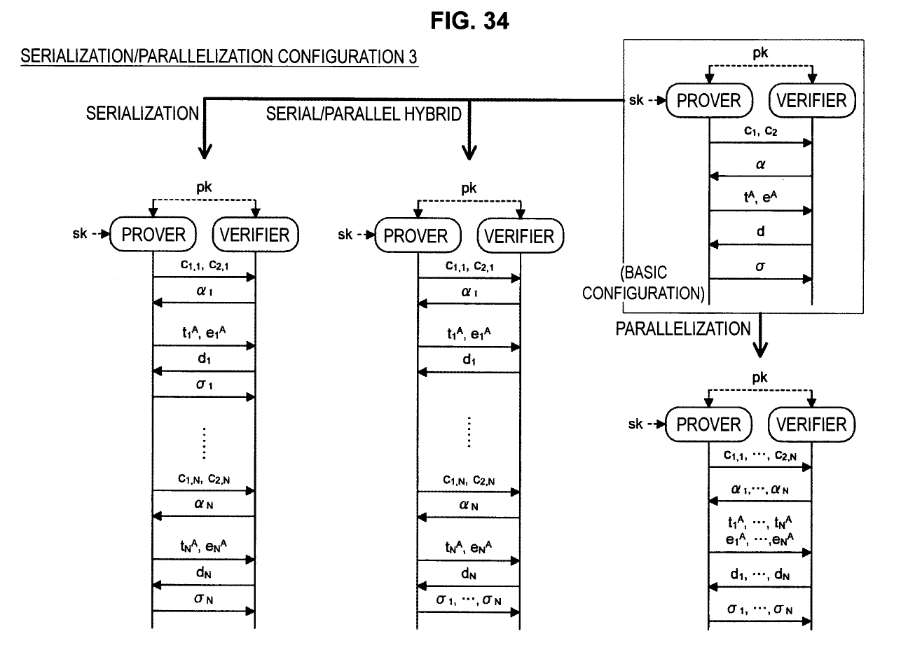

An algorithm of another hybrid type (hereinafter, called the serial-parallel algorithm) will be described with reference to FIG. 34. FIG. 34 shows the basic configuration according to the present scheme, the serial algorithm serializing the basic configuration, the parallel algorithm parallelizing the basic configuration, and a serial-parallel algorithm. The configurations and properties of the basic configuration, the serial algorithm, and the parallel algorithm are as described above.

The serial-parallel algorithm shown in FIG. 34 is an algorithm combining properties of a parallel algorithm and properties of a serial algorithm. According to the serial-parallel algorithm, a message (c_{1,1}, c_{2,1}) for one time is transmitted from the prover to the verifier in the first pass. In the second pass, a number α₁ for one time is transmitted from the verifier to the prover. In the third pass, a vector (t₁^{A}, e₁^{A}) for one time is transmitted from the prover to the verifier. In the fourth pass, a request d₁ for one time is transmitted from the verifier to the prover. Then, c_{1,2}, c_{2,2}, . . . , c_{1,N}, c_{2,N}, α₂, . . . , α_{N}, t₂^{A}, e₂^{A}, . . . , t_{N}^{A}, e_{N}^{A}, d₂, . . . , d_{N} are exchanged between the prover and the verifier. Lastly, responses (σ₁, . . . , σ_{N}) for N times are transmitted from the prover to the verifier.

Safety against active attacks is secured by the serial-parallel algorithm based on the present scheme. Moreover, the number of times of dialog can be reduced to 4N+1.

(Hybrid Configuration 4)

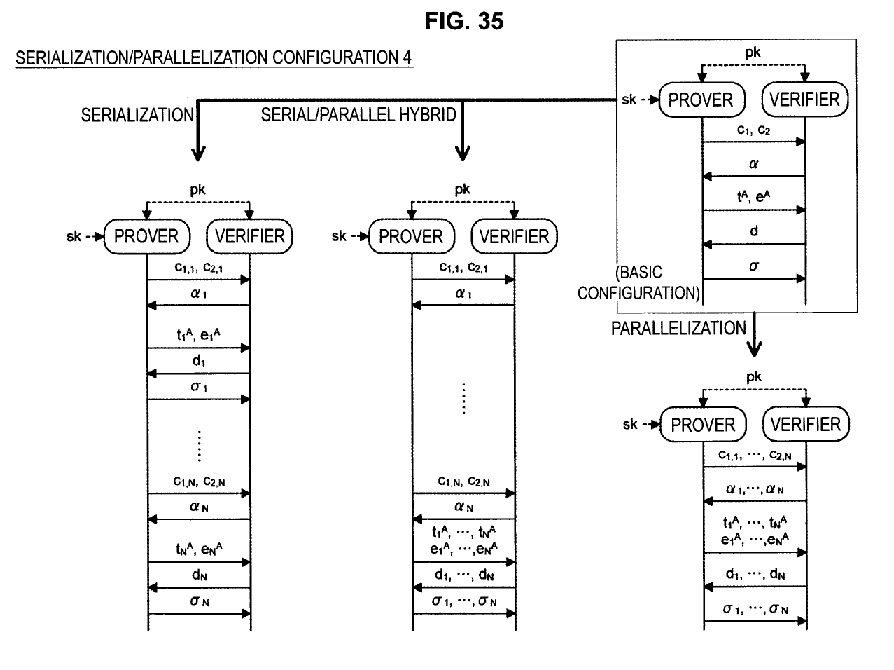

Another serial-parallel algorithm will be described with reference to FIG. 35. FIG. 35 shows the basic configuration according to the present scheme, the serial algorithm serializing the basic configuration, the parallel algorithm parallelizing the basic configuration, and a serial-parallel algorithm. The configurations and properties of the basic configuration, the serial algorithm, and the parallel algorithm are as described above.

The serial-parallel algorithm shown in FIG. 35 is an algorithm combining properties of a parallel algorithm and properties of a serial algorithm. According to the serial-parallel algorithm, a message (c_{1,1}, c_{2,1}) for one time is transmitted from the prover to the verifier in the first pass. In the second pass, a number α₁ for one time is transmitted from the verifier to the prover. Then, c_{1,2}, c_{2,2}, . . . , c_{1,N}, c_{2,N}, α₂, . . . , α_{N} are exchanged between the prover and the verifier. After the exchange of α_{N} being completed, vectors (t_{1gA}, e₁^{A}, . . . , t_{N}^{A}, e_{N}^{A}) for N times are transmitted from the prover to the verifier. Next, requests (d₁, . . . , d₁) for N times are transmitted from the verifier to the prover. Lastly, responses (σ₁, . . . , σ_{N}) for N times are transmitted from the prover to the verifier.

Safety against passive attacks is secured by the serial-parallel algorithm based on the present scheme. Moreover, the number of times of dialog can be reduced to 2N+3.

In the foregoing, the algorithms of the hybrid types based on the present scheme have been described.

In the foregoing, the second embodiment of the present technology has been described. The form of a multivariable simultaneous equation is the same as in the first embodiment.

### 4: Extension of the Efficient Algorithm

The above efficient algorithms according to first and second embodiments are configured to use a second-order multivariable polynomial represented by the following formula (20) as a public key (or a system parameter). However, the above efficient algorithms can be extended to a configuration in which a multivariable polynomial whose order is third or higher is used as a public key (or a system parameter).

[4-1: Higher-Order Multivariable Polynomial]

Consider, for example, a configuration in which a multivariable polynomial (see the following formula (21)) of third order or higher defined on a field of the order q=p^{k} is used as the public key (or a system parameter).

$$\begin{matrix} {f}_{l} ( {x}_{1} , … , {x}_{n} ) = {\sum }_{i = 1}^{n} {\sum }_{j = 1}^{n} {a}_{l , i , j} {x}_{i} {x}_{j} + {\sum }_{i = 1}^{n} {b}_{l , i} {x}_{i} & ( 20 ) \\ {f}_{l} ( {x}_{1} , … , {x}_{n} ) = {\sum }_{i = 1}^{n} {\sum }_{j = 1}^{n} {\sum }_{s = 0}^{k - 1} {\sum }_{t = 0}^{k - 1} {a}_{l , i , j , s , t} {x}_{i}^{{p}^{s}} {x}_{j}^{{p}^{t}} + {\sum }_{i = 1}^{n} {\sum }_{t = 0}^{k - 1} {b}_{l , i , s} {x}_{i}^{{p}^{s}} & ( 21 )\end{matrix}$$

A condition for a multivariable polynomial f₁ to be usable as a public key for the efficient algorithm according to the first or second embodiment is that the following formula (22) becomes bilinear with respect to (x₁, . . . , xₙ) and (y₁, . . . , yₙ). For a multivariable polynomial represented by the above formula (20), as shown in the following formula (23), bilinearity thereof can easily be checked (an underlined portion is linear with respect to each of xᵢ and yᵢ). Also for a multivariable polynomial represented by the above formula (21), as shown in the following formula (24), bilinearity thereof can easily be checked. However, the underlined portion of the following formula (24) shows bilinearity on a field GF(p) whose order is p. Thus, if a multivariable polynomial represented by the above formula (21) is used as a public key of the above efficient algorithm according to the second embodiment, it is necessary to limit a number α transmitted by the verifier after process #2 of the algorithm to elements of GF(p).

$$\begin{matrix}{f}_{l} ( {x}_{1} + {y}_{1} , … , {x}_{n} + {y}_{n} ) - {f}_{l} ( {x}_{1} , … , {x}_{n} ) - {f}_{l} ( {y}_{1} , … , {y}_{n} ) & ( 22 ) \\ {f}_{l} ( {x}_{1} + {y}_{1} , … , {x}_{n} + {y}_{n} ) = {\sum }_{i = 1}^{n} {\sum }_{j = 1}^{n} {a}_{l , i , j} ( {x}_{i} + {y}_{i} ) ( {x}_{j} + {y}_{j} ) + {\sum }_{i = 1}^{n} {b}_{l , i} ( {x}_{l} + {y}_{i} ) = {\sum }_{i = 1}^{n} {\sum }_{j = 1}^{n} {a}_{l , i , j} ( {x}_{i} {x}_{j} + {x}_{i} {y}_{j} + {y}_{i} {x}_{j} + {y}_{i} {y}_{j} ) + {\sum }_{i = 1}^{n} {b}_{l , j} ( {x}_{i} + {y}_{i} ) = {f}_{l} ( {x}_{1} , … , {x}_{n} ) + {f}_{l} ( {y}_{1} , … , {y}_{n} ) + {\sum }_{i = 1}^{n} {\sum }_{j = 1}^{n} {a}_{l , i , j} \underline{( {x}_{i} {y}_{j} + {y}_{i} {x}_{j} )} & ( 23 ) \\ {f}_{l} ( {x}_{1} + {y}_{1} , … , {x}_{n} + {y}_{n} ) = {\sum }_{i = 1}^{n} {\sum }_{j = 1}^{n} {\sum }_{s = 0}^{k - 1} {\sum }_{t = 0}^{k - 1} {{a}_{l , i , j , s , t} ( {x}_{i} + {y}_{i} )}^{{p}^{s}} {( {x}_{j} + {y}_{j} )}^{{p}^{t}} + {\sum }_{i = 1}^{n} {\sum }_{t = 0}^{k - 1} {{b}_{l , i , s} ( {x}_{i} + {y}_{i} )}^{{p}^{s}} = {\sum }_{i = 1}^{n} {\sum }_{j = 1}^{n} {\sum }_{s = 0}^{k - 1} {\sum }_{t = 0}^{k - 1} {a}_{l , i , j , s , t} ( {x}_{i}^{{p}^{s} } + {y}_{i}^{{p}^{s}} ) ( {x}_{j}^{{p}^{t} } + {y}_{j}^{{p}^{t}} ) + {\sum }_{i = 1}^{n} {\sum }_{t = 0}^{k - 1} {b}_{l , i , s} ( {x}_{i}^{{p}^{s} } + {y}_{i}^{{p}^{s}} ) = {\sum }_{i = 1}^{n} {\sum }_{j = 1}^{n} {\sum }_{s = 0}^{k - 1} {\sum }_{t = 0}^{k - 1} {a}_{l , i , j , s , t} ( {x}_{i}^{{p}^{s}} {x}_{j}^{{p}^{t}} + {x}_{j}^{{p}^{s}} {y}_{j}^{{p}^{t}} + {y}_{i}^{{p}^{s}} {y}_{j}^{{p}^{t}} + {y}_{i}^{{p}^{s}} {y}_{j}^{{p}^{t}} ) + {\sum }_{i = 1}^{n} {\sum }_{t = 0}^{k - 1} {b}_{l , i , s} ( {x}_{i}^{{p}^{s} } + {y}_{i}^{{p}^{s}} ) = {f}_{l} ( {x}_{1} , … , {x}_{n} ) + {f}_{l} ( {y}_{1} , … , {y}_{n} ) + {\sum }_{i = 1}^{n} {\sum }_{j = 1}^{n} {\sum }_{s = 0}^{k - 1} {\sum }_{t = 0}^{k - 1} {a}_{l , i , j , s , t} \underline{( {x}_{i}^{{p}^{s}} {y}_{j}^{{p}^{t}} + {y}_{i}^{{p}^{s}} {x}_{j}^{{p}^{t}} )} & ( 24 )\end{matrix}$$

For the above reason, construction of an algorithm that extends the above efficient algorithm according to the first or second embodiment to use a multivariable polynomial of third order or higher as represented by the above formula (21) as a public key is considered to be practicable.

The relationship between a multivariable polynomial (hereinafter, called a second-order polynomial) represented by the above formula (20) and a multivariable polynomial (hereinafter, called a multi-order polynomial) represented by the above formula (21) will be considered. An nk-variable second-order polynomial defined on a field of the order q=p and an n-variable multi-order polynomial defined on a field of the order q=p^{k} will be considered. In this case, difficulty of solving a simultaneous equation constituted of mk second-order polynomials and difficulty of solving a simultaneous equation constituted of m multi-order polynomials are equivalent. For example, difficulty of solving a simultaneous equation constituted of 80 80-variable second-order polynomials defined on a field of order 2 and difficulty of solving a simultaneous equation constituted of 10 10-variable multi-order polynomials defined on a field of order 2⁸ are equivalent.

That is, if elements of GF(p^{k}) and elements of GF(p)^{k} are identified by isomorphism, a function that is equivalent to a function represented by a set of mk nk-variable second-order polynomials defined on a field of order q=p and is represented by a set of m n-variable multi-order polynomials defined on a field of order q=p^{k} exists. For example, elements of GF(2⁸) and elements of GF(2)⁸ are identified by isomorphism, a function that is equivalent to a function represented by a set of 80 80-variable second-order polynomials defined on a field of order 2 and is represented by a set of 10 10-variable multi-order polynomials defined on a field of order 2⁸ exists. For the above reason, whether to use the above second-order polynomial or the above multi-order polynomial can optionally be selected.

Calculation efficiency when the above second-order polynomial is used and calculation efficiency when the above multi-order polynomial is used will be considered.

When an nk-variable second-order polynomial defined on a field of order 2 is used, an operation contained in the algorithm is performed on nk 1-bit variables. That is, the unit of operation is 1 bit. On the other hand, when an n-variable multi-order polynomial defined on a field of order 2^{k} is used, an operation contained in the algorithm is performed on n k-bit variables. That is, the unit of operation is k bits. k (k=2, 3, 4, . . . ) can be set arbitrarily. Thus, calculation efficiency can be improved by setting a favorable value as k for implementation. When an algorithm is implemented on a 32-bit architecture, higher calculation efficiency is achieved by adopting a configuration in which an operation is performed in 32 bits than a configuration in which an operation is performed in 1 bit.

Thus, by extending the above efficient algorithm according to the first or second embodiment in such a way that a multi-order polynomial can be used as a public key, the unit of operation can be fitted to the implemented architecture. As a result, calculation efficiency can be improved.

[4-2: Extending Scheme (Addition of a High-Order Term)]

A method of adding a term of third order or higher to a second-order polynomial can be considered as a method of using a multi-order polynomial of third order or higher. For example, as shown in the following formula (25), a method of adding a fourth-order term to a second-order polynomial represented by the above formula (20) can be considered. If a multi-order polynomial f₁ is defined like the following formula (25), the term g₁(x,y) defined by the following formula (26) is represented like the following formula (27). The term g₁(x,y) may be called a polar form below.

$$\begin{matrix} {f}_{l} ( {x}_{1} , … , {x}_{n} ) = {x}_{1} {x}_{2} {x}_{3} {x}_{4} + {\sum }_{i = 1}^{n} {\sum }_{j = 1}^{n} {a}_{l , i , j} {x}_{i} {x}_{j} + {\sum }_{i = 1}^{n} {b}_{l , i} {x}_{i} & ( 25 ) \\ {g}_{l} ( {x}_{1} , … , {x}_{n} , {y}_{1} , … , {y}_{n} ) = {f}_{l} ( {x}_{1} + {y}_{1} , … , {x}_{n} + {y}_{n} ) - {f}_{l} ( {y}_{1} , … , {y}_{n} ) - {f}_{l} ( {x}_{1} , … , {x}_{n} ) & ( 26 ) \\ {g}_{l} ( {x}_{1} , … , {x}_{n} , {y}_{1} , … , {y}_{n} ) = ( {x}_{1} + {y}_{1} ) ( {x}_{2} + {y}_{2} ) ( {x}_{3} + {y}_{3} ) ( {x}_{4} + {y}_{4} ) - {x}_{1} {x}_{2} {x}_{3} {x}_{4} - {y}_{1} {y}_{2} {y}_{3} {y}_{4} + {\sum }_{i = 1}^{n} {\sum }_{j = 1}^{n} ( {a}_{l , i , j} + {a}_{l , j , i} ) {x}_{i} {y}_{j} & ( 27 )\end{matrix}$$

As shown in the above formula (27), the term g₁(x,y) is not expressed bilinearly. Thus, six terms xᵢxⱼ obtained by selecting two variables from four variables x₁, x₂, x₃, x₄ and four terms xᵢxⱼxₖ obtained by selecting three variables from four variables x₁, x₂, x₃, x₄ are represented by four variables tᵢⱼ, tᵢⱼ, tᵢⱼₖ, tᵢⱼₖ^{A} like the following formulas (28) and (29). Using the above representation, the above efficient algorithm can be realized by using a multivariable polynomial of third order or higher. A fourth-order term is added to a second-order polynomial in the example shown in the above formula (25), but instead of the fourth-order term, a third-order term (for example, x₁x₂x₃) or a term of fifth order or higher (for example, x₁x₂x₃x₄x₅) may be added. Thus, by adding a term of third order or higher, robustness of an equation can be improved.

xᵢxⱼ=tᵢⱼ+tᵢⱼ^{A} (28)

xᵢxⱼxₖ=tᵢⱼₖ+tᵢⱼₖ^{A} (29)

### 5: Mechanism to Enhance Robustness

A mechanism to enhance robustness of the above algorithm according to the first or second embodiment will be presented.

[5-1: Setting Method of System Parameters]

Heretofore, how to set coefficients of a multivariable polynomial or random number seeds used for generation of coefficients (hereinafter, coefficients of a multivariable polynomial) is not described in detail. Coefficients of a multivariable polynomial may be set as parameters common throughout the system or parameters different from user to user.

However, if coefficients of a multivariable polynomial are set as parameters common throughout the system, it becomes necessary to update settings throughout the system when a vulnerability of the multivariable polynomial is found. Moreover, while average robustness (difficulty to solve) of a multivariable polynomial having randomly selected coefficients has been analyzed, it is difficult to guarantee sufficient robustness for a multivariable polynomial having specific coefficients.

Thus, the inventor of the present technology devised a mechanism to generate coefficients of a multivariable polynomial by using a character string selected by each user or the like as a seed of a pseudo random number generator. For example, a method of using the e-mail address of a user as a seed or a method of using a character string obtained by combining the e-mail address and update date as a seed can be considered. Using such a method, even if a vulnerability should be found in a multivariable polynomial having coefficients generated from some character string, only users using the multivariable polynomial having the coefficients are affected. Moreover, the vulnerability can easily be eliminated because the multivariable polynomial is changed only by changing the character string.

In the foregoing, the setting method of system parameters has been described. The character string is taken as an example in the above description, but a string of numbers or a string of symbols that is different for each user may be used.

[5-2: Method of Responding to Irregular Requests]

Next, the method of responding to irregular requests will be described.

(5-2-1: Response Method by the Prover)

As shown in FIG. 36, the possibility that the verifier makes a false request during interactive protocol can be considered. In the example of FIG. 36, after the prover transmits a message (c₁, c₂, c₃) to the verifier and the verifier transmits a request d=0 to the prover, the prover transmits a response σ to the request d=0 to the verifier. This is a normal dialog.

In the example of FIG. 36, however, the verifier further requests a response σ to a request d=1 from the prover. If the prover transmits the response σ to the request d=1 in response to the request, the secret key will be leaked to the verifier. Such leakage of the secret key could realistically occur. For example, the verifier may further request the response σ to the request d=1 by misrepresenting that the request d=0 must have been transmitted in the second pass, instead of transmitting the request d=1. On the other hand, the prover may misunderstand that the bit of the request d transmitted in the second pass has changed to another bit due to a communication error.

Thus, the inventor of the present technology invented a method of avoiding leakage of the secret key as described above. More specifically, a method of terminating the dialog or restart the dialog from the first pass by using a new random number is devised if responses to two or more requests d for one message are requested from the prover. If this method is applied, the secret key will not be leaked even if the verifier requests responses to two or more requests d under false pretenses.

In the foregoing, a contrivance to prevent leakage of the secret key due to irregular requests has been described. The 3-pass basic configuration is taken as an example here, but safety can also be improved by devising an algorithm of the serial method, parallel method, or hybrid type in the same manner. This also applies to a 5-pass algorithm.

(5-2-2: Response Method by the Verifier)

As shown in FIG. 37, there is also the possibility that the prover requests retransmission of the request d under false pretenses. In the example of FIG. 37, after the prover transmits a message (c₁, c₂, c₃) to the verifier and the verifier transmits a request d=0 to the prover, the prover requests retransmission of the request d. If the verifier selects the request d randomly again in response to the request, the request d=1 that is different from the request d=0 transmitted previously may be selected. In such a case, the request d=1 is transmitted from the verifier to the prover. In the example of FIG. 37, the prover transmits a response σ to the request d=1.

However, the prover may have been able to respond to the request d=1, but may not have been able to respond to the request d=0. That is, there is no denying the possibility that the prover gives false evidence. For example, the prover may request retransmission of the request d because the prover has lost the request d. On the other hand, the verifier may retransmit the request d in response to the request of the prover by assuming that the request has been lost due to a communication error. Then, if the retransmitted request d is different from the request d transmitted previously, the falsification is successful.

As is evident from the example of FIG. 37, an opportunity of falsification is given to the prover due to a random selection of the request d. Thus, the inventor of the present technology invented a method of preventing an opportunity of falsification from being given. This method is to refine the interactive protocol in such a way that the verifier terminates the dialog or retransmits the same request d as the request transmitted previously without generating a new random number when the prover requests transmission of the request d again for one message. If this method is applied, an opportunity of falsification using a retransmission request of the request d can be eliminated.

In the foregoing, a contrivance to eliminate an opportunity for falsification to be successful due to irregular requests has been described. The 3-pass basic configuration is taken as an example here, but safety can also be improved by devising an algorithm of the serial method, parallel method, or hybrid type in the same manner. This also applies to a 5-pass algorithm.

### 6: Example Hardware Configuration

Each algorithm described above can be performed by using, for example, the hardware configuration of the information processing apparatus shown in FIG. 38. That is, processing of each algorithm can be realized by controlling the hardware shown in FIG. 38 using a computer program. Additionally, the mode of this hardware is arbitrary, and may be a personal computer, a mobile information terminal such as a mobile phone, a PHS or a PDA, a game machine, a contact or non-contact IC chip, a contact or non-contact IC card, or various types of information appliances. Moreover, the PHS is an abbreviation for Personal Handy-phone System. Also, the PDA is an abbreviation for Personal Digital Assistant.

As shown in FIG. 38, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a device for contact or non-contact communication. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

### 7: Summary

Lastly, the technical contents according to the embodiment of the present technology will be briefly described. The technical contents stated here can be applied to various information processing apparatuses, such as a personal computer, a mobile phone, a portable game machine, a portable information terminal, an information appliance, a car navigation system, and the like. Further, the function of the information processing apparatus described below can be realized by using a single information processing apparatus or using a plurality of information processing apparatuses. Furthermore, a data storage means and an arithmetic processing means which are used for performing a process by the information processing apparatus described below may be mounted on the information processing apparatus, or may be mounted on a device connected via a network.

The function configuration of the above information processing apparatus can be expressed as shown below. For example, an information processing apparatus described in (1) below can show to the verifier that the prover knows the secret key s without leaking information about the secret key s to the verifier at all by using a set F of multi-order multivariable polynomials as a public key and executing an interactive protocol with the verifier. That is, the information processing apparatus described in (1) below has an authentication function of a public key authentication scheme whose safety is grounded on difficulty of solving a multi-order multivariable simultaneous equation.

Further, the information processing apparatus described in (1) below uses different information for each user, instead of using information common throughout the system, when generating the set F of multi-order multivariable polynomials. Thus, if a situation arises in which the set F of multi-order multivariable polynomials is unusable, the spread of damage can be minimized. That is, safety is improved. Also when technologies described in (2) to (29) described below are applied, equivalent safety or higher safety can be realized than when the information processing apparatus described in (1) below is used.

(1) An information processing apparatus, including:

a message generator that generates a message based on a set F=(f₁, . . . , fₘ) of multi-order multivariable polynomials defined on a ring K and a vector sεKⁿ;

a message provision unit that provides the message to a verifier holding the set F of multi-order multivariable polynomials and a vector y=(y₁, . . . , yₘ)=(f₁(s), . . . , fₘ(s)); and

a response provision unit that provides response information corresponding to a verification pattern selected by the verifier from k (k≧3) verification patterns to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(2) The information processing apparatus according to (1),

wherein the message generator generates messages for N times (N≧2),

wherein the message provision unit provides the messages for the N times to the verifier in one dialog, and

wherein the response provision unit provides, to the verifier in the one dialog, the response information for the N times corresponding to the verification pattern selected by the verifier for each of the messages for the N times.

(3) The information processing apparatus according to (1) or (2),

wherein the message generator generates messages for N times (N≧2) and also generates a hash value from the messages for the N times,

wherein the message provision unit provides the hash value to the verifier, and

wherein the response provision unit provides, to the verifier in the one dialog, the response information for the N times corresponding to the verification pattern selected by the verifier for each of the messages for the N times and a portion of the messages that is not obtained even if the operation prepared in advance for the verification pattern corresponding to the response information is performed by using the public key and the response information.

(4) The information processing apparatus according to any of (1) to (3),

wherein the set F of multi-order multivariable polynomials is generated by using information different for each user for whom the public key is generated.

(5) An information processing apparatus, including:

an information holding unit that holds a set F=(f₁, . . . , fₘ) of multi-order multivariable polynomials defined on a ring K and a vector y=(y₁, . . . , yₘ)=(f₁(s), . . . , fₘ(s));

a message acquisition unit that acquires a message generated based on the set F of multi-order multivariable polynomials and a vector sεKⁿ;

a pattern information provision unit that provides information about a verification pattern selected randomly from k (k≧3) verification patterns to a prover who provides the message;

a response acquisition unit that acquires response information corresponding to the selected verification pattern from the prover; and

a verification unit that verifies whether the prover holds the vector s based on the message, the set F of multi-order multivariable polynomials, the vector y, and the response information,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(6) The information processing apparatus according to (5),

wherein the message acquisition unit acquires messages for N times (N≧2) in one dialog,

wherein the pattern information provision unit selects the verification pattern for each of the messages for the N times and provides information about the selected verification patterns for the N times to the prover in the one dialog,

wherein the response acquisition unit acquires the response information for the N times corresponding to the selected verification patterns for the N times from the prover in the one dialog, and

wherein the verification unit judges that the prover holds the vector s if verification is successful for all the messages for the N times.

(7) The information processing apparatus according to (5) or (6),

wherein the message acquisition unit acquires a hash value generated from the messages for N times (N≧2),

the response acquisition unit acquires, from the prover, the response information corresponding to the selected verification pattern and a portion of messages that is not obtained even if the operation prepared in advance for the verification pattern corresponding to the response information is performed by using the public key and the response information, and

the verification unit verifies whether the prover holds the vector s based on the hash value, the portion of messages, the public key, and the response information.

(8) The information processing apparatus according to any of (5) to (7),

wherein the set F of multi-order multivariable polynomials is generated by using information different for each user for whom the public key is generated.

(9) An information processing apparatus, including:

a message generator that generates a message based on a set F=(f₁, . . . , fₘ) of multi-order multivariable polynomials defined on a ring K and a vector se Kⁿ;

a message provision unit that provides the message to a verifier holding the set F of multi-order multivariable polynomials and a vector y=(y₁, . . . , yₘ)=(f₁(s), . . . , fₘ(s));

an intermediate information generator that generates third information by using first information randomly selected by the verifier and second information obtained when the message is generated;

an intermediate information provision unit that provides the third information to the verifier; and

a response provision unit that provides response information corresponding to a verification pattern selected by the verifier from k (k≧2) verification patterns to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key, the first information, the third information, and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(10) The information processing apparatus according to (9),

wherein the message generator generates messages for N times (N≧2),

wherein the message provision unit provides the messages for the N times to the verifier in one dialog,

wherein the intermediate information generator generates the third information for the N times by using the first information selected by the verifier for each of the messages for the N times and the second information for the N times obtained when the messages are generated,

wherein the intermediate information provision unit provides the third information for the N times to the verifier in the one dialog, and

wherein the response provision unit provides the response information for the N times corresponding to the verification pattern selected by the verifier for each of the messages for the N times to the verifier in the one dialog.

(11) The information processing apparatus according to (9) or (10),

wherein the message generator generates messages for N times (N≧2) and also generates a hash value from the messages for the N times,

wherein the message provision unit provides the hash value to the verifier,

wherein the intermediate information generator generates the third information for the N times by using the first information selected by the verifier for each of the messages for the N times and the second information for the N times obtained when the messages are generated,

wherein the intermediate information provision unit provides the third information for the N times to the verifier in the one dialog, and

wherein the response provision unit provides, to the verifier in the one dialog, the response information for the N times corresponding to the verification pattern selected by the verifier for each of the messages for the N times and a portion of the messages that is not obtained even if the operation prepared in advance for the verification pattern corresponding to the response information is performed by using the public key and the response information.

(12) The information processing apparatus according to any of (9) to (11),

wherein the set F of multi-order multivariable polynomials is generated by using information different for each user for whom the public key is generated.

(13) An information processing apparatus, including:

an information holding unit that holds a set F=(f₁, . . . , fₘ) of multi-order multivariable polynomials defined on a ring K and a vector y=(y₁, . . . , yₘ)=(f₁(s), . . . , fₘ(s));

a message acquisition unit that acquires a message generated based on the set F of multi-order multivariable polynomials and a vector sεKⁿ;

an information provision unit that provides first information selected randomly to a prover who provides the message;

an intermediate information acquisition unit that acquires third information generated by the prover by using the first information and second information obtained when the message is generated;

a pattern information provision unit that provides information about a verification pattern selected randomly from k (k≧3) verification patterns to the prover;

a response acquisition unit that acquires response information corresponding to the selected verification pattern from the prover; and

a verification unit that verifies whether the prover holds the vector s based on the message, the first information, the third information, the set F of multi-order multivariable polynomials, and the response information,

wherein the vector s is a secret key,

wherein the set F of multi-order multivariable polynomials and the vector y are a public key,

wherein the message is information obtained by performing an operation prepared in advance for the verification pattern corresponding to the response information by using the public key, the first information, the third information, and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(14) The information processing apparatus according to (13),

wherein the message acquisition unit acquires the messages for N times (N≧2) in one dialog,

wherein the information provision unit randomly selects the first information for each of the messages for the N times and provides the selected first information for the N times to the prover in the one dialog,

wherein the intermediate information acquisition unit acquires the third information for the N times generated by the prover by using the first information for the N times and the second information for the N times obtained when the messages for the N times are generated,

wherein the pattern information provision unit selects the verification pattern for each of the messages for the N times and provides information about the selected verification patterns for the N times to the prover in the one dialog,

wherein the response acquisition unit acquires the response information for the N times corresponding to the selected verification patterns for the N times from the prover in the one dialog, and

wherein the verification unit judges that the prover holds the vector s if verification is successful for all messages for the N times.

(15) The information processing apparatus according to (13) or (14),

wherein the message acquisition unit acquires a hash value generated from the messages for N times (N≧2),

wherein the information provision unit randomly selects the first information for each of the messages for the N times and provides the selected first information for the N times to the prover in one dialog,

wherein the intermediate information acquisition unit acquires the third information for the N times generated by the prover by using the first information for the N times and the second information for the N times obtained when the messages for the N times are generated,

wherein the pattern information provision unit selects the verification pattern for each of the messages for the N times and provides information about the selected verification patterns for the N times to the prover in the one dialog,

wherein the response acquisition unit acquires the response information corresponding to the selected verification pattern and a portion of messages that is not obtained even if the operation prepared in advance for the verification pattern corresponding to the response information is performed by using the public key, the first information, the third information, and the response information, and

wherein the verification unit verifies whether the prover holds the vector s based on the hash value, the portion of messages, the public key, and the response information and judges that, if verification is successful for all the messages for the N times, the prover holds the vector s.

(16) The information processing apparatus according to any of (13) to (15),

wherein the set F of multi-order multivariable polynomials is generated by using information different for each user for whom the public key is generated.

(17) An information processing method, including:

generating a message based on a set F=(f₁, . . . , fₘ) of multi-order multivariable polynomials defined on a ring K and a vector sεKⁿ;

providing the message to a verifier holding the set F of multi-order multivariable polynomials and a vector y=(y₁, . . . , yₘ)=(f₁(s), . . . , fₘ(s)); and

providing response information corresponding to a verification pattern selected by the verifier from k (k≧3) verification patterns to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(18) An information processing method to be performed by an information processing apparatus that holds a set F=(f₁, . . . , fₘ) of multi-order multivariable polynomials defined on a ring K and a vector y=(y₁, . . . , yₘ)=(f₁(s), . . . , fₘ(s)), the method including:

acquiring a message generated based on the set F of multi-order multivariable polynomials and a vector sεKⁿ;

providing information about a verification pattern selected randomly from k (1.3) verification patterns to a prover who provides the message;

acquiring response information corresponding to the selected verification pattern from the prover; and

verifying whether the prover holds the vector s based on the message, the set F of multi-order multivariable polynomials, the vector y, and the response information,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(19) An information processing method, including:

generating a message based on a set F=(f₁, . . . , fₘ) of multi-order multivariable polynomials defined on a ring K and a vector s EK″;

providing the message to a verifier holding the set F of multi-order multivariable polynomials and a vector y=(y₁, . . . , yₘ)=(f₁(s), . . . , fₘ(s));

generating third information by using first information randomly selected by the verifier and second information obtained when the message is generated;

providing the third information to the verifier; and

providing response information corresponding to a verification pattern selected by the verifier from k (k≧2) verification patterns to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key, the first information, the third information, and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(20) An information processing method to be performed by an information processing apparatus that holds a set F=(f₁, . . . , fₘ) of multi-order multivariable polynomials defined on a ring K and a vector y=(y₁, . . . , yₘ)=(f₁(s), . . . , fₘ(s)), the method including:

acquiring a message generated based on the set F=(f₁, . . . , fₘ) of multi-order multivariable polynomials and a vector se K″;

providing first information selected randomly to a prover who provides the message;

acquiring third information generated by the prover by using the first information and second information obtained when the message is generated;

providing information about a verification pattern selected randomly from k (k≧3) verification patterns to the prover;

acquiring response information corresponding to the selected verification pattern from the prover; and

verifying whether the prover holds the vector s based on the message, the first information, the third information, the set F of multi-order multivariable polynomials, and the response information,

wherein the vector s is a secret key,

wherein the set F of multi-order multivariable polynomials and the vector y are a public key,

wherein the message is information obtained by performing an operation prepared in advance for the verification pattern corresponding to the response information by using the public key, the first information, the third information, and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(21) The information processing apparatus according to any of (1) to (16), wherein the m and the n have a relationship of m<n.
(22) The information processing apparatus according to (21), wherein the m and the n have a relationship of 2^{m-n}<<1.
(23) An information processing apparatus (a signature generation apparatus) including:

a message generator that generates a message based on a set F=(f₁, . . . , fₘ) of multi-order multivariable polynomials defined on a ring K and a vector se Kⁿ;

a message provision unit that provides the message to a verifier holding the set F of multi-order multivariable polynomials and a vector y=(y₁, yₘ)=(f₁(s), . . . , fₘ(s));

a verification pattern selection unit that selects a verification pattern from k (k≧3) verification patterns based on a numerical value obtained by inputting a document M and the message to a one-way function;

a response generator that generates response information corresponding to the selected verification pattern; and

a signature provision unit that provides, as a signature, the message and the response information to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , g₁^{A}) of terms of third order or higher.

(24) A program for causing a computer to realize:

a message generation function for generating a message based on a set F=(f₁, . . . , fₘ) of multi-order multivariable polynomials defined on a ring K and a vector sεKⁿ;

a message provision function for providing the message to a verifier holding the set F of multi-order multivariable polynomials and a vector y=(y₁, . . . , yₘ)=(f₁(s), . . . , fₘ(s)); and

a response provision function for providing response information corresponding to a verification pattern selected by the verifier from k (k≧3) verification patterns to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(25) A program for causing a computer to realize:

an information holding function for holding a set F=(f₁, . . . , fₘ) of multi-order multivariable polynomials defined on a ring K and a vector y=(y₁, . . . , yₘ)=(f₁(s), . . . , fₘ(s));

a message acquisition function for acquiring a message generated based on the set F of multi-order multivariable polynomials and a vector sεKⁿ;

a pattern information provision function for providing information about a verification pattern selected randomly from k (k≧3) verification patterns to a prover who provides the message;

a response acquisition function for acquiring response information corresponding to the selected verification pattern from the prover; and
a verification function for verifying whether the prover holds the vector s based on the message, the set F of multi-order multivariable polynomials, the vector y, and the response information,

wherein the vector s is a secret key,

wherein the set F of multi-order multivariable polynomials and the vector y are a public key,

wherein the message is information obtained by performing an operation prepared in advance for the verification pattern corresponding to the response information by using the public key and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(27) A program for causing a computer to realize:

a message generation function for generating a message based on a set F=(f₁, . . . , fₘ) of multi-order multivariable polynomials defined on a ring K and a vector sεKⁿ;

a message provision function for providing the message to a verifier holding the set F of multi-order multivariable polynomials and a vector y=(y₁, . . . , yₘ)=(f₁(s), . . . , fₘ(s));

an intermediate information generation function for generating third information by using first information randomly selected by the verifier and second information obtained when the message is generated;

an intermediate information provision function for providing the third information to the verifier; and

a response provision function for providing response information corresponding to a verification pattern selected by the verifier from k (k≧2) verification patterns to the verifier,

wherein the vector s is a secret key,

wherein the set F of multi-order multivariable polynomials and the vector y are a public key,

wherein the message is information obtained by performing an operation prepared in advance for the verification pattern corresponding to the response information by using the public key, the first information, the third information, and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(28) A program for causing a computer to realize:

an information holding function for holding a set F=(f₁, . . . , fₘ) of multi-order multivariable polynomials defined on a ring K and a vector y=(y₁, . . . , yₘ)=(f₁(s), . . . , fₘ(s));

a message acquisition function for acquiring a message generated based on the set F of multi-order multivariable polynomials and a vector sεKⁿ;

an information provision function for providing first information selected randomly to a prover who provides the message;

an intermediate information acquisition function for acquiring third information generated by the prover by using the first information and second information obtained when the message is generated;

a pattern information provision function for providing information about a verification pattern selected randomly from k (k≧3) verification patterns to the prover;

a response acquisition function for acquiring response information corresponding to the selected verification pattern from the prover; and

a verification function for verifying whether the prover holds the vector s based on the message, the first information, the third information, the set F of multi-order multivariable polynomials, and the response information,

wherein the vector s is a secret key,

wherein the set F of multi-order multivariable polynomials and the vector y are a public key,

wherein the message is information obtained by performing an operation prepared in advance for the verification pattern corresponding to the response information by using the public key, the first information, the third information, and the response information, and

wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

(29) A computer-readable recording medium in which the program according to any of (24) to (28) is recorded.

(Notes)

The above prover algorithm P is an example of a message generator, a message provision unit, a response provision unit, an intermediate information generator, and an intermediate information provision unit. The verifier algorithm V is an example of an information holding unit, a message acquisition unit, a pattern information provision unit, a response acquisition unit, a verification unit, and an intermediate information acquisition unit.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-177333 filed in the Japan Patent Office on Aug. 12, 2011, the entire content of which is hereby incorporated by reference.

What is claimed is:

1. An information processing apparatus, comprising:
a message generator that generates a message based on a set F=(f₁, . . . , fₘ) of multi-order multivariable polynomials defined on a ring K and a vector sεKⁿ;
a message provision unit that provides the message to a verifier holding the set F of multi-order multivariable polynomials and a vector y=(y₁, . . . , yₘ)=(f₁(s), . . . , fₘ(s)); and
a response provision unit that provides response information corresponding to a verification pattern selected by the verifier from k (k≧3) verification patterns to the verifier,
wherein the vector s is a secret key,
wherein the set F of multi-order multivariable polynomials and the vector y are a public key,
wherein the message is information obtained by performing an operation prepared in advance for the verification pattern corresponding to the response information by using the public key and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, gₘ^{A}) of terms of third order or higher.

2. The information processing apparatus according to claim 1,
wherein the message generator generates messages for N times (N≧12),
wherein the message provision unit provides the messages for the N times to the verifier in one dialog, and
wherein the response provision unit provides, to the verifier in the one dialog, the response information for the N times corresponding to the verification pattern selected by the verifier for each of the messages for the N times.

3. The information processing apparatus according to claim 1,
wherein the message generator generates messages for N times (N≧12) and also generates a hash value from the messages for the N times,
wherein the message provision unit provides the hash value to the verifier, and
wherein the response provision unit provides, to the verifier in the one dialog, the response information for the N times corresponding to the verification pattern selected by the verifier for each of the messages for the N times and a portion of the messages that is not obtained even if the operation prepared in advance for the verification pattern corresponding to the response information is performed by using the public key and the response information.

4. The information processing apparatus according to claim 1,
wherein the set F of multi-order multivariable polynomials is generated by using information different for each user for whom the public key is generated.

5. An information processing apparatus, comprising:
an information holding unit that holds a set F=(f₁, . . . , fₘ) of multi-order multivariable polynomials defined on a ring K and a vector y=(y₁, . . . , yₘ)=(f₁(s), . . . , fₘ(s));
a message acquisition unit that acquires a message generated based on the set F of multi-order multivariable polynomials and a vector sεKⁿ;
a pattern information provision unit that provides information about a verification pattern selected randomly from k (k≧3) verification patterns to a prover who provides the message;
a response acquisition unit that acquires response information corresponding to the selected verification pattern from the prover; and
a verification unit that verifies whether the prover holds the vector s based on the message, the set F of multi-order multivariable polynomials, the vector y, and the response information,
wherein the vector s is a secret key,
wherein the set F of multi-order multivariable polynomials and the vector y are a public key,
wherein the message is information obtained by performing an operation prepared in advance for the verification pattern corresponding to the response information by using the public key and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

6. The information processing apparatus according to claim 5,
wherein the message acquisition unit acquires messages for N times (N≧2) in one dialog,
wherein the pattern information provision unit selects the verification pattern for each of the messages for the N times and provides information about the selected verification patterns for the N times to the prover in the one dialog,
wherein the response acquisition unit acquires the response information for the N times corresponding to the selected verification patterns for the N times from the prover in the one dialog, and
wherein the verification unit judges that the prover holds the vector s if verification is successful for all the messages for the N times.

7. The information processing apparatus according to claim 5,
wherein the message acquisition unit acquires a hash value generated from the messages for N times (N≧2),
the response acquisition unit acquires, from the prover, the response information corresponding to the selected verification pattern and a portion of messages that is not obtained even if the operation prepared in advance for the verification pattern corresponding to the response information is performed by using the public key and the response information, and
the verification unit verifies whether the prover holds the vector s based on the hash value, the portion of messages, the public key, and the response information.

8. The information processing apparatus according to claim 5,
wherein the set F of multi-order multivariable polynomials is generated by using information different for each user for whom the public key is generated.

9. An information processing apparatus, comprising:
a message generator that generates a message based on a set F=(f₁, . . . , fₘ) of multi-order multivariable polynomials defined on a ring K and a vector sεKⁿ;
a message provision unit that provides the message to a verifier holding the set F of multi-order multivariable polynomials and a vector y=(y₁, . . . , yₘ)=(f₁(s), . . . , fₘ(s));
an intermediate information generator that generates third information by using first information randomly selected by the verifier and second information obtained when the message is generated;
an intermediate information provision unit that provides the third information to the verifier; and
a response provision unit that provides response information corresponding to a verification pattern selected by the verifier from k (k≧2) verification patterns to the verifier,
wherein the vector s is a secret key,
wherein the set F of multi-order multivariable polynomials and the vector y are a public key,
wherein the message is information obtained by performing an operation prepared in advance for the verification pattern corresponding to the response information by using the public key, the first information, the third information, and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

10. The information processing apparatus according to claim 9,
wherein the message generator generates messages for N times (N≧2),
wherein the message provision unit provides the messages for the N times to the verifier in one dialog,
wherein the intermediate information generator generates the third information for the N times by using the first information selected by the verifier for each of the messages for the N times and the second information for the N times obtained when the messages are generated,
wherein the intermediate information provision unit provides the third information for the N times to the verifier in the one dialog, and
wherein the response provision unit provides the response information for the N times corresponding to the verification pattern selected by the verifier for each of the messages for the N times to the verifier in the one dialog.

11. The information processing apparatus according to claim 9,
wherein the message generator generates messages for N times (N≧2) and also generates a hash value from the messages for the N times,
wherein the message provision unit provides the hash value to the verifier,
wherein the intermediate information generator generates the third information for the N times by using the first information selected by the verifier for each of the messages for the N times and the second information for the N times obtained when the messages are generated,
wherein the intermediate information provision unit provides the third information for the N times to the verifier in the one dialog, and
wherein the response provision unit provides, to the verifier in the one dialog, the response information for the N times corresponding to the verification pattern selected by the verifier for each of the messages for the N times and a portion of the messages that is not obtained even if the operation prepared in advance for the verification pattern corresponding to the response information is performed by using the public key and the response information.

12. The information processing apparatus according to claim 9,
wherein the set F of multi-order multivariable polynomials is generated by using information different for each user for whom the public key is generated.

13. An information processing apparatus, comprising:
an information holding unit that holds a set F=(f₁, . . . , fₘ) of multi-order multivariable polynomials defined on a ring K and a vector y=(y₁, . . . , yₘ)=(f₁(s), . . . , fₘ(s));
a message acquisition unit that acquires a message generated based on the set F of multi-order multivariable polynomials and a vector sεKⁿ;
an information provision unit that provides first information selected randomly to a prover who provides the message;
an intermediate information acquisition unit that acquires third information generated by the prover by using the first information and second information obtained when the message is generated;
a pattern information provision unit that provides information about a verification pattern selected randomly from k (k≧3) verification patterns to the prover;
a response acquisition unit that acquires response information corresponding to the selected verification pattern from the prover; and
a verification unit that verifies whether the prover holds the vector s based on the message, the first information, the third information, the set F of multi-order multivariable polynomials, and the response information,
wherein the vector s is a secret key,
wherein the set F of multi-order multivariable polynomials and the vector y are a public key,
wherein the message is information obtained by performing an operation prepared in advance for the verification pattern corresponding to the response information by using the public key, the first information, the third information, and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

14. The information processing apparatus according to claim 13,
wherein the message acquisition unit acquires the messages for N times (N≧2) in one dialog,
wherein the information provision unit randomly selects the first information for each of the messages for the N times and provides the selected first information for the N times to the prover in the one dialog,
wherein the intermediate information acquisition unit acquires the third information for the N times generated by the prover by using the first information for the N times and the second information for the N times obtained when the messages for the N times are generated,
wherein the pattern information provision unit selects the verification pattern for each of the messages for the N times and provides information about the selected verification patterns for the N times to the prover in the one dialog,
wherein the response acquisition unit acquires the response information for the N times corresponding to the selected verification patterns for the N times from the prover in the one dialog, and
wherein the verification unit judges that the prover holds the vector s if verification is successful for all messages for the N times.

15. The information processing apparatus according to claim 13,
wherein the message acquisition unit acquires a hash value generated from the messages for N times (N≧2),
wherein the information provision unit randomly selects the first information for each of the messages for the N times and provides the selected first information for the N times to the prover in one dialog,
wherein the intermediate information acquisition unit acquires the third information for the N times generated by the prover by using the first information for the N times and the second information for the N times obtained when the messages for the N times are generated,
wherein the pattern information provision unit selects the verification pattern for each of the messages for the N times and provides information about the selected verification patterns for the N times to the prover in the one dialog,
wherein the response acquisition unit acquires the response information corresponding to the selected verification pattern and a portion of messages that is not obtained even if the operation prepared in advance for the verification pattern corresponding to the response information is performed by using the public key, the first information, the third information, and the response information, and
wherein the verification unit verifies whether the prover holds the vector s based on the hash value, the portion of messages, the public key, and the response information and judges that, if verification is successful for all the messages for the N times, the prover holds the vector s.

16. The information processing apparatus according to claim 13,
wherein the set F of multi-order multivariable polynomials is generated by using information different for each user for whom the public key is generated.

17. An information processing method, comprising:
generating a message based on a set F=(f₁, . . . , fₘ) of multi-order multivariable polynomials defined on a ring K and a vector sεKⁿ;
providing the message to a verifier holding the set F of multi-order multivariable polynomials and a vector y=(y₁, . . . , yₘ)=(f₁(s), . . . , fₘ(s)); and
providing response information corresponding to a verification pattern selected by the verifier from k (k≧3) verification patterns to the verifier,
wherein the vector s is a secret key,
wherein the set F of multi-order multivariable polynomials and the vector y are a public key,
wherein the message is information obtained by performing an operation prepared in advance for the verification pattern corresponding to the response information by using the public key and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

18. An information processing method to be performed by an information processing apparatus that holds a set F=(f₁, . . . , fₘ) of multi-order multivariable polynomials defined on a ring K and a vector y=(y₁, . . . , yₘ)=(f₁(s), . . . , fₘ(s)), the method comprising:
acquiring a message generated based on the set F of multi-order multivariable polynomials and a vector sεKⁿ;
providing information about a verification pattern selected randomly from k (k≧3) verification patterns to a prover who provides the message;
acquiring response information corresponding to the selected verification pattern from the prover; and
verifying whether the prover holds the vector s based on the message, the set F of multi-order multivariable polynomials, the vector y, and the response information,
wherein the vector s is a secret key,
wherein the set F of multi-order multivariable polynomials and the vector y are a public key,
wherein the message is information obtained by performing an operation prepared in advance for the verification pattern corresponding to the response information by using the public key and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

19. An information processing method, comprising:
generating a message based on a set F=(f₁, . . . , fₘ) of multi-order multivariable polynomials defined on a ring K and a vector sεKⁿ;
providing the message to a verifier holding the set F of multi-order multivariable polynomials and a vector y=(y₁, . . . , yₘ)=(f₁(s), . . . , fₘ(s));
generating third information by using first information randomly selected by the verifier and second information obtained when the message is generated;
providing the third information to the verifier; and
providing response information corresponding to a verification pattern selected by the verifier from k (k≧2) verification patterns to the verifier,
wherein the vector s is a secret key,
wherein the set F of multi-order multivariable polynomials and the vector y are a public key,
wherein the message is information obtained by performing an operation prepared in advance for the verification pattern corresponding to the response information by using the public key, the first information, the third information, and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.

20. An information processing method to be performed by an information processing apparatus that holds a set F=(f₁, . . . , fₘ) of multi-order multivariable polynomials defined on a ring K and a vector y=(y₁, . . . , yₘ)=(f₁(s), . . . , fₘ(s)), the method comprising:
acquiring a message generated based on the set F=(f₁, . . . , fₘ) of multi-order multivariable polynomials and a vector sεKⁿ;
providing first information selected randomly to a prover who provides the message;
acquiring third information generated by the prover by using the first information and second information obtained when the message is generated;
providing information about a verification pattern selected randomly from k (k≧3) verification patterns to the prover;
acquiring response information corresponding to the selected verification pattern from the prover; and
verifying whether the prover holds the vector s based on the message, the first information, the third information, the set F of multi-order multivariable polynomials, and the response information,
wherein the vector s is a secret key,
wherein the set F of multi-order multivariable polynomials and the vector y are a public key,
wherein the message is information obtained by performing an operation prepared in advance for the verification pattern corresponding to the response information by using the public key, the first information, the third information, and the response information, and
wherein the set F of multi-order multivariable polynomials is obtained by adding a set F^{A}=(f₁^{A}, . . . , fₘ^{A}) of second-order multivariable polynomials set so that F_{b}(x,y) defined as F_{b}(x,y)=F(x+y)−F(x)−F(y) becomes bilinear regarding x and y and a set G^{A}=(g₁^{A}, . . . , gₘ^{A}) of terms of third order or higher.
